(19) United States
(12) Patent Application Publication
(10) Pub. No.: US 2026/0330965 A1
(43) Pub. Date: Oct. 22, 2026

(54) SYSTEMS AND METHODS FOR OPTIMIZING TRAFFIC FLOW BASED ON FUTURE ROADWAY CONDITIONS

(71) Applicant: Cintra US Services, LLC, Austin, TX (US)

(72) Inventors: Ricardo Sanchez Gomez, Austin, TX (US); Alvaro Prieto Moneo, Austin, TX (US); Joseph Charles McKenzie, Austin, TX (US)

(21) Appl. No.: 19/727,417

(22) Filed: Jul. 1, 2026

Related U.S. Application Data
(63) Continuation-in-part of application No. 19/342,425, filed on Sep. 26, 2025.
Application No. 19/342,425 is a continuation of application No. 19/074,312, filed on Mar. 7, 2025, now Pat. No. 12,451,003.

(51) Int. Cl. G08G 1/01; G07B 15/06

(52) U.S. Cl. CPC G08G 1/0129; G07B 15/063; G08G 1/0116

(57) ABSTRACT

Aspects of the disclosed technology relate to a system and methods for optimizing traffic flow along a roadway. The systems receive, from a connected-automated vehicle (CAV), a request for a travel time along a roadway having a managed lane and a general purpose lane. The system determines real-time traffic data, and using a trained machine learning model, predicts future traffic data along the roadway, determines a time saved by using the managed lane, communicates with the CAV, receives an acknowledgement that the vehicle will use the managed lane, and updates the predicted traffic data. Segment agents may be responsible for discrete segments of the roadway and may communicate with a coordination agent to result in a multi-agent reinforced traffic machine learning system. The system provides a mobility service to CAVs by implementing a reinforcement learning process to understand CAV behavior to optimize and maintain the service level along a roadway.

### TECHNICAL FIELD

The present invention relates to systems, methods, and computer readable storage media containing instructions for detecting anomalous traffic conditions and predicting future roadway conditions for connected-automated vehicles (CAVs). Some embodiments further relate to calculating a decision in response to the detection or prediction of roadway conditions and communicating with connected-automated vehicles.

### BACKGROUND

Dynamically priced toll lanes, also known as managed lanes or high-occupancy toll (HOT) lanes, adjust toll rates in real-time based on current and future traffic conditions. By varying the toll rates, these lanes aim to maintain a consistent speed and ensure smoother traffic flow. They use advanced traffic monitoring systems to collect real-time data on traffic volumes, speeds, and congestion levels. These systems also use predictive algorithms which combine historical data and machine learning models to forecast future traffic conditions and adjust toll rates accordingly. By dynamically adjusting toll rates, these algorithms help maintain a steady flow of traffic, reducing delays and improving overall travel times.

However, broader issues hinder the effectiveness of current traffic optimization technologies. Many traffic management systems rely on siloed data sources, preventing comprehensive analysis and coordination across different segments of the freeway. Real-time data collection is often nonexistent, insufficient or inaccurate, leading to suboptimal decisions. Current traffic technologies often use predefined algorithms that cannot adapt to unexpected changes in traffic conditions, such as accidents, weather, or special events. Roadways are not always equipped with the necessary sensors, cameras, or communication networks to support real-time, large-scale traffic management. Existing technologies often fail to accommodate the increasing complexity of mixed traffic, including human-driven and connected-automated vehicles.

Current traffic optimization technologies, while effective in some specific scenarios, suffer technical limitations and do not take advantage of new and advanced vehicle technologies. For instance, vehicles are now equipped with communication connectivity that enable them to send and receive information in limitless ways, combining this with automated driving systems or full autonomy as in the case of robotaxis create “cooperative” opportunities that can meet the needs of both the driver or customer and the traffic operator.

Furthermore, toll road operators continually analyze customer behaviors to better understand pricing strategies, the relation to traffic conditions and the “capture rate” which is the frequency in which drivers choose to take a managed lane. This analysis informs future strategies that could be taken to influence customers and maximize the usage of the managed lane's capacity. These analyses are performed retroactively and do not utilize the advantages of real-time communications with connected-automated vehicles that would enable customized incentivization through reinforcement learning techniques.

What is needed, therefore, is a system and method that understands real-time traffic information, predicts future traffic conditions and can communicate information with connected-automated vehicles. The system should learn and anticipate connected-automated vehicle behaviors, preferences and better control the future traffic conditions of managed lanes and the unmanaged or general-purpose lanes within a facility. These, and other benefits, will be readily apparent to those of skill in the art in reference to the following disclosure which provides technical solutions to these, and other, issues.

### SUMMARY

To address the above-identified shortcomings, technical solutions focus on integrating real-time data, predictive analytics, and adaptive algorithms, as well as fostering coordination among systems and jurisdictions. The proposed embodiments are directed at overcoming these challenges and result in improving freeway efficiency, reducing congestion, and accommodating connected-automated vehicles and smart city ecosystems.

According to some embodiments, a traffic optimization system includes a plurality of real-time roadway sensors including one or more of lidar sensors, radar sensors, infrared sensors, microwave sensors, optical sensors, and doppler sensors, the plurality of real-time roadway sensors disposed along a roadway having a plurality of segments, each segment having a managed lane and a non-managed lane, wherein the plurality of real-time roadway sensors are configured to determine real-time traffic data comprising vehicle count, speed, volume, and density associated with each of the plurality of segments; a traffic database storing historical traffic data for the plurality of segments of the roadway; a network interface configured to receive a route request from a connected-automated vehicle, the route request including a starting point, a destination, a route along the roadway from the starting point to the destination, and an estimated time of arrival at an entry point of the managed lane; a future traffic conditions prediction server comprising a memory and a processor executing instructions stored in the memory, the instructions causing the processor to: receive, via the network interface, the route request from the connected-automated vehicle; retrieve, from the traffic database, historical traffic data associated with the route at the estimated time of arrival at the entry point of the managed lane; receive, from the plurality of real-time roadway sensors, real-time traffic data for the route; input the historical traffic data, the real-time traffic data, and the estimated time of arrival into a machine learning model trained on historical patterns to predict future traffic conditions; predict, using the machine learning model, an estimated travel time for the managed lane and the non-managed lane along the route at the estimated time of arrival; determine, based on the estimated travel times, a time savings for traveling in the managed lane; transmit, via the network interface, the estimated travel time for the managed lane, the estimated travel time for the non-managed lane, and the time savings to the connected-automated vehicle; receive, via the network interface, an acceptance from the connected-automated vehicle to travel in the managed lane; update the machine learning model with the acceptance from the connected-automated vehicle; and predict, using the updated machine learning model, future estimated travel times for additional connected-automated vehicles; a plurality of segment agents, each segment agent associated with one of the plurality of roadway segments, wherein each segment agent is configured to monitor real-time traffic data from roadway sensors in its associated roadway segment and communicate the real-time traffic data to the future traffic conditions prediction server; and a coordination agent in communication with each of the plurality of segment agents, the coordination agent configured to generate and transmit instructions to each segment agent to control traffic flow in the managed and non-managed lanes based on the predicted future estimated travel times from the future traffic conditions prediction server.

The traffic optimization system may be further configured to receive historical traffic data for the plurality of segments of the roadway, the historical traffic data including traffic speed, traffic density, and managed lane acceptance data; vectorize the historical traffic data into a plurality of vectors, each vector corresponding to a single time interval for one of the plurality of segments; identify anomalous vectors within the plurality of vectors using an isolation forest anomaly detection algorithm, wherein each anomalous vector represents a time interval where traffic conditions significantly deviate from normal conditions; and cluster the anomalous vectors into a plurality of anomalous vector clusters using a clustering algorithm, wherein each anomalous vector cluster represents a group of similar anomalous traffic conditions.

In some cases, the instructions further cause the processor to determine, for each anomalous vector cluster, an anomaly type based on the traffic conditions represented by the vectors in the cluster; and associate an adjustment factor with each anomaly type, the adjustment factor indicating how to adjust the estimated travel times predicted by the machine learning model when the real-time traffic data matches that anomaly type.

The instructions may further cause the processor to vectorize the real-time traffic data received from the plurality of real-time roadway sensors into a real-time traffic vector; compare the real-time traffic vector to each of the anomalous vector clusters to determine if the real-time traffic data is anomalous; if the real-time traffic vector is anomalous, identify the anomaly type based on the matching anomalous vector cluster; and adjust the estimated travel times predicted by the machine learning model using the adjustment factor associated with the identified anomaly type prior to transmitting the estimated travel times to the connected-automated vehicle.

In some cases, the future traffic conditions prediction server is further configured to receive, via the network interface, actual travel time data from each connected-automated vehicle that accepted travel in a managed lane; compare the actual travel time data to the predicted estimated travel times; and further update the machine learning model based on the comparison to improve future predictions.

Each of the segment agents may be further configured to store historical acceptance data for connected-automated vehicles that have traveled through the agent's associated roadway segment; analyze the historical acceptance data to identify patterns of managed lane usage by individual connected-automated vehicles; and generate targeted incentives for transmission to the individual connected-automated vehicles based on the identified patterns to further encourage managed lane usage.

In some cases, the targeted incentives are customized based on factors including one or more of a connected-automated vehicle's historical managed lane usage frequency, time of day, day of week, holiday designation, vehicle occupancy, or vehicle type.

The future traffic conditions prediction server may be further configured to receive, via the network interface, navigation data from the connected-automated vehicle indicating a change in the connected-automated vehicle's route after accepting travel in the managed lane; and further update the machine learning model based on the navigation data to improve future predictions.

In some embodiments, the coordination agent is further configured to monitor real-time and historical managed lane usage data across all the roadway segments; and dynamically adjust the instructions transmitted to one or more of the segment agents based on the real-time and historical managed lane usage data to balance managed lane usage across the plurality of roadway segments.

According to some embodiments, a traffic optimization system includes one or more real-time roadway sensors including one or more of lidar, radar, infrared, microwave, optical, or doppler sensors, the one or more real-time roadway sensors disposed along a first section of roadway and configured to determine vehicle count, speed, volume, and density associated with the first section of roadway ; and a future traffic conditions prediction server, the future traffic conditions prediction server configured to receive a request from a connected-automated vehicle for a travel time along a first route, the first route including a managed lane and a non-managed lane, and a time of arrival at the managed lane; receive, from the one or more real-time roadway sensors disposed along the first route, current traffic conditions comprising vehicle count, speed, volume, and density associated with the first route; receive, from a traffic database, past traffic conditions associated with the first route at the time of arrival at the managed lane; execute a trained machine learning model; enter, into the trained machine learning model, input features comprising one or more of current traffic conditions, past traffic conditions, weather conditions, and the time of arrival at the managed lane; determine, by the trained machine learning model, an estimated travel time along the managed lane at the time of arrival at the managed lane; send, to the vehicle, the estimated travel time along the managed lane at the time of arrival at the managed lane and an indication of time saved by accepting the managed lane over the non-managed lane; receive, from the connected-automated vehicle, an acceptance of the managed lane; determine, based on the acceptance of the managed lane, an updated future traffic conditions for the first section of roadway; and display, on a roadway sign, indicia associated with an incentive to enter the managed lane.

The traffic optimization system may include an on ramp to the first section of roadway, the on ramp including one or more sensors including one or more of radar detectors, automatic license plate readers, radio-frequency identification (RFID) tag readers, and Bluetooth readers, the one or more sensors configured to determine a number of vehicles entering the first section of roadway by the on ramp and sending, to the future traffic predictions server, the number of vehicles entering the first section of roadway.

In some cases, the traffic optimization system further includes a first segment agent and a coordination agent, the first segment agent configured to monitor the current traffic conditions present in the first section of roadway and provide, to the coordination agent, the current traffic conditions.

The traffic optimization system may further include a second segment agent configured to monitor the current traffic conditions present in a second segment of the roadway, and receive, from the coordination agent, instructions for managing the traffic in the second segment of the roadway.

In some examples, the instructions further cause the processor to identify connected-automated vehicles that consistently accept and use the managed lanes; categorize the identified connected-automated vehicles as frequent users; and transmit, via the network interface, exclusive incentives to the frequent users, the incentives including one or more of guaranteed pricing, personalized route recommendations, or partner discounts.

According to some embodiments, a machine learning method includes the steps of receiving, from a connected-automated vehicle, a request for a travel time along a first route, the first route including a managed lane and a non-managed lane; determining, in response to the request for the travel time along the first route, a first travel time associated with the non-managed lane and a second travel time associated with the managed lane; receiving, from one or more sensors disposed along the first route, real-time roadway traffic data, the roadway traffic data including one or more of a traffic speed and a traffic density; receiving, from a traffic database, historical data of travel times along the first route; receiving, from the connected-automated vehicle, an estimated travel time for the route; determining, by executing a machine learning model and based at least in part on the real-time roadway traffic data and the historical data, an estimated future traffic prediction for the route; determining, based on the estimated future traffic prediction for the route, a predicted travel time along the route; determining, based on the predicted travel time along the route, that the managed lane results in a travel time savings; sending, to the connected-automated vehicle, data associated with the managed lane, including the travel time savings and a cost associated with the managed lane; and receiving, from the connected-automated vehicle, an indication that the connected-automated vehicle will travel along the managed lane.

The method may include the step of determining, based on the estimated future traffic prediction, an incentive for a second connected-automated vehicle to accept the managed route. In some cases, the incentive comprises dynamically setting a toll price.

The machine learning method may include the step of training the machine learning model on ground truth data, the ground truth data including the time saved and the cost associated with the managed route and the indication that the connected-automated vehicle will travel along the managed lane.

The machine learning method may include determining an actual travel time of the connected-automated vehicle along the route and comparing the actual travel time to the predicted travel time. The method may further include training the machine learning model based on comparing the actual travel time to the predicted travel time.

According to some embodiments, a machine learning method includes the steps of receiving a request from a connected-automated vehicle; executing a trained machine learning model; providing input features to the machine learning model associated with the request from the connected-automated vehicle, the input features comprising: a route of travel for the connected-automated vehicle, the route of travel including a managed lane and a non-managed lane; real-time traffic sensor data from one or more of lidar, radar, infrared, microwave, optical, or doppler sensors disposed along the route of travel, the real-time traffic sensor data including one or more of a traffic speed and a traffic density; and historical data of travel times along the route; predicting, by the machine learning model, an estimated future traffic prediction for the route during a time block; predicting, by the machine learning model, an estimated travel time along the route for the managed lane and the non-managed lane during the time block; returning, to the connected-automated vehicle the estimated travel time along the route for the managed lane and the non-managed lane; receiving, from the connected-automated vehicle, an acceptance of the route of travel including the managed lane; and providing the acceptance of the route of travel including the managed lane to the machine learning model for use in subsequent estimated future traffic predictions.

According to some embodiments, a traffic optimization system includes a plurality of real-time roadway sensors including one or more of lidar sensors, radar sensors, infrared sensors, microwave sensors, optical sensors, and doppler sensors, the plurality of real-time roadway sensors disposed along a roadway having a plurality of segments, each segment having a managed lane and a non-managed lane, wherein the plurality of real-time roadway sensors are configured to determine real-time traffic data comprising vehicle count, speed, volume, and density associated with each of the plurality of segments; a traffic database storing historical traffic data for the plurality of segments of the roadway; a network interface configured to receive a route request from a connected-automated vehicle, the route request including a starting point, a destination, a route along the roadway from the starting point to the destination, and an estimated time of arrival at an entry point of the managed lane; a future traffic conditions prediction server comprising a memory and a processor executing instructions stored in the memory, the instructions causing the processor to: receive, via the network interface, the route request from the connected-automated vehicle; retrieve, from the traffic database, historical traffic data associated with the route at the estimated time of arrival at the entry point of the managed lane; receive, from the plurality of real-time roadway sensors, real-time traffic data for the route; input the historical traffic data, the real-time traffic data, and the estimated time of arrival into a machine learning model trained on historical patterns to predict future traffic conditions; predict, using the machine learning model, an estimated travel time for the managed lane and the non-managed lane along the route at the estimated time of arrival; determine, based on the estimated travel times, a time savings for traveling in the managed lane; transmit, via the network interface, the estimated travel time for the managed lane, the estimated travel time for the non-managed lane, and the time savings to the connected-automated vehicle; receive, via the network interface, an acceptance from the connected-automated vehicle to travel in the managed lane; update the machine learning model with the acceptance from the connected-automated vehicle; and predict, using the updated machine learning model, future estimated travel times for additional connected-automated vehicles; a plurality of segment agents, each segment agent associated with one of the plurality of roadway segments, wherein each segment agent is configured to monitor real-time traffic data from roadway sensors in its associated roadway segment and communicate the real-time traffic data to the future traffic conditions prediction server; and a coordination agent in communication with each of the plurality of segment agents, the coordination agent configured to generate and transmit instructions to each segment agent to control traffic flow in the managed and non-managed lanes based on the predicted future estimated travel times from the future traffic conditions prediction server. It should be appreciated that many of the components, features, methods, and benefits can be used with any of the embodiments described herein in various combinations to tailor a specific system and method to a particular roadway or series of roadways.

Aspects of the presently disclosed technology further include computing systems configured to perform these methods, and computer-readable storage media for performing these methods. The presently disclosed technology is not, however, limited to only these features, and includes such other features and embodiments as are described herein.

### BRIEF DESCRIPTION OF THE DRAWINGS

Included in the present specification are figures which illustrate various embodiments of the present disclosed technology. As will be recognized by a person of ordinary skill in the art, actual embodiments of the disclosed technology need not incorporate each and every component illustrated, but may omit components, add additional components, or change the general order and placement of components. Reference will now be made to the accompanying figures and flow diagrams, which are not necessarily drawn to scale, and wherein:

FIG. 1 depicts a computing device in accordance with some embodiments.

FIG. 2 depicts a cloud computing environment in accordance with some embodiments.

FIG. 3 depicts an example system architecture for a traffic management system, in accordance with some embodiments.

FIG. 4 depicts an example system for analyzing and clustering historical data in accordance with some embodiments.

FIG. 5 depicts example methods for assigning new data to existing clusters of data, in accordance with some embodiments.

FIG. 6 depicts a computer-implemented method in accordance with some embodiments.

FIG. 7 illustrates a schematic block diagram of a tolling system sharing a toll price interval and travel time saved with a connected-automated vehicle, in accordance with some embodiments.

FIG. 8 is a process flow diagram for sharing a toll price interval and travel time saved with a connected-automated vehicle, in accordance with some embodiments.

FIG. 9 is an illustrative example of a connected-automated vehicle navigation application display of trip planning information used for receiving toll price intervals and estimated travel time saved, in accordance with some embodiments.

FIG. 10 is a process flow diagram for trip planning by receiving toll price intervals and estimated travel time saved, in accordance with some embodiments.

FIG. 11 is a block diagram illustrating systems and a methodology for a toll system that determines and assigns a future toll price interval and determining a travel time saved, in accordance with some embodiments.

FIG. 12 is a process flow diagram for assigning a future toll price interval and determining travel time saved, in accordance with some embodiments.

FIG. 13 illustrates a multi-agent reinforced machine learning system that monitors segments of a roadway to maximize throughput, in accordance with some embodiments.

FIG. 14 depicts a promotional pricing platform system architecture for generating, communicating, administering, and measuring promotional offers for managed lane usage, in accordance with some embodiments.

FIG. 15 depicts a promotional pricing lifecycle including customer acquisition, offer strategy, promotions and discount administration, customer support, and measurement and optimization stages, in accordance with some embodiments.

FIG. 16 depicts an end-to-end data flow for a promotional pricing platform interacting with marketing systems, customer devices, analytics systems, communication services, customer support services, roadway tolling systems, and an operational back office, in accordance with some embodiments.

FIG. 17 depicts a customer acquisition and onboarding flow for enrolling a customer, verifying customer information, associating a vehicle with the customer, receiving notification consent, and presenting an offer, in accordance with some embodiments.

FIG. 18 depicts a data model for customer accounts, vehicles, tags, segments, offers, campaigns, claimed offers, trips, discounts, savings records, and message variants, in accordance with some embodiments.

FIG. 19 depicts an administrative interface for managing campaigns, offers, and segments of a promotional pricing platform, in accordance with some embodiments.

FIG. 20 depicts an offer configuration interface and corresponding offer object used to generate eligibility and application rules for toll discounts, in accordance with some embodiments.

FIG. 21 depicts a process for bulk vehicle tagging and segment creation for campaign targeting, in accordance with some embodiments.

FIG. 22 depicts a personalized offer generation and optimization system using customer, vehicle, tolling, engagement, support, and roadway condition data, in accordance with some embodiments.

FIG. 23 depicts an operational back office integration flow for determining discount eligibility, applying discounts to toll transactions, and updating offer progress and savings records, in accordance with some embodiments.

FIG. 24 depicts a consumer offer lifecycle including offer presentation, offer claiming, progress tracking, threshold satisfaction, discount application, and expiration or redemption, in accordance with some embodiments.

FIG. 25 depicts a savings dashboard and transaction detail view for displaying aggregated and transaction-level savings from applied toll discounts, in accordance with some embodiments.

### DETAILED DESCRIPTION

The following detailed description is directed to machine learning systems, methods, and computer-readable media for determining and predicting current and future roadway conditions and communicating with connected-automated vehicles in response to queries related to the current and future roadway conditions.

Although example embodiments of the present disclosure are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which have no influence on the scope of the present disclosure.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps of a method or process does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

In the following detailed description, references are made to the accompanying drawings that form a part hereof and that show, by way of illustration, specific embodiments or examples. In referring to the drawings, like numerals represent like elements throughout the several figures.

Various products and services provided by third parties are mentioned as example components of embodiments in accordance with the disclosed technologies. The use of trademarked (registered or common-law) names are intended for descriptive purposes only no claim of ownership over the terms is asserted by the applicants. Further, the mention of a trademarked product or service is as an example only. Other products and services providing equivalent functions, whether commercial, open-source, or custom-developed to support embodiments are contemplated in accordance with the disclosed technology.

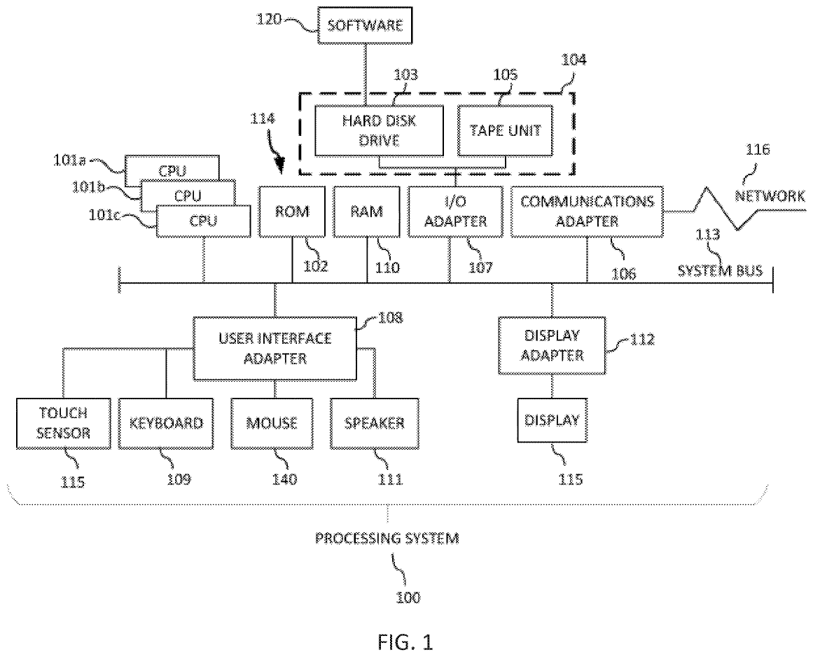

Referring now to FIG. 1, there is shown an embodiment of a processing system 100 for implementing the teachings herein. In this embodiment, the processing system 100 has one or more central processing units (processors) 101a, 101b, 101c, etc. (collectively or generically referred to as processor(s) 101). Processors 101, also referred to as processing circuits, are coupled to system memory 114 and various other components via a system bus 113. Read only memory (ROM) 102 is coupled to system bus 113 and may include a basic input/output system (BIOS), which controls certain basic functions of the processing system 100. The system memory 114 can include ROM 102 and random access memory (RAM) 110, which is read-write memory coupled to system bus 113 for use by processors 101.

FIG. 1 further depicts an input/output (I/O) adapter 107 and a network adapter 106 coupled to the system bus 113. I/O adapter 107 may be a small computer system interface (SCSI) adapter that communicates with a hard disk (magnetic, solid state, or other kind of hard disk) 103 and/or tape storage drive 105 or any other similar component. I/O adapter 107, hard disk 103, and tape storage drive 105 are collectively referred to herein as mass storage 104. Software 120 for execution on processing system 100 may be stored in mass storage 104. The mass storage 104 is an example of a tangible storage medium readable by the processors 101, where the software 120 is stored as instructions for execution by the processors 101 to implement a circuit and/or to perform a method. Network I communications adapter 106 interconnects system bus 113 with an outside network 116 enabling processing system 100 to communicate with other such systems. A screen (e.g., a display monitor) 115 is connected to system bus 113 by display adapter 112, which may include a graphics controller to improve the performance of graphics intensive applications and a video controller. In one embodiment, adapters 107, 106, and 112 may be connected to one or more I/O buses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 140, and speaker 111 can be interconnected to system bus 113 via user interface adapter 108, which may include, for example, a Super I/O chip integrating multiple device adapters into a single integrated circuit.

Thus, as configured in FIG. 1, processing system 100 includes processing capability in the form of processors 101 and storage capability including system memory 114 and mass storage 104, input means such as a keyboard 109, mouse 140, or touch sensor 115 (including touch sensors 109 incorporated into displays 115), and output capability including speaker 111 and display 115. In one embodiment, a portion of system memory 114 and mass storage 104 collectively store an operating system to coordinate the functions of the various components shown in FIG. 1.

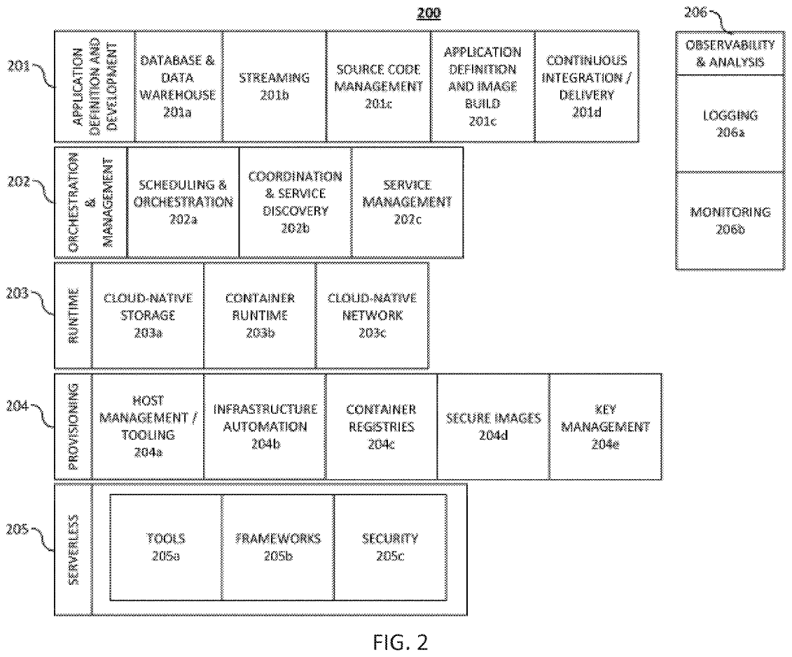

Embodiments of the present technology can also be implemented using cloud-based technologies, such as those depicted in FIG. 2. Cloud native technologies include scalable applications in modern, dynamic environments such as public, private, and hybrid clouds. Containers, service meshes, microservices, immutable infrastructure, and declarative APIs exemplify this approach. These techniques enable loosely coupled systems that are resilient, manageable, and observable.

Embodiments of the disclosed technology can be built using one or more elements of cloud computing technology as shown in FIG. 2. Cloud technologies can include application definition and development tools 201, orchestration & management tools 202, runtime tools 203, provisioning tools 204, serverless components 205, and observability & analysis tools 206.

Application definition and development components 201 (“ADD”) enable developers to define and develop applications prior to deployment, and to refine those designs in subsequent versions. ADD components 201 can include database and data warehouse components 201a that provide data sets and data storage for application development. These database and data warehouse components 201a include relational and non-relational data stores, graph databases, flat files, and other data storage technologies. ADD components 201 can further include streaming components 201b that facilitate rapid distribution of data to numerous system endpoints, such as message queues, stream processing software, and other data distribution systems. ADD components 201 can further include source code management components 201c, such as Git, Mercurial, Subversion, and other similar source management systems. Source code management components 201c can also include cloud-based servers for version control, such as GitHub or GitLab. ADD components 201 can further include application definition and image build components 201c that allow developers to define cloud-based infrastructure, including configurations of application servers, software defined networks, and containerized services. ADD components 201 can further include continuous integration and continuous delivery (CI/CD) components 201d that automate the process of application testing and deployment. CI/CD components 201d can be configured to automatically run automated tests on application software (e.g., when a change is committed to a version control platform), and if the tests are successful, to deploy the application software to a production environment.

Orchestration and management (“OM”) components 202 facilitate the containerization and subsequent coordinated execution of application software. OM components 202 include scheduling and orchestration components 202a that schedule and run containerized software. Non limiting examples of scheduling and orchestration components 202a include Kubernetes and Docker Swarm. OM components 202 can further include coordination and service discovery components 202b that allow software to automatically discover cloud-based resources, such as data stores, data streaming sources, etc. OM components can further include service management components 202c that can include load balancers, reverse proxy systems, auto scalers, and other components that facilitate autonomous or manual application scaling.

Runtime components 203 can include basic environments to support execution of cloud based application software. Runtime components 203 can include cloud-native storage 203a, such as object stores, virtual file systems, block storage, and other forms of cloud-centric data storage. Runtime components 203 can include container runtimes 203b that provide the foundation for containerized application software, such as Docker or Rkt. Runtime components 203 can further include cloud-native network components 203c that provide software-defined networking and virtual private cloud technologies that enable components of cloud-based systems to communicate with each other, as well as with the wider Internet.

Provisioning components 204 can include components intended for configuring cloud components and triggering the creation of cloud resources on various cloud platforms. Provisioning components can include Host Management and Tooling components 204a that define and deploy configurations of cloud components when executed. Provisioning components 204 can further include infrastructure automation components 204b that automate basic cloud infrastructure tasks. Provisioning components 204 can further include container registries 204c that provide storage for containerized cloud applications that are deployable by other provisioning components. Provisioning components can further include secure image components 204d that provide security and verification for container images to ensure consistent and reliable deployment of trusted container images. Provisioning components can further include key management systems 204e that provide for secure storage of cryptographic keys.

Serverless components 205 can include components for deploying cloud applications that do not rely upon a continuously running (or scheduled) runtime execution, but instead run discrete components of functionality given a condition. Serverless components 205 can include components 205a to simplify the development of serverless applications, such as components that convert server-centric software into serverless code, event simulators, and simulations of cloud based serverless platforms. Serverless components 205 can also include frameworks 205b that are predefined systems that take code in certain configurations and deploy them as serverless applications in cloud environments. Serverless components 205 can also include security components 205c that help to secure serverless applications.

Observability & Analysis components (“O&A”) 206 can include systems for monitoring running cloud applications, detecting and observing defects and errors, and logging system performance. O&A components 206 can include monitoring components 206a that monitor running systems to display and/or record performance metrics, error rates, and other application data. O&A components 206 can also include logging components 206b that collect system logs from cloud-based components and aggregate them in a single place or to a single access point to review system performance. O&A components 206 can also include tracing components 206c that collect detailed trace logs when cloud components run into errors, system exceptions, and other problematic behaviors to assist in the identification and remediation of problems in cloud-based systems.

In some embodiments, one or more methods are embodied in a set of instructions for one or more processors having access to one or more types of memory. The instructions could be coded in hardware or in software. Many kinds of platforms may be used, including, but not limited to: computers, mobile devices, tablets, game consoles, network management devices, field programmable gate arrays, and cloud-based computer systems. Aspects of the disclosure could be deployed on multiple devices for concurrent operation. Embodiments may be used as a component of a larger system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD ROM), an optical storage device, a magnetic storage device, or any suitable combination of the foregoing. In some embodiments, the computer readable medium can be a non-transitory storage system on a cloud platform, such as, for example, in a database or data warehouse component 201a, a source code management tool 201c, cloud-native storage component 203a, embodied in a container image stored locally or in a container registry 204c, or deployed in a container runtime 203b. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to wireless, wireline, optical fiber cable, RF, etc., or any suitable combination of the foregoing.

Computer program code for carrying out operations for aspects of the present invention may be written in any combination of one or more programming languages, including languages such as Java, Python, Go, Ruby, JavaScript, Smalltalk, C++ or the like. As defined herein, computer program code also includes the build artifact of any of the above languages, or similar languages and environments, such as object code, byte- or word-code, or other compiled, interpreted, or processed code. The program code may execute entirely on the user's computer, partly on the user's computer, as a stand-alone software package, partly on the user's computer and partly on a remote computer or entirely on one or more remote computers, servers, or serverless cloud platforms. In the latter scenario, the remote computer may be connected to the user's computer through any type of network, including a local area network (LAN) or a wide area network (WAN), or the connection may be made to an external computer (e.g., through the Internet using an Internet Service Provider).

Aspects of embodiments of the present invention that are described above with reference to flowchart illustrations and/or block diagrams of methods, apparatus (systems) and computer program products according to embodiments of the invention. The flowchart and/or block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It will be understood that each block of the flowchart illustrations and/or block diagrams, and combinations of blocks in the flowchart illustrations and/or block diagrams, can be implemented by computer program instructions. These computer program instructions may be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The disclosed technology is disclosed in terms of modules and submodules, each of which are to be understood as discrete units of functionality, which can be embodied as classes, modules, functions, compilation or build artifacts, or other components of one or more programming languages used to implement embodiments of the disclosed technology. While the present description illustrates one organization of the various modules and submodules for implementing embodiments of the disclosed technology, the invention is not so limited. Embodiments of the presently disclosed technology can include other organizations for implementing equivalent or overlapping functionality for the various modules described herein, such as by sharing functionality between modules, combining modules, separating modules into multiple modules, implementing class hierarchies and the like. Additionally, the accompanying drawings illustrate example relationships between various modules and submodules (such as by flowchart connectors or inclusion of modules as sub-modules of other modules), but these relationships are not limiting. As would be recognized by a person of ordinary skill in the art, the output of any given module is available to be included as part of the input of any other component in accordance with various embodiments. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatuses, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein were chosen and described in order to best explain the principles of the invention and the practical application, and to enable others of ordinary skill in the art to understand the invention for various embodiments with various modifications as are suited to the particular use contemplated.

Technical effects and benefits include reducing travel time for vehicles, improving revenue generation from toll roads, and improved roadway safety from actively managed roadways.

In some embodiments, the traffic data management system performs a calculation and makes a decision based on the input data for a time interval on a road segment, such as input data received in real time. Examples of such a calculation can include determining a preferred route from a plurality of routes, determining a speed limit for a road segment, or determining a toll rate for a road segment. In some embodiments, a pre-existing system can be in use that makes such decisions using a predetermined algorithm, such as a programmed function, machine learning model, artificial neural network, or other computational system. In such embodiments, the presently disclosed technology can be used to detect instances where the decision made by the predetermined algorithm is anomalous or otherwise unexpected. By implementing the disclosed technology in such circumstances, the health of the predetermined algorithm can be monitored, or the predetermined algorithm can be augmented to produce less anomalous or non-anomalous results. In other embodiments, the predetermined algorithm can be omitted, and instead, a calculation can be performed solely as a result of the techniques discussed herein.

An example embodiment of the disclosed technology is in a managed toll lane system (MTLS). Such a system can comprise one or more road segments, where at least one of the road segments includes both managed and unmanaged lanes. The MTLS can receive historical data, including the toll price charged, for the road segments as described above. The toll price in the historical data can be obtained from a predetermined algorithm, such as a preexisting tolling model implemented by the MTLS.

The MTLS can then vectorize the historical data, and train an isolation forest from that data. The historical data can be annotated with anomaly scores from the isolation forest, and then those rows in the historical data with an anomaly score above a threshold can be clustered into one or more anomaly clusters. Support staff can then review the rows falling within each one of the clusters to determine an adjustment rule that should apply to points within that cluster. The presence of the historical data means that such adjustments can be applied to the historical data, and anomaly scores recalculated to observe whether the adjustments reduced the anomaly scores within the cluster.

Alternatively, as described above, the MTLS can determine adjustment rules for each cluster automatically in accordance with the techniques previously described. While the MTLS is in service, it can monitor real-time input data corresponding to a time interval, and calculate an anomaly score corresponding to that interval. If the anomaly score exceeds a predetermined threshold, the MTLS can then categorize the real-time input data into one of the anomaly clusters. For example, a centroid can be calculated for the anomalous rows in each anomaly cluster in the historical data, and then the distance of the vectorized input data can be calculated to each centroid. The cluster having the nearest centroid is likely to be the cluster to which the real-time data corresponds. The MTLS can then apply the adjustment rule corresponding to that cluster. An MTLS is a single example of a traffic management system in accordance with an embodiment, however, other traffic management systems (“TMS”) are contemplated hereby.

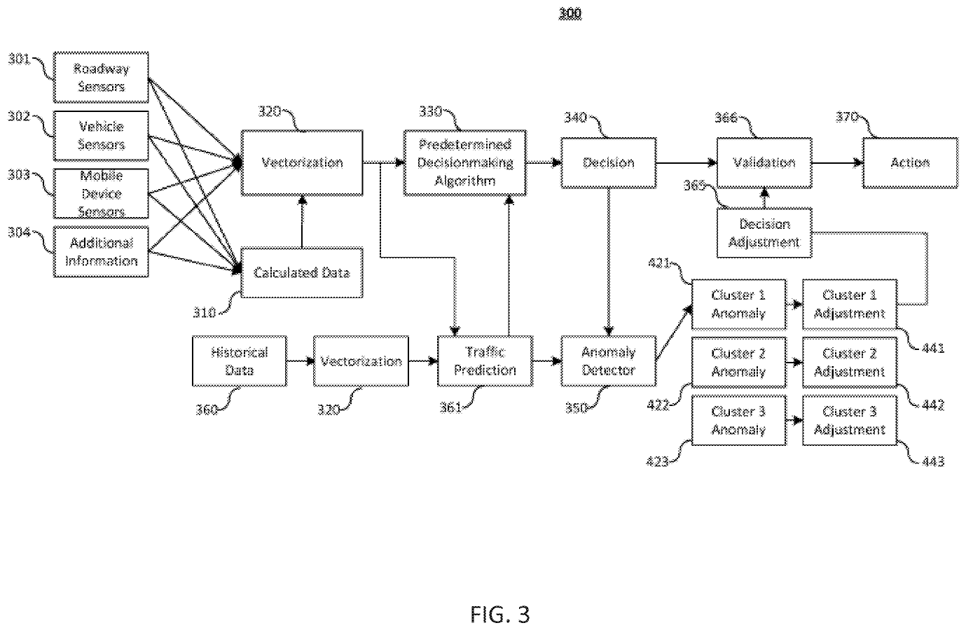

FIG. 3 depicts a TMS 300 in accordance with an embodiment. Such a system can receive data from a plurality of sources, including, but not limited to (1) sensors mounted on or in proximity to the roadway 301, (2) sensors mounted on vehicles 302, or (3) sensors contained within an individual's mobile devices 303 and other devices. Such sources are not intended to be limiting; aspects of the present invention can also include data obtained about the roadway and traffic conditions thereon regardless of source. The data received by the system can comprise various attributes about traffic conditions at the time the measurement is taken, such as speed, relative spacing between vehicles, current lane, how many vehicles have passed over a current spot, etc. In some embodiments, such as those implemented on managed toll lanes, other types of data can be collected, such as toll counts (e.g., how many vehicles have paid a toll, either by stopping at a physical booth, or passing through a sensing gate (e.g., RFID reader, license plate reader, etc.).

Additional information 304 can also be received that is not directly related to traffic, but has an impact on traffic. Such data can include date and time information, such as the current time of day or calendar date. Such data can also include special date information, such as whether a day is a weekday, weekend, or holiday, whether local schools are in session, whether the city offices are open or closed (e.g., due to a natural disaster), etc. Such data can also include special event information, such as whether there is a major event (sporting event, convention, etc.) occurring in the vicinity, construction projects, etc. Such data can also include weather information, such as whether it is raining, rainfall rates, current temperature, current cloud cover, wind speed, wind direction, and hazardous weather alerts (flash flood warnings/watches, hurricane/tornado warnings/watches, etc.).

From this raw data, additional data attributes can be calculated (“calculated traffic data 310”). This can include simple calculation of vehicle detection rates from detection counts, applying categorical thresholds (e.g., is the atmospheric temperature above or below freezing?), or other similar calculations. More advanced calculations can be applied, such as, for example, calculating a probability of ice on the road. Such a calculation may need to take into account, for example, rainfall rates, current temperature, relative humidity, and how long it has been raining.

Data obtained by the TMS can be provided as real-time information, and/or as a historical data set 360 comprising any of the data discussed above over a period of time. Preferably, the same data attributes available in the real-time data are available in the historical data set.

Calculated traffic data 310 for a time interval can also include predicted future information about the road segment, or other road segments. Predicted future information can be based on historical data for similar times and dates, based on extrapolating current information based on recent trends, or produced as the result of a predictive machine learning system (e.g., an artificial neural network, SVM, or other decision model). A collection of data attributes for each time interval, for each road segment can comprise an input data row, and a collection of input data rows for a plurality of time intervals and/or road segments can comprise an input data set. This input data set can then be vectorized into a vectorized data set.

Conversion of the input data attributes into a vector can be referred to as vectorization 320. To facilitate analysis of the input data set, the data attributes for each input row can be converted into a vector in n-dimensional space, wherein each dimension is one of the data attributes for the interval, and the magnitude of the interval in each dimension is calculated as a function of the data attribute. Vectorization of the data can comprise applying one or more rules to one or more attributes of the data set. In some embodiments, vectorization rules can comprise encoding rules, feature selection rules, standardization rules, and dimensionality reduction rules. However, as would be recognized by a person of ordinary skill in the art, each of these categories of steps may be omitted in certain circumstances. For example, if all data attributes are already numeric, no encoding is necessary.

Encoding steps convert one or more attribute values into a format suitable for analysis. For example, attribute values can be organized into time intervals. Such intervals can be short, such as a second, a minute, or five minutes, or can be longer, such as a half-hour, hour, 6 hours, 12 hours, 1 day, or more. Each interval can comprise a plurality of data attributes selected or calculated from the raw traffic data and calculated traffic data, and corresponding to that interval. Such attributes can be a single representative value from the time interval (e.g., mean/median/average roadway speed for a particular segment), or a plurality of representative values (e.g., 25-50-75 percentiles for roadway speed in the interval). Attributes for a time interval can also include information from past intervals, such as, for example, average roadway speed for a segment for the last 1, 2, 5, or 10 intervals. Attributes for a time interval can also include information from other road segments that are adjacent to, feed into, or out of, or otherwise affect roadway conditions on the road segment.

As another example of encoding, if the attribute has an ordinary numeric value, the number can be used as-is (or cast to an appropriate data type, e.g., integers, doubles, etc.). Alternatively, such numeric values can be binned or binarized. For example, if the distribution of a data attribute runs from 0 to 500, the distribution could be binned into groups of 100 (e.g., bin 0:0-100, bin 1:101-200, bin 2:201-300, bin 3:301-400, bin 4:401-500), and encoded into bin position (e.g., 55 minutes=>0, 198 minutes=>1). Binarization is a special case of binning with two bins, where a threshold value is determined, and values are encoded as either 0 for below the threshold, or 1 for above the threshold.

If the attribute is ordered categorical data, the categorical data can be encoded as an integer value indicating its position. The attributes can also be vectorized into standard deviations from a mean value. If the attribute is a compound data object, such an array, structure, map, or similar indexed/keyed data structure, the vectorization rule can be a function to perform on the data to extract a numeric value, such as picking a particular value from the structure, or calculating a statistic based on the structure. In some embodiments, the vectorization rules can produce multiple output columns for one or more input columns. For example, a single numeric value can be vectorized into a first column by using the numeric value directly and into a second column as a bin number. Alternatively, a vectorized column can be vectorized as a ratio or comparison between multiple input columns

Vectorization 320 can also comprise standardization rules to standardize, scale, center, or perform other statistical numeric transformations. Such transformations can include scaling the values to a range (e.g., normalization between 0 and 1), centering on average value, scaling to a known distribution (e.g., Gaussian distribution), filling in missing data (e.g., either a zero or a computed value such as an average value), or eliminating outliers (e.g., data beyond a certain distance, such as number of standard deviations, from the mean).

Vectorization 320 can also comprise dimensionality reduction techniques. As is known in the art, machine learning and statistical estimation often suffers from the “curse of dimensionality,” having too many dimensions or degrees of freedom to feasibly calculate. Therefore, vectorization can, in some embodiments, comprise dimensionality reduction techniques, such as principal component analysis (PCA), non-negative matrix factorization (NNMF), and latent Dirichlet allocation (LDA), and other techniques known in the art.

Vectorization 320 can also comprise feature selection criteria. In some embodiments, not all attribute values are used. In general, it is desirable for the selected data attributes to not be highly correlated with each other. From the available attribute values, certain attributes can be included or excluded based on industry expertise or hypotheses about correlations in the data. Using multiple highly correlated input values can increase the computational complexity of training the model without meaningfully improving performance. One method of eliminating correlated data is to calculate a correlation coefficient between each pairwise set of attribute values, aggregating attributes into groups or categories of correlated attribute values, and then dropping all but one or a few of the correlated attribute values in each of the groups of correlated attribute values. This correlation coefficient-based technique can be applied at any stage of the vectorization process, either to the raw attribute values, encoded attribute values, or standardized attribute values.

In some embodiments, a traffic prediction 361 step can be applied to vectorized data. In this step, the values of the vectorized traffic data is predicted at a predetermined time interval in the future. Any predicting modeling technique as is known by a person of ordinary skill in the art can be used for traffic prediction 361, including but not limited to regression techniques. In some embodiments, traffic prediction 361 can be performed using an artificial neural network. In some embodiments, such artificial neural network can utilize architectures intended to predict time series information, such as a recurrent neural network, or long-term / short-term memory (LTSM) network.

In some embodiments, a TMS 300 can include a predetermined decisionmaking algorithm 330. This algorithm can comprise a pre-existing module, system, or other pre-existing component for receiving input data 301-304 and producing a decision 340. The predetermined decisionmaking algorithm 330 can comprise a plurality of rules, if-then statements, or other procedural software in some embodiments. In some embodiments, the predetermined decisionmaking algorithm 330 can receive as input vectorized data 320 or predicted traffic data from traffic prediction technique 361. In some embodiments, the predetermined decisionmaking algorithm 330 can comprise a machine learning model, such as an artificial neural network, decision tree, support vector machine, or other similar model. The predetermined decisionmaking algorithm 330 can produce a decision 340, such as a decision to set or adjust a toll price (in the case of a MTLS), or to set or adjust other traffic related features, such as speed limits, traffic flow control devices, automatic gates, lighting or signage, and other similar features.

In some embodiments, the traffic management detection system can comprise an anomaly detection technique 350, performed on either the input data alone (either vectorized 320 or not), or the input data combined with a decision 340 made by the TMS 300. In some embodiments, the anomaly detection technique 350 can be performed using predicted traffic data generated by traffic prediction technique 361. This anomaly detection 350 can be performed against a historical data set 360 that comprises prior input data 301-304 (either vectorized 320 or not) and prior decisions 340 (if a predetermined decisionmaking algorithm 330 is present) to determine, for example, whether the current input data 301-304 is anomalous, or whether the decision 340 in view of the input data 301-304 is anomalous. The historical data 360 can comprise, for example, data from the prior month, prior year, or any other time interval. Such historical data can also be a trailing window of data-such as the prior six months, prior year, etc.

Examples of anomaly detection techniques that can be performed include a robust covariance, one-class support vector models, isolation forests, and Local Outlier Factor (“LOF”), among other anomaly detection techniques as are known in the art. One class of techniques that are useful for embodiments are isolation forests. This technique takes advantage of two quantitative properties of anomalies: i) they are the minority consisting of few instances, and ii) they have attribute-values that are very different from those of normal instances. In other words, anomalies are ‘few and different’, which make them more susceptible to isolation. Isolation can be implemented by any means that separates instances. One method is to use a binary tree structure called an isolation tree (iTree), which can be constructed effectively to isolate rows. Because of the susceptibility to isolation, anomalies are more likely to be isolated closer to the root of an iTree; whereas normal points are more likely to be isolated at the deeper end of an iTree.

Isolation Forest (iForest) techniques build an ensemble of iTrees for a given data set; anomalies are those instances which have short average path lengths on the iTrees. There are two training parameters and one evaluation parameter in this method: the training parameters are the number of trees to build and subsampling size; the evaluation parameter is the tree height limit during evaluation. We show that iForest's detection accuracy converges quickly with a very small number of trees; it only requires a small subsampling size to achieve high detection accuracy with high efficiency; and the different height limits are used to cater for anomaly clusters of different density.

Isolation means “separating an instance from the rest of the instances.” In general, an isolation-based method measures individual instances' susceptibility to be isolated; and anomalies are those that have the highest susceptibility. To realize the idea of isolation, data structures can be used that naturally isolate data. In randomly generated binary trees where instances are recursively partitioned, these trees produce noticeable shorter paths for anomalies since (a) in the regions occupied by anomalies, less anomalies result in a smaller number of partitions-shorter paths in a tree structure, and (b) instances with distinguishable attribute-values are more likely to be separated early in the partitioning process. Hence, when a forest of random trees collectively produce shorter path lengths for some particular points, they are highly likely to be anomalies.

Anomaly detection using iForest is a two-stage process. The first (training) stage builds isolation trees using sub-samples of the given training set. The second (evaluation) stage passes test instances through isolation trees to obtain an anomaly score for each instance. In the training stage, iTrees are constructed by recursively partitioning a sub-sample X′ until all instances are isolated. Details of the training stage can be found in Algorithms 1 and 2. Each iTree is constructed using a sub-sample X′ randomly selected without replacement from X, X′⊂X.

In some embodiments, there are two input parameters to the iForest algorithm: the subsampling size ψ and the number of trees t. Subsampling size ψ controls the training data size. We find that when ψ increases to a desired value, iForest detects reliably and there is no need to increase ψ further because it increases processing time and memory size without any gain in detection accuracy. As we assume that anomalies are few and different, normal points are also assumed to be many and similar. Under these assumptions, a small subsampling size is enough for iForest to distinguish anomalies from normal points. Number of trees t controls the ensemble size. We find that path lengths usually converge well before t=100. At the end of the training process, a collection of trees is returned and is ready for evaluation. The worse case time complexity of training an iForest is O(tψ2) and the space complexity is O(tψf).

In the evaluation stage, a single path length h(x) is derived by counting the number of edges e from the root node to an external node as instance x traverses through an iTree. When the traversal reaches a predefined height limit hlim, the return value is e plus an adjustment c(Size). This adjustment accounts for estimating an average path length of a random sub-tree which could be constructed using data of Size beyond the tree height limit. When h(x) is obtained for each tree of the ensemble, an anomaly score is computed. The anomaly score and the adjustment c(Size) are to be defined in the next subsection. The worse case time complexity of the evaluation process is O(ntψ), where n is the testing data size.

An anomaly score can be calculated for each row in a data set. Since iTrees have an equivalent structure to Binary Search Tree (“BST”), the estimation of average h(x) for external node terminations is the same as that of the unsuccessful searches in BST. We borrow the analysis from BST to estimate the average path length of iTree. Given a sample set of ψ instances, the average path length of unsuccessful searches in BST is:
where H(i) is the harmonic number and can be estimated by [symbol] n(i)+0.5772156649 (Euler's Constant). As c(ψ) is the average of h(x) given ψ, it can be used to normalize h(x). The anomaly score s of a row can then be defined as, for example:

A point is more likely to be an anomaly as the score approaches 1, and less likely to be anomalous as the score approaches 0. A point can then be determined to be anomalous if the anomaly score is over a particular threshold, such as, for example, 0.5.

Isolation forests techniques are well-suited for embodiments of the disclosed technology, because they work well for highly-dimensional data, and are computationally efficient. Many implementations have linear or near-linear complexity bounds (i.e. O(n)). Further, isolation forests can facilitate visualization of outlier boundaries, as contours of a constant anomaly score can be calculated. By applying an isolation forest to the input data, an anomaly score can be calculated for each input value. Further, by training an isolation forest, the same forest can be applied to future data to calculate an anomaly score given the historical data set. In some embodiments, an isolation forest technique can be performed on a vectorized historical data set, and the anomaly score calculated for each, or a plurality of, rows in the vectorized historical data set. These anomaly scores can be added as an additional dimension of the vectorized historical data set.

In embodiments where anomaly detection 350 is not performed on decisions made by a predetermined algorithm 330, anomaly detection 350 can be used to monitor the health of the input data sources 301-304. That is, rows having a high anomaly score can indicate that sources of input data 301-304 are not operating correctly, or that the roadway is experiencing a rare and unexpected set of circumstances. In embodiments where the anomaly detection 350 is performed on decisions 340 made by a predetermined algorithm 330, anomaly detection 359 can be used to monitor the health of the predetermined algorithm. That is, combinations of input data 301-304 and a decision 340 having a high anomaly score may indicate suboptimal performance of the predetermined algorithm 330, and identify instances where the predetermined algorithm 330 should be modified or augmented. In some embodiments, the anomaly scores of historical data can be analyzed to identify times in the past where erroneous or unexpected behavior has occurred, or the anomaly score of real time data can be calculated to determine whether an anomalous condition is currently occurring. Such embodiments follow the same data path as the TMS 300 described herein, but the input data 301-304 is simulated from a point in time from the historical data 360.

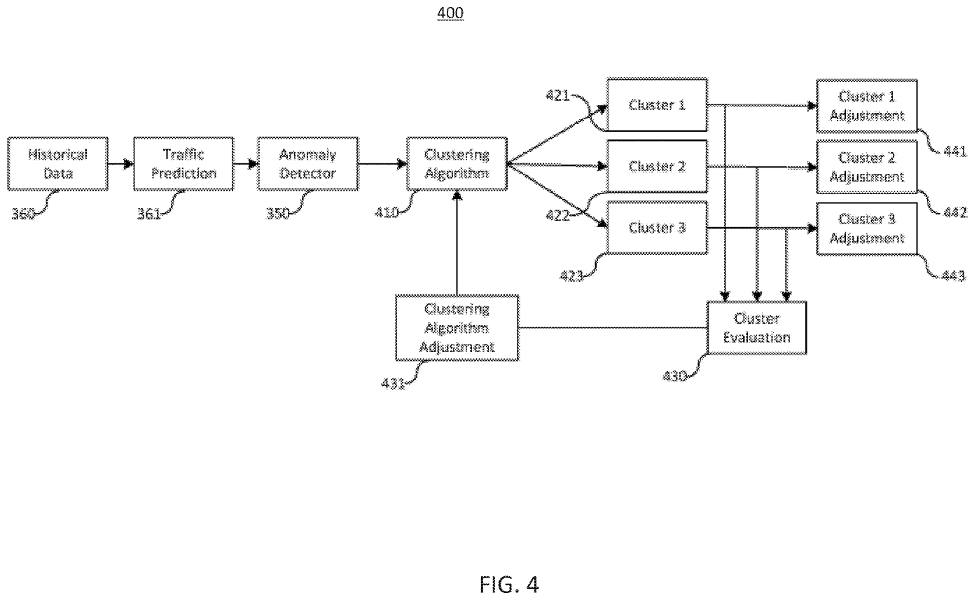

FIG. 4 depicts a process identifying anomaly types 400, in accordance with an embodiment. In some embodiments, a historical data set 360 that has been annotated with anomaly scores by the anomaly detector 350 can be used to identify particular types of anomalies using a clustering algorithm 410. In some embodiments, the anomaly scores are calculated by the anomaly detector 350 based on predicted traffic data produced by a traffic prediction technique 361. In some embodiments, identification of anomaly types can be used to assist support staff in identifying the failure mode and correcting the anomalous conditions. In some embodiments, the identified anomaly types can be automatically corrected by a TMS in accordance with embodiments. This clustering 410 can either be performed on all historical input data, to determine clusters of similar points generally, or can be applied only to that historical data that is considered “anomalous” as determined by an anomaly detection technique.

To identify anomaly types, a clustering algorithm 410 can be performed on the vectorized data set. This clustering can be performed by an automatic segmentation mechanism, wherein each row in the vectorized data set is divided into groups, where each row in the group is relatively similar to others in the group, and is relatively dissimilar from members of other groups. A variety of techniques exist for clustering data in this manner. Automatic clustering algorithms that are known in the art include k-Means, Affinity Propagation, Mean Shift, Spectral Clustering, Ward Clustering, Agglomerative Clustering, DBSCAN, Birch, and Gaussian Mixture. Each of these techniques first require as input a plurality of points in n-dimensional space, such as vectorized data 320.

In some embodiments, the clustering algorithm 410 can be provide a predetermined number of groups into which to subdivide the input data. In some embodiments, the number of groups can be programmatically selected by repeating the clustering algorithm with various numbers of groups, and evaluating the quality of the clusters, and selecting a number of groups that provides the best performance. In such a process, the quality of the individual clusters can be evaluated 430, and adjustments 431 to the clustering algorithm can be made based on that evaluation. Many clustering algorithms, likewise, can use various distance measures to evaluate the quality of individual clusters. While the default in most circumstances is Euclidean distance (e.g., straight line distance), many other distance metrics can be used, such as squared Euclidean distance, standardized Euclidean distance, cosine distance, Manhattan distance, Bray-Curtis distance, Canberra distance, Chebyshev distance, Jensen-Shannon distance, Mahalanobis distance, Minkowski distance, and other distance metrics as are known in the art.

The clusters can also be evaluated 430 to ensure adequate performance. Evaluation criteria can include, for example, determining the average density of each cluster, distortion (mean sum of squared distances to centers), intercluster distances, calculating the Variance Ratio Criterion (Calinski Harabaz score), calculation of a silhouette score (mean ratio of intra-cluster and nearest cluster distance), or other similar metrics. These performance criteria can be compared to a minimum or maximum acceptable value. Alternatively, the clustering can be repeated using different vectorization rules, algorithms, desired number of groups, and/or distance measures, and the scores recalculated to see if they improve or worsen. Techniques for such evaluation can also comprise generating an elbow chart (e.g., mapping one or more fit scores/computational performance metrics against choices for number of groups), silhouette visualizations, or intercluster distance maps. Where a vectorized data set has been clustered, the vectorized data set can be annotated with an additional dimension corresponding to its cluster membership. (e.g., Cluster 1, Cluster 2, etc.)

Because each cluster 421-423 represents anomalous rows that are similar to one another, each cluster can be considered an anomaly type. Once time interval data is divided into clusters, a set of rules or algorithmic technique can be applied to the data points in the cluster to make an adjustment 441-443. For example, a human programmer can review the points categorized into a single cluster, and study why those points are anomalous. The human programmer can then apply knowledge obtained from the data set, domain knowledge (e.g., knowledge about traffic patterns and roadway conditions) and other expertise to derive a calculation or rule that applies to the cluster.

In some embodiments, where an existing technique is used to calculate decisions, the TMS can determine adjustments 441-443 to calculate decisions automatically. In some embodiments, such an adjustment can be calculated on a cluster-by-cluster basis. One method of doing this would be to calculate the average adjustment to the decision that, if added to each vector in a cluster of anomalous vectors, would reduce the anomalousness of the vector, such as by lowering its anomaly score below a predetermined threshold. Another method of doing this would be to calculate the centroid of each cluster of anomalous vectors, and determine an adjustment necessary to move the centroid of the anomalous vectors such that it would have an anomaly score below a predetermined threshold.

In some embodiments, where the anomaly detection 350 is performed on a data set containing decisions, the TMS can automatically determine an adjustment 441-443 to the decision based on historical data in the absence of clustering. In some embodiments, an anomalous vector can be analyzed to determine a gradient of anomaly score along the dimension of the decision. Stated another way, the TMS can determine how the decision should be adjusted to reduce the anomaly score of the point (e.g., by a predetermined amount, or such that the anomaly score falls below a given threshold).

A simple gradient calculation can be performed by gradient descent techniques as are well known in the art. For example, an anomaly score can be calculated for a point as a small distance in a random direction from the specific data point. If the anomaly score decreases in that direction, the decision can be moved in that direction. If the anomaly score increases in that direction, the decision can be moved in the opposite direction. The process then repeats until a terminating condition is met, such as by having an anomaly score reduced by a predetermined amount, reducing it below a predetermined threshold, or finding a local minimum.

In other embodiments, the TMS can determine how the decision should be adjusted by performing a k-nearest neighbors (“KNN”) search around the anomalous point for non-anomalous points. The decision can then be adjusted to match the predicted value for the nearest non-anomalous point, or an average of a predetermined number of nearest non-anomalous points, or the direction of the nearest non-anomalous point can be used as a direction, and then the decision corresponding to the row can be adjusted in that direction until its anomaly score falls below a predetermined threshold.

The adjustments 441-443 can be used in the TMS 300 where the anomaly detector 350 determines an anomalous condition. The anomaly detector can assign the vector representing an anomalous condition to one of the predetermined clusters 421-423 from system 400, and then apply the corresponding adjustment 441-443. In some embodiments, the anomaly detector can assign the anomalous vector to the predetermined clusters 421-423.

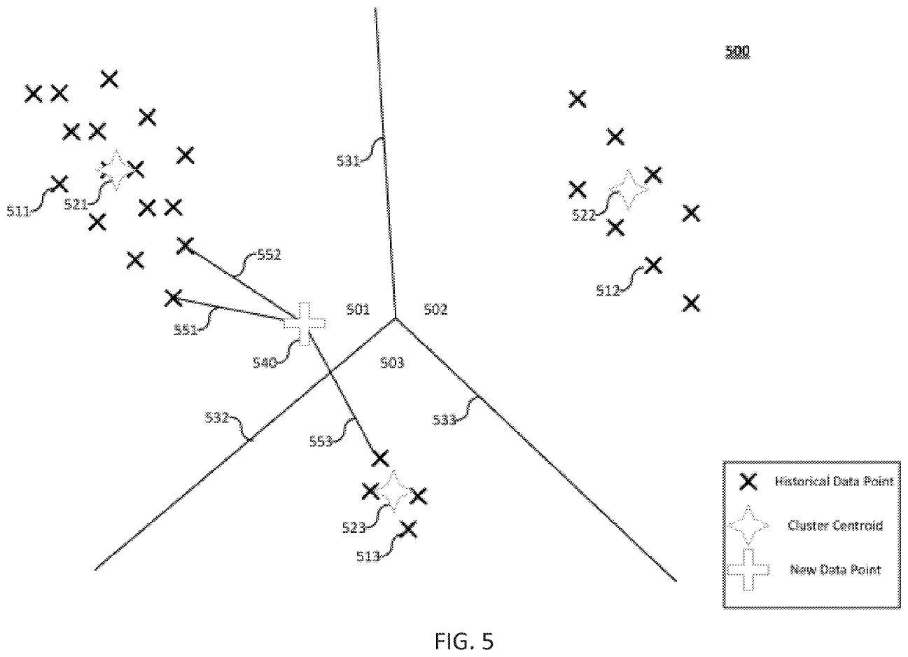

FIG. 5 depicts an example process 500 for assigning new points to existing clusters. The process in FIG. 5 is a simplified form of clustering, reduced to two dimensions, for ease of explanation. As will be understood by persons of ordinary skill in the art, similar techniques can be applied to higher-dimensional spaces, including spaces not visualizable (e.g., 100 or more dimensional space). The clustering algorithm 410 divides a plurality of historical data points (e.g., 511-513) into a plurality of clusters 501-503. The centroid of each cluster 521-523 can be calculated as the average or mean point for the points assigned to that cluster. Boundary lines 531-533 can be calculated between each of the clusters 501-503 by dividing the plotting space into Voroni cells by partitioning the available space into regions closest to each centroid, resulting in boundaries 531-533. A new data point 540, such as a vector representing input data 301-304 and/or a decision 340, can be assigned to a cluster by comparing the new data point 540 to the cluster boundaries 531-533, and assigning it to the cluster corresponding to the region within which new data point 540 falls. For example, new data point 540 would be assigned to cluster 501. Another example technique for assigning a new data point 540 to a cluster would be to perform a KNN search for a predetermined number of historical data points, and assigning the point to the cluster corresponding to the majority of nearest neighbors. For example, if a KNN search for the three nearest neighbors was conducted for new data point 540, two of the nearest neighbors would belong to cluster 501 (as shown by lines 551 and 552), and one neighbor would belong to cluster 503 (as shown by line 553). Accordingly, new data point 540 would be assigned to cluster 501.

Once a new data point 540 has been assigned to a corresponding cluster 501-503, the corresponding adjustment can be performed. Returning to FIG. 3, if an anomaly is detected by anomaly detector 350, the anomaly detector can assign the anomaly to one of clusters 421-423. In the example depicted in FIG. 3, the anomaly is determined to be a Cluster 1 Anomaly 421. A corresponding adjustment rule 441 is then applied to the anomalous data, and provided to an adjustment module 365, which provides the adjustment to the decision 340, as determined by the predetermined decision making algorithm 330. In some embodiments, the decision adjustment 365 can be validated 366 prior to application. For example, the validation process 366 can perform quality control on the decision adjustment 365 to ensure that the output to the action 370 is reasonable. Examples of such validation include ensuring compliance with business rules (e.g. minimum or maximum speed limits, tolls), and reasonableness (e.g. within a maximum variation of previous values). If validation 366 fails, the decision 340 from the predetermined decision making algorithm 330 can be based through to action 370 without applying decision adjustment 365. An action 370 is then performed in accordance with the adjusted decision by, for example, setting a toll, adjusting a speed limit, opening or closing traffic flow control devices, activating signage or displaying messages thereon, or other similar traffic-related actions.

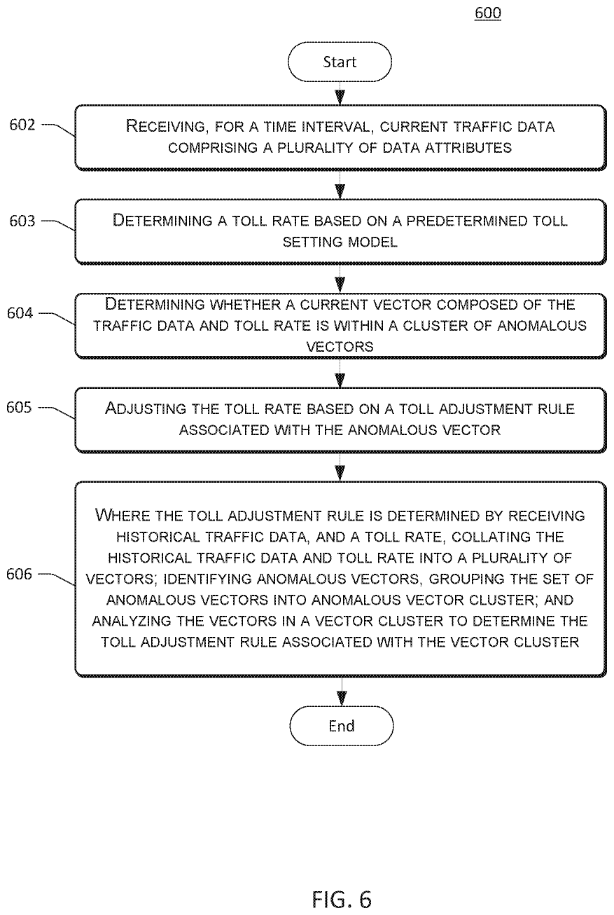

FIG. 6 depicts a computer-implemented method for determining a toll rate for a toll road 600, in accordance with an embodiment. In some embodiments, the method comprises the step 602 of receiving, for a time interval, current traffic data comprising a plurality of data attributes, composed of: roadway traffic data, tolling traffic data, and calculated traffic data. In some embodiments, the method comprises the step 603 of determining a toll rate based on a predetermined toll setting model. In some embodiments, the method comprises the step 604 of determining whether a current vector composed of the traffic data and toll rate is within a cluster of anomalous vectors. In some embodiments, the method comprises the step 605 adjusting the toll rate based on a toll adjustment rule associated with the anomalous vector. In some embodiments, the toll adjustment rule is determined 606 by receiving, for a plurality of time intervals, historical traffic data comprising the plurality of data attributes, and a toll rate corresponding to each time interval, collating the historical traffic data and toll rate into a plurality of vectors, wherein each vector comprises the traffic data and toll rate corresponding to a single time interval; identifying a plurality of anomalous vectors from within the plurality of vectors, where each vector in the set of anomalous vectors is anomalous relative to the plurality of vectors; grouping the set of anomalous vectors into a plurality of anomalous vector clusters, wherein each anomalous vector cluster comprises a subset of anomalous vectors selected from the set of anomalous vectors, and wherein each anomalous vector in an anomalous vector cluster is closer to other anomalous vectors in the anomalous vector cluster than to anomalous vectors in other anomalous vector clusters, according to a distance metric; and analyzing the vectors in a vector cluster to determine the toll adjustment rule associated with the vector cluster.

According to some embodiments, the systems and methods described herein provide an adaptable system to various roadway environments and integration with other smart transportation systems. The system can be configured with machine learning methodologies with predictive capabilities, such as the ability to predict and share future traffic conditions with connected-automated vehicles, roadway managers, and others to enhance and improve route and trip planning, traffic management and improving overall traffic flow. As used herein, the term “connected-automated vehicle” or “CAV” for short, is a broad term, and generally speaking, is used to refer to any vehicle that is able to communicate with the systems described throughout this disclosure. A connected-automated vehicle (CAV) is therefore one that is able to communication directly with systems associated with the roadway, other vehicles, roadway infrastructure, the traffic monitoring systems, cloud-based computing systems, and others. This may be accomplished, for example, by dedicated short-range communications (DSRC), cellular vehicle to everything networks (C-V2X), vehicle to everything (V2X)(such as vehicle to vehicle (V2V), vehicle to infrastructure (V2I), vehicle to pedestrian (V2P), or vehicle to network (V2N)), Bluetooth, Wi-Fi, 5G, multi-access edge computing (MEC), Non Terrestrial Network (NTN) among others and other protocols that are yet to be developed. A connected-automated vehicle also includes a vehicle in which an occupant has a mobile computing device that is able to communicate with external systems, which may include one or more of a smartphone, a smart watch, a mobile computing device, a laptop computing device, a tablet computing device, smart glasses or other wearable devices, among others. In many cases, a mobile computing device, by its virtue of being associated with an occupant of a vehicle, may share a common location, speed, direction, acceleration and deceleration, and a destination with the vehicle and therefore may provide important information regarding the location and motion of the vehicle. A CAV may also include a fully, or partially, autonomous vehicle. That is, a vehicle that can be self-driving or is fully self-driving.

In some cases, the system may provide future estimated toll prices for managed lanes and roadways and receive acknowledgements from navigation systems, such as from connected-automated vehicles, smart phones, and other devices that may interact with mapping data and/or trip planning responsibilities, which allows for more accurate trip time calculations and optimized route selections. The systems and methods further allow for cost savings to users by choosing optimal travel times and routes based on real-time, and future predicted, toll and traffic information. As with any embodiment described herein, another benefit is reduced vehicle emissions from improved traffic flow and lower roadway congestion which further supports environmental sustainability goals.

For example, according to some embodiments the system is configured to receive information associated with current traffic and/or roadway conditions and identifying multiple routes for which traffic conditions will be monitored. In some cases, the system receives trip planning information from a navigation system that has identified one or more travel routes and a request for information regarding the one or more travel routes. The system may predict future traffic conditions and/or future tolls for the one or more travel routes along with an estimated travel time for the one or more travel routes and return this information to the requesting navigation system. The system may further, based in part on the future predicted roadway conditions, determine a toll rate for managed lanes to optimize traffic flow and travel times along the routes.

The system may receive a request from a connected-automated vehicle, such as a request for a travel time along a route and the route may have a managed lane and a non-managed lane. The system may determine, based in part on real-time traffic data as well as future predicted traffic data along the requested route, travel times along the managed lane, the non-managed lane, and a cost associated with the managed lane, and provide the travel time saved and cost associated with the travel time saved to the connected-automated vehicle. For example, the system may monitor traffic flow in the non-managed lane with the same roadside sensors and systems and therefore has accurate real-time traffic data for determining travel times that it can share with the CAV, including incident induced congestion, among other factors. In some cases, the CAV includes a navigation application that computes the travel time along the non-managed lane and provides that travel time to the unique systems described herein, which is then able to compare the travel time provided by the navigation application and to the predicted travel time and return the time saved by using the managed lane rather than the unmanaged lane. The connected-automated vehicle may respond with a selection of either the managed lane or the non-managed lane or not respond at all. In some cases, a selection of the managed lane will also process a payment associated with the connected-automated vehicle.

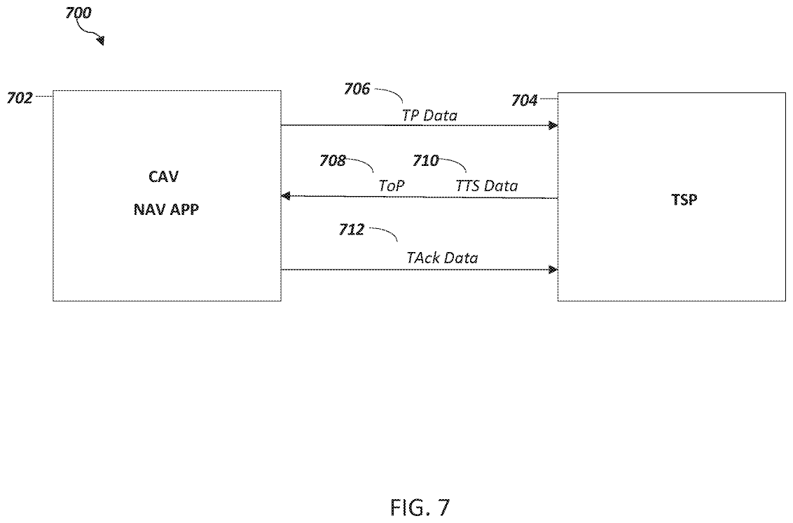

FIG. 7 is a schematic illustrating a tolling system sharing a toll price interval and travel time saved with a connected-automated vehicle. As with all the embodiments described herein, the connected-automated vehicle may include a connected-automated vehicle, a vehicle with a navigation application, or a computing device having a navigation application that may communicate with the systems described herein. For simplicity and ease of description, this disclosure will use the term CAV to refer to any type of connected-automated vehicle as that term has been defined herein. For instance, the CAV 702 may include a computing device associated with the CAV 702. The computing device(s) may correspond to in-vehicle navigation systems or other devices connected to the vehicle, such as cellular based smartphones, tablet devices that can provide network connectivity global positioning systems and processing resources for enabling a user to communicate with the toll service provider 704 (TSP).

The CAV may send Trip Planning Data (TP) 706 to the TSP 704, which may include one or more of a desired route, a current position, a current speed, a time of arrival at an entry or exit to a managed lane, among others. In some cases, the CAV 702 may associate the route with an ID that determines the correct toll service provider which may be a public agency or a private entity. The TP data 706 may additionally contain a user profile associated with the vehicle, a make and/or model of the vehicle, license plate information of the vehicle, toll-tag identification, banking details, and may further include sequential updates of the TP data 706 as the vehicle progresses along the route.

The TP data 706 may further include a request for information regarding the physical attributes of the toll facility, such as, for example, entry points, exit points of the managed lanes. The TSP 704 may respond with information regarding the physical attributes of the toll facility in any suitable format, but in some cases may be provided in a geo-json file. For clarity, A geo-json file is a format for encoding various geographic data structures using JavaScript Object Notation (JSON). It is designed to represent simple geographical features, along with their non-spatial attributes. Geo-json supports the representation of Points (e.g., locations of specific places); LineStrings (e.g., paths, streets, and rivers); Polygons (e.g., boundaries of areas like cities, states, countries); MultiPoints; MultiLineStrings; and MultiPolygons (combinations of the above types); and GeometryCollections (groups of different types of geometries).

Geo-json files consist of a series of Feature objects or a single Geometry object. Each feature in a geo-json file has geometry (coordinates that specify the shape and location) and properties (descriptive information about the feature).

The CAV 702 uses the returned information to choose one or more routes in relation to the toll facility and may send its estimated time of arrival to the entry point and may further choose an exit of one or more routes. In some cases, the process may take several iterative steps depending on the information the CAV 702 has or requests. As an example, the CAV 702 may request, in a first request, multiple entries and exits way-points within the managed lane facility. After the TSP 704 provides the requested data, the CAV 702 may be unable to determine its arrival time to the entry points. Once the arrival time is determined, the CAV 702 may send this information to the TSP 704 and receive the toll price and travel time saved by using the managed lane. In some cases, the CAV 702 may already know the entry and exit points to the managed lane and may simply request toll pricing and estimated time saved based on its arrival time to the desired entry point and its exit point from the managed lane.

The TSP 704 may be associated with an operating agency or authority responsible to the managed lane. It should be appreciated that throughout this disclosure, the term “managed lane” is a broad term and refers to a type of traffic lane or roadway that is actively managed to optimize traffic flow, improve travel time reliability, and reduce congestion. Managed lanes may use a combination of operational strategies, often involving restrictions or special pricing, to control access and maintain optimal driving conditions within these lanes. Some examples of managed lanes include high occupancy vehicle lanes (HOV), high occupancy toll lanes (HOT), express toll lanes, bus-only lanes, truck-only lanes, reversible lanes, and toll roads.

In some cases, the TSP 704 is the agency responsible for operating and maintaining the managed lane may also manage the collection of tolls and customer accounts. The TSP 704 may include all the necessary systems to monitor the roadway traffic including roadside sensors, 3^{rd} party data, integrated traffic management systems, servers and databases for traffic prediction and toll setting algorithms, internal and external communication networks, electronic toll collection (ETC) system, as well as the commercial back-office systems for managing transactions, payment processing and customer relationship management systems (CRM).

The TSP 704 may send, to the CAV 702, a toll price (ToP) data 708, which may be a current toll price, or a predicted future estimated toll price. The TSP 704 may also send data indicative of a travel time saved (TTS) 710 that corresponds with selecting a managed lane versus an unmanaged lane. For ease of description throughout, an unmanaged lane is one that is not associated with a toll or other restrictions, and may be referred to interchangeably as a general purpose lane. In some cases, the TSP 704 uses the estimated time of arrival to the entry point and chosen exit point for one or more routes and determines the future travel time saved associated with the routes. The TTS 710 is the difference in total journey time by choosing to take the managed lane in lieu of general purpose lane for one or more routes as well as the associated price for each alternative. This information is sent back to the CAV 702.

In some cases, additional information associated with a route or routes for both the managed lanes and general purpose lanes can be sent back to the CAV 702 such as information regarding periodic check-in requirements for the CAV 702, ongoing incidents or wrecks, active ramp metering, work or construction zones, as well incentive based information such as discounts for delaying travel so a wreck can be cleared, or customer loyalty points and other commercial incentives from participating business along the routes.

The CAV 702 may process the ToP data 708 and the TTS Data 710 and make an intelligent decision whether to access the managed lane or not. In response, the CAV may send a Trip Acknowledgement (TAck data) 712 to the TSP 704, which may be used to determine future roadway conditions along the managed lane and/or general purpose lane. The TAck data 712 may include further information, such as an acceptance of the tolling amount for accessing the managed lane, a rejection of the route containing the managed lane, meeting passenger requirements for HOV or HOT lane access or discounts.

As with all the embodiments described herein, the toll price may be based on future traffic conditions which may be correlated to the trip plan data provided by the CAV 702 (route or entry and exit points within the managed lane facility and the estimated arrival time to the entry point).

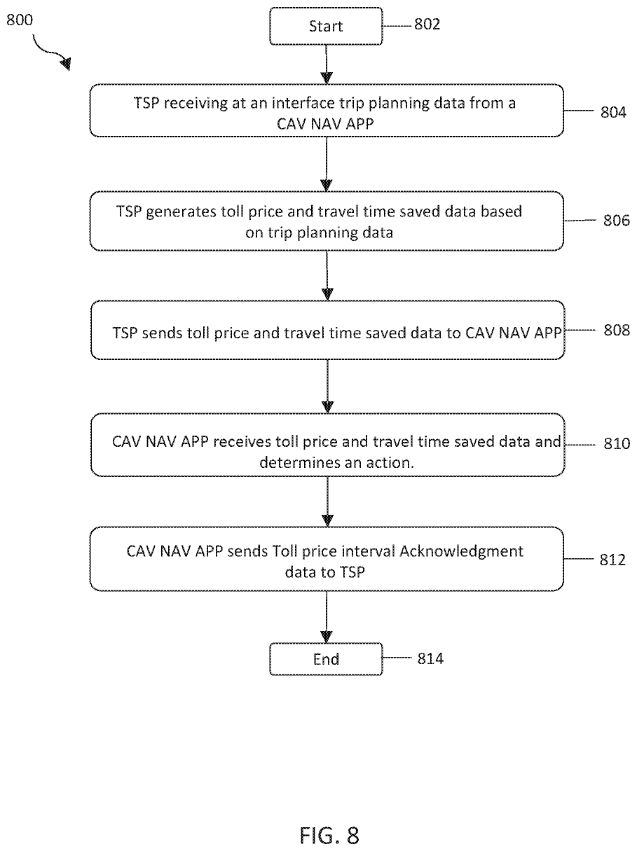

FIG. 8 is an example process flow for a method for sharing a toll price interval and travel time saved with a CAV. The process visually illustrates many of the process steps described in conjunction with FIG. 7, which may be used as an additional reference in conjunction with FIG. 8. As the process starts at block 802, and at block 804, the TSP receives, at an interface, trip planning data from a CAV. At block 806, the TSP generates toll price interval and travel time saved data based on the Trip Planning data. The travel time saved may be based upon future roadway conditions that the system generates through algorithms designed to accept roadway condition inputs, weather data, event information, historical roadway conditions, among others to predict future roadway conditions in order to determine the travel time saved by using a managed lane in lieu of a general purpose lane.

At block 808, the TSP sends the toll price and the travel time saved to the CAV. AT block 810, the CAV receives the toll price and travel time saved and determines an action, such as whether to accept the toll price and travel time saved, or to reject the toll price and the travel time saved.

At block 812, the CAV sends the toll price acknowledgement (TAck) to the TSP. Once the TAck is sent to the TSP, the process may end at block 814. It should be appreciated that the process may be iterated, such as updating the toll price and/or predicted travel time saved based on changing roadway conditions.

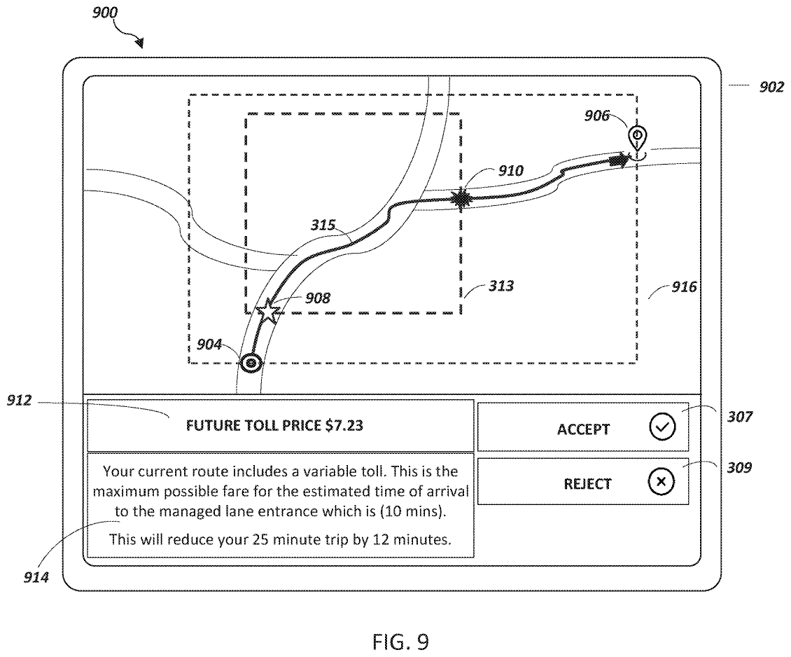

FIG. 9 illustrates an example display 900 from a CAV (i.e., navigation application) showing trip planning information that may be utilized for receiving toll pricing and estimated travel time saved. The display may be shown on any suitable display, which may include, for example, a vehicle in-dash display unit, a smartphone, a mobile computing device, a heads-up display (e.g., such as shown on the windshield or window of the vehicle), smart glasses, or otherwise. In some cases, the display is configured to show integrated toll rate information 902 with CAV systems to provide in-vehicle alerts about current and future traffic conditions and/or toll rates. This ensures that users are aware of toll rates without relying solely on roadside signs. A vehicle current position 904 may be shown to provide context to the driver of the route and the alternative routes with managed and general purpose lanes. The vehicle current position 904 may also be the original point of the CAV for trip planning purposes. As the trip planning commences, the destination 906 may also be displayed, or at least stored by the CAV, especially where the destination is a considerable distance from the origin point 904 and there may be numerous alternate routes between the original and the destination. In some cases, the destination may not be readily viewable on the display 900.

An entry point 908 to the managed lane may be displayed based on the TP data the TSP provided to the CAV. This may also represent the first toll gantry or entrance offered to the CAV. An exit point 910 from the managed lane is provided by the TP data the TSP provided to the CAV. This may also represent a last toll gantry the CAV will enter. In some cases, additional entry points 908 and/or exit points 910 may be displayed, which may be associated with different toll pricing. The entry point 908 and exit point 910 may define a boundary 313 of the area for which the travel time saved is determined. Thus, the travel time saved may be determined only for the roadway 315 within the boundary 313 of a preferred route of the CAV.

A toll price 912 and travel time saved 914 may be determined and shown for the entry point 908 and exit point 910 of the preferred route of the CAV. The total trip time 916 is determined by the navigation application associated with the CAV, which may not be privy to the future toll price or travel time saved. The future toll price 912 and/or the travel time saved 914 may be provided to the CAV from the TSP automatically, or upon request.

The future toll price 912 may be sent by the TSP and displayed in the CAV, such as on any suitable display as described herein.

The CAV determines an estimated time of arrival to the managed lane entry point 908 and also the overall route 916 travel time and identifies the appropriate TSP and pings it for Tpdata. The TSP sends the TPdata to the CAV, which includes the future toll price and the estimated travel time saved by using the managed lane. The CAV may display the future toll price 912 and/or the estimate travel time saved 914. In some cases, a rules-based approach will automatically accept or reject the toll price and may send TAck data to the TSP. In some cases, a prompt is displayed to a driver or occupant of the CAV, such as in a display associated with the CAV, which may be a navigation application display, an audio que and the driver or occupant is able to accept or reject the toll price.

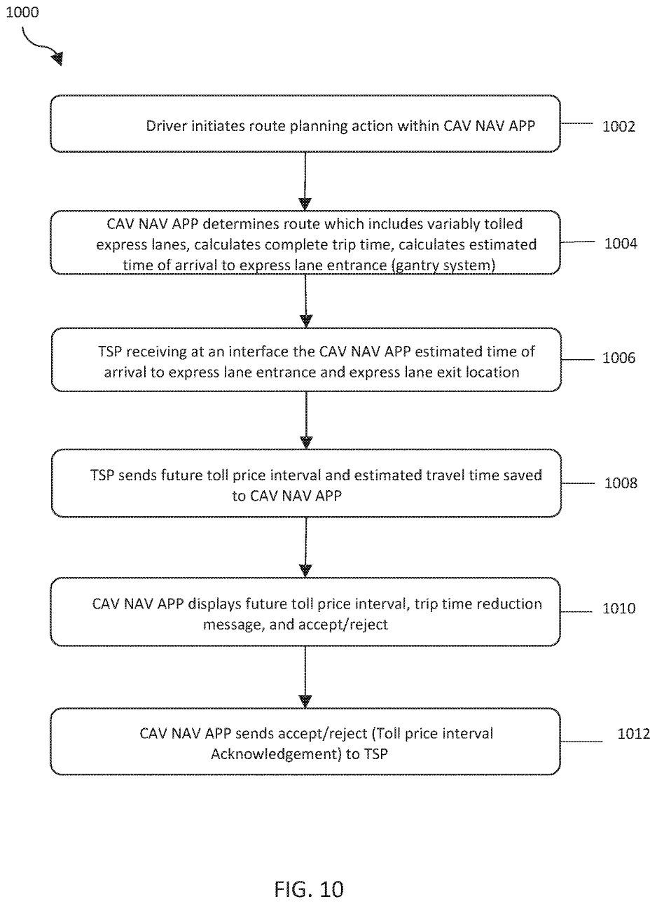

With additional reference to FIG. 10, which shows an illustrative process flow for trip planning 1000, at block 1002, a driver initiates a route planning action within a CAV. In some cases, this may be performed by identifying a desired destination. At block 1004, the CAV determines a route from the CAV's current location to the specified destination and the route includes a variably tolled managed lane as an option for travel. The CAV further calculates the complete trip time and determines an estimate time of arrival to an entry point to the managed lane. The entry point may be any suitable point, such as, for example, a gantry, a gate, the beginning of a new lane, an entrance ramp onto a toll road, or other type of entry that allows a vehicle to enter the managed lane. At block 1006, the TSP receives, from the CAV, an estimated time of arrival to the managed lane entrance, a managed lane exit location, and may also receive the estimated total trip time.

At block 1008, the TSP determines the future roadway conditions, a future predicted toll price for the managed lane, and an estimated travel time saved. This information is sent by the TSP back to the CAV.

At block 1010, the CAV displays, to an occupant of the CAV, the future toll price, a trip time reduction, and an opportunity to accept or reject the toll. The future toll price may be a not to exceed price in which the future price displayed is the maximum toll price for entry into the managed lane, although the actual price at the time of arrival at the managed lane may be lower than the maximum toll price. In some cases, a toll price interval may be displayed which indicates the highest and lowest price associated with the managed lane at the estimated time of arrival at the managed lane.

At block 1012, the CAV sends an indication of acceptance or rejection (TAck) to the TSP. The TSP may, in turn, use the TAck to further predict future roadway conditions as it will have another data point associated with a specific vehicle and whether that vehicle will be in the managed lane or the general-purpose lane.

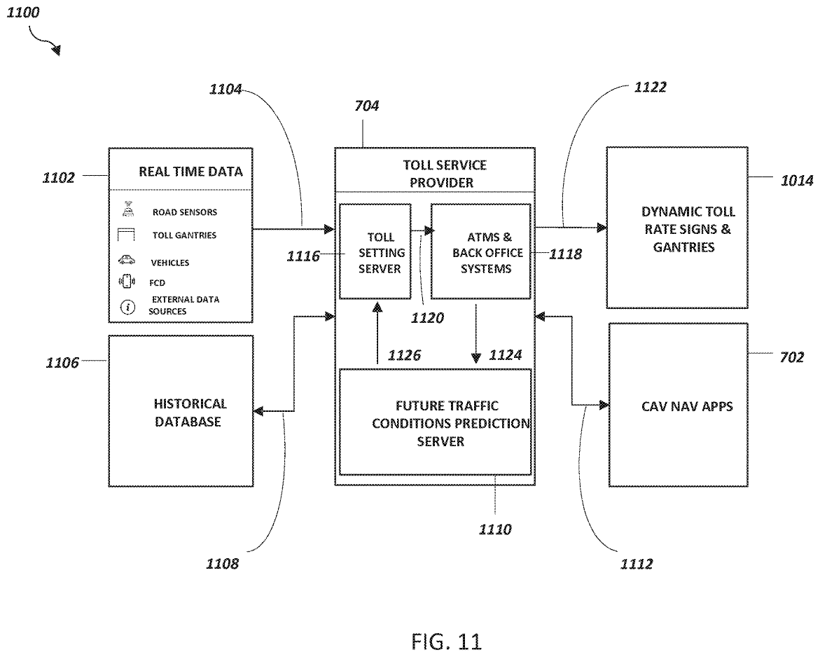

FIG. 11 illustrates, in block diagram form, a methodology for a toll system 1100 that determines and assigns a future toll price interval and determining a travel time saved. It should be appreciated the that the system and methods described in relation to FIG. 11 are applicable to, and combinable with, all the various embodiments described herein.

Block 1102 includes real time traffic data, which may include current traffic volumes, speeds, congestion levels, lane occupancy, segment density on both managed lanes and general-purpose lanes, sensors such as radar, cameras, and LiDAR may be used to collect some of this data.

Specialized sensors may be located along the roadway and are configured to send traffic data 1104 to the TSP 704. For example, radar sensors may be used to detect vehicle speed and vehicle volume. They can operate in various weather conditions and provide continuous monitoring of traffic flow and send real-time updates to the TSP. Cameras, which may include closed-circuit television (CCTV), and automatic license plate recognition (ALPR) systems may be used for visual monitoring, incident detection, and may also aid in the enforcement of tolls or lane usage restrictions. In addition, light detection and ranging sensors (LiDAR) can be used to create high-resolution 3D maps of the roadway environment. They may be used for vehicle detection, classification, and tracking while providing detailed information about traffic conditions.

In addition, gantries provided over, adjacent to, under, or on the roadway trigger a toll collection mechanism and can count the number of tolls that are collected for a specified period of time. Furthermore, mobile GPS data can be aggregated such as from CAV's, mobile computing devices, and other such sources, to provide real-time traffic patterns and travel speeds, offering a broad view of traffic conditions beyond those provided by fixed sensors.

In some cases, information on major events, such as sports games, concerts, conventions, parades, and the like can help predict surges or reductions in expected traffic patterns and adjust the estimated travel times, and tolls, accordingly.

Weather monitors and sensors can be used to provide real-time weather information as adverse weather can significantly impact traffic flow and driver behavior. In some cases, sensors and/or monitors provide real-time information on accidents, roadworks, and other traffic-affecting incidents. All of this type of traffic data 1104, which has a tendency to impact traffic flow can be used to predict future traffic patterns and tolls.

The TSP 704 additionally receives important ground truth information from historical records, such as a historical database 1106. Ground truth data, in the context of machine learning, refers to the data that is known to be accurate and reliable, and serves as a benchmark for training and evaluating machine learning models. It is the data that has been directly observed or measured, rather than inferred or predicted.

In supervised learning, in particular, ground truth data is used to train the model by providing it with input features along with their corresponding correct output labels or values. The model learns to map the input features to the correct outputs based on the ground truth data. In many cases, the historical data 1106 The historical database 1106 may include the real time traffic data associated with historical time periods, weather data, event data, travel times, GPS data, among other types of historical traffic data. The historical database 1106 may share and receive information with the future traffic conditions prediction server 1110.

The future traffic conditions prediction server 1110 uses one or more machine learning models to predict future traffic conditions, and in turn, time saved by utilizing managed lanes. In some embodiments, the future traffic conditions prediction server 1110 relies on models that rely on real-time data 1102 from sensors to predict traffic volumes and speeds. They help in understanding how traffic is likely to evolve over several minutes or even longer time periods, such as every fifteen minute increments, or thirty-minute increments, or more. Real-time weather data may be integrated into the prediction models to account for the impact of weather conditions on traffic flow. For example, rain or snow can significantly slow down traffic which entices drivers to choose a managed lane, which may have slow down to a lesser degree than general purpose lanes. Incident detection systems use data from various sources including roadside sensors as well as navigation apps, social media, traffic reports from the three-digit dialing code (511 systems), to detect accidents.

According to some embodiments, various machine learning models can be used by the future traffic conditions prediction server. In predictive modeling, as here, machine learning algorithms analyze historical data to forecast future conditions. The quality and quantity of data can significantly influence model performance, and iterative training on data from the historical database 1106 increases model performance over time. The historical database includes raw data that is preprocessed and cleaned, such as to handle missing values and outliers, normalization or standardization, and encoding categorical variables to convert qualitative data into numerical form. The raw data is transformed into meaningful inputs through feature engineering. Features are created that categorize the data and can be used to reduce dimensionality to remove redundancies and relevant features can be selected to avoid overfitting. Some suitable algorithms used by the future traffic conditions prediction server 1110 include linear regression, decision trees, support vector machines, neural networks, and ensemble methods.

Once the model is trained, it may be evaluated on hold-out or cross validation data sets to assess its performance on unseen data. The model may be trained using supervised learning or unsupervised learning, or both. Supervised learning involves labeled datasets where the model learns from input-output pairs to predict outcomes for new data. Unsupervised learning uses unlabeled data, and the model searches for hidden patterns or groupings.

The trained models utilize the learned patterns from historical data to make accurate predictions about future conditions, such as traffic pattern and time saved data.

An appropriate algorithm is chosen, such as one or more of a suitable classification, regression, clustering, etc. algorithm. The algorithm is trained on the historical data, and the model adjusts its parameters to minimize, or at least reduce, prediction errors.

Other models that can be useful with the future traffic conditions prediction server include: anomaly detection, which include isolation forests, robust covariance, one-class vector support machines, and local outlier factors.

Isolation Forests function by isolating observations by randomly selecting a feature and then randomly selecting a split value between the maximum and minimum values of the selected feature. Anomalies are isolated quickly because they are few and different.

Robust Covariance techniques identify outliers by measuring the distance of data points from the center of a data distribution.

One-Class Support Vector Machines (SVMs) can be used to identify the boundary that best separates normal data points from anomalies.

Local Outlier Factor (LOF) can be used to identify anomalies by comparing the local density of a data point to that of its neighbors.

The future traffic conditions prediction server 1110 may also use one or more clustering algorithms to manage and respond to detected anomalies. For example, k-Means Clustering can be used to partition data into k clusters, where each data point belongs to the cluster with the nearest mean.

Affinity Propagation can be used to identify exemplars among data points and forms clusters based on the similarity between data points.

DBSCAN (Density-Based Spatial Clustering of Applications with Noise) techniques can be used to group together points that are closely packed together, marking points that lie alone in low-density regions as outliers.

The future traffic conditions prediction server 1110 may also rely on predictive modeling techniques to forecast future traffic conditions and make informed decisions.

For example, regression techniques can be used to predict continuous outcomes, such as traffic flow rates or toll prices.

Artificial Neural Networks (ANNs) can be utilized for more complex predictions, such as traffic patterns over time. Specific architectures of ANNs may include one or more of Recurrent Neural Networks (RNNs): Suitable for time-series predictions; and Long Short-Term Memory (LSTM) Networks: A type of RNN that can learn long-term dependencies, useful for predicting traffic conditions based on historical data.

The future traffic conditions prediction server may further rely on Decision-Making Algorithms, such as for setting toll rates and managing traffic and use the output from anomaly detection and clustering.

For example, rule-based Systems can be used to apply predefined rules to adjust toll rates based on detected anomalies, which impact roadway conditions.

Machine Learning Models, such as decision trees or support vector machines, can be used to make decisions based on patterns learned from historical data.

The future traffic conditions prediction server 1110 may further utilize vectorization and feature selection for converting raw traffic data into a format suitable for analysis, including vectorization in which data attributes are transformed into vectors in n-dimensional space. Feature Selection may be used to choose relevant data attributes to reduce dimensionality and improve the efficiency of the algorithms.

In addition, dimensionality reduction techniques may be employed to handle high-dimensional data, including Principal Component Analysis (PCA) which can be used to reduce the number of dimensions by transforming data into a set of orthogonal components. Non-Negative Matrix Factorization (NNMF) may decompose data into non-negative factors for easier interpretation.

Furthermore, Multi-Agent Machine Learning Algorithms (MAML) may involve multiple autonomous agents that work together to solve complex traffic management problems. These agents can be used optimize traffic flow and reduce congestion problems, among other things. For instance, each agent learns and makes decisions independently but also coordinate with each other to achieve a common goal. A common approach in multi-agent systems is reinforcement learning, where agents learn optimal behaviors through trial and error by receiving rewards or penalties based on their actions.

In some example systems, there are higher-level coordination agents that oversee the actions of individual agents. These coordination agents ensure that the overall traffic management strategy is being followed and can override decisions if necessary. Each segment of a highway or express lane can be monitored by individual agents, each responsible for controlling toll prices and other traffic control devices designed to manage traffic flow.

Based on the real-time data collected, each agent can dynamically adjust toll prices for its segment. For example, if an agent detects increasing congestion, and more vehicles entering the express lane it can raise toll prices to discourage additional vehicles from entering, thereby managing traffic flow more effectively.

To ensure smooth traffic flow across the entire express lane, agents can communicate with each other. If one segment becomes congested, neighboring agents can adjust their toll prices to balance the traffic load. This coordination helps prevent severe slowdowns and ensures a more even distribution of vehicles.

As an example, during peak hours, the agent for a particularly busy segment detects heavy traffic entering the express lane. It raises the toll price for that segment to reduce the number of vehicles entering. Neighboring agents, noticing the change, adjust their toll prices to accommodate more or less traffic depending on their location being upstream or downstream from the particularly busy segment.

Route or trip planning information from connected and/or automated vehicles (CAVs) can be integrated into a multi-agent traffic management system to significantly enhance its efficiency. The CAV navigation applications share their route and trip planning information with the higher-level coordination agent. This data includes, among other things, expected arrival times, and their preferred routes. The coordination agent uses this data to predict traffic patterns and managed lane demand.

The higher-level coordination agent aggregates data from a plurality of CAV navigation apps and communicates relevant information to segment-specific agents. This ensures that each segment agent has a comprehensive view of upcoming traffic conditions. Segment-specific agents provide feedback to the coordination agent about the effectiveness of their adjustments. This feedback helps refine the predictive models and improve future traffic management strategies. Agents collaborate to ensure that adjustments in one segment do not negatively impact neighboring segments. For instance, if raising tolls in one segment diverts traffic to another, agents coordinate to balance the traffic load across the entire managed lane network.

CAV navigation apps 702 are configured to continuously collect and transmit data 1112 about their location, speed, and route choices. Additionally, when these vehicles accept future trip data and toll rates, this information can be used to predict future road segments and lane densities. By analyzing historical data on trip and toll acceptance, predictive models can forecast future demand based on current and future traffic conditions and corresponding toll rates. For instance, if a significant number of CAVs accept higher future tolls for managed lanes, it indicates a likely increase in traffic volume on these lanes. This helps in predicting congestion levels and adjusting toll rates dynamically to manage current flows that will impact future traffic flows. Conversely, if fewer CAVs accept the tolls, it could suggest that more vehicles will use general purpose lanes, potentially leading to increased congestion there.

The CAV navigation apps 702 share the trip planning data 1112 with the future traffic conditions prediction server 1110 and receives information from the TSP 704, such as time saved by using the managed lanes and the toll price at the time the CAV will reach the managed lane entry.

In some embodiments, one or more dynamic toll rate signs and/or gantries 1014 can be updated in real-time based on current traffic conditions and predictive data. They are updated frequently to reflect the latest traffic predictions and conditions, providing drivers with the most accurate information. The dynamic toll rate signs and/or gantries 1014 may be controlled by the TSP 704 and may update, in real time, with updated information from the toll setting server 1116.

The toll setting server 1116 uses future and real-time traffic data in making decision about setting specific toll rates in order to manage the level of service along the roadway. The toll setting server 1116 may run a dynamic pricing algorithms that adjusts toll rates based on the traffic condition data. The goal is to manage congestion and maintain a steady flow of traffic to maintain a desired level of service. For example, during peak hours when traffic is heavy, the toll rates increase to maintain a level of service and reduce congestion. Conversely, during off-peak hours, the toll rates decrease as there is little risk that higher usage will impact the level of service. The rates set by the toll setting server 1116 may automatically be sent to the dynamic toll rate signs and/or gantries 1014 in order to update CAVs and drivers.

The TSP 704 further includes an advanced traffic management system (ATMS) and back office systems 1118. The back-office system helps to ensure the efficient operation, management, and oversight of toll collection services. It integrates various processes and supports the various business functions involved in tolling operations. The functionalities of such a system can be broken down into several core categories that include toll transaction processing, account management, data management and reporting, dispute and violation, customer support and communication, integration with other systems, compliance and regulatory, operational management system monitoring, dynamic pricing and discounts, and security and fraud protection among others. These will be discussed in greater detail.

Toll Transaction Processing includes transaction capture and validation. This ensures that all toll transactions (manual or electronic) are accurately captured from various sources (e.g., toll booths, electronic toll collection systems). Validation cross-checks transactions against the registered vehicles and the predefined rules (e.g., valid toll rates, vehicle types, or accounts). Automatic vehicle identification (AVI) integrates with vehicle identification systems (such as RFID or license plate recognition) to automate toll collection.

The account management functions include account creation and maintenance, which allows for the creation and maintenance of user accounts, including both individual and commercial users. Account balance management monitors account balances, processes top-ups or fund transfers, and tracks toll usage against account balances. Payment integration supports multiple payment methods, including credit/debit cards, bank transfers, prepaid accounts, and mobile payments. These payments may be automatically processed as a vehicle enters or exits a managed lane, and the system can provide updates to the registered user of a vehicle through the account managements, which may show day and time of toll, amount of toll, direction of travel, an identification of a specific managed lane, and may include a photograph of the vehicle or license plate at the time of tolling. Billing generates accurate billing for toll charges based on usage, applying any applicable discounts, dynamic pricing, or special toll classifications. Refund processing manages refunds for overcharges, cancellations, or disputes.

The data management and reporting functions to report on daily, weekly, or monthly toll revenues, usage statistics, and transaction volumes. Audit logs maintain logs for auditing purposes, tracking system access, and operational activities. Revenue reconciliation provides functionality for verifying total toll revenues against collected amounts and flags discrepancies for investigation. Data analytics analyzes user behavior, traffic patterns, toll revenue trends, and more for planning and optimization.

The dispute and violation management of the back office systems functions integrally with the tolling infrastructure to identify vehicles that pass through toll points without proper payment. Violation processing manages the issuing and tracking of violation notices (e.g., toll evasion), including correspondence, payment deadlines, and penalties. The dispute resolution functionality provides a platform for users to dispute charges, providing case management features to resolve issues.

The penalty management functionality manages penalties, fines, and enforcement actions, tracking whether a fine has been paid or contested.

Customer support and communication provides tools for customer service representatives to assist users with account issues, toll violations, payment inquiries, and general queries.

Notifications allows the sending of notifications to users regarding low balances, upcoming renewals, toll payment due dates, or violations via email, SMS, or app notifications.

A Portal/Website access provides an online portal or mobile app for users to manage their accounts, view transactions, load funds, and review toll history.

The back office systems may be configured for integration with other systems such as other toll systems, both regionally and internationally, for cross-border or multi-regional tolling. It may also offer third-party integration, such as payment gateways, bank networks, government databases, and vehicle registration systems, among others.

In some cases, the system allows for an external API access so that other systems (like fleet management software, for example) can use to integrate with the tolling back-office system.

The compliance and regulatory reporting function allows compliance with relevant government regulations and standards (such as electronic toll collection requirements, tax reporting, or environmental standards). Tax calculation determines and reports on applicable taxes on toll charges, including VAT, road usage fees, or congestion charges.

The ATMS and back office system further include operational management functionality such as system monitoring which tracks the health and performance of tolling systems, including hardware and software components, ensuring smooth operations. It also provides for maintenance scheduling for the maintenance or upgrades of tolling infrastructure and back-office systems. Resource management manages the deployment of human resources to monitor and support toll collection, such as staffing toll booths, call centers, or violation enforcement teams.

The ATMS and back office system may further be responsible for dynamic pricing and discounts. For example, dynamic pricing models can be based on traffic conditions, time of day, or congestion, adjusting toll rates to optimize flow. The toll rates can be sent not only to dynamic toll rate signs and/or gantries 1014, but may also be sent directly to CAVs where they can be received by CAVs and/or displayed for a driver or vehicle occupant to review and approve.

Discounts and special rates functionality can be used to apply special pricing structures or discounts for specific vehicle types, users (e.g., frequent users, commercial vehicles), or scenarios (e.g., off-peak hours).

The ATMS and back office systems can also be configured for security and fraud prevention. According to some embodiments, fraud detection implements algorithms or machine learning models to detect fraudulent activity, such as toll evasion or account hacking. data encryption ensures secure transmission and storage of sensitive user data, payment information, and transaction records. Access control limits access to the system to authorized personnel, ensuring sensitive data is protected from unauthorized access.

The advanced traffic management system (ATMS) plays an important role in the efficient operation of a tolling facility. For example, ATMS integrate data from various roadside sensors (radar, cameras, LiDAR, etc.) and other sources (floating car data, weather reports) to provide a comprehensive view of traffic conditions and congestion levels.

In some embodiments, current toll rates are generated by the toll setting server 1116 and sent to the ATMS 1118 as shown by arrow 1120. The ATMS, in turn, send the current toll rates to the dynamic toll rate signs and/or gantries 1014, shown by arrow 1122, and to the future traffic conditions prediction server, as shown by arrow 1124, which can use the current tolls to predict future traffic congestion.

The CAV navigation apps 702 send TP data and requests to the future traffic conditions prediction server 1110, which predicts future traffic conditions and sends it to the toll setting server 1116, shown by arrow 1126, which communicates with the ATMS and back office systems 1118, which in turn, sends commands to the dynamic toll rate signs and/or gantries 1014 to modify traffic flow.

The predicted and real-time traffic data is sent back to the historical database 1106, shown by arrow 1108, and stored for later analysis and model iterative training. All the data inputs can correlate to dates, time periods, and other influencing patterns to identify patterns such as rush hours, weekends, and holiday traffic surges. This includes historical data on the number of vehicles and their speeds on both managed and public purpose lanes. Historical toll rates the corresponding traffic volumes and travel time saved for a plurality of routes.

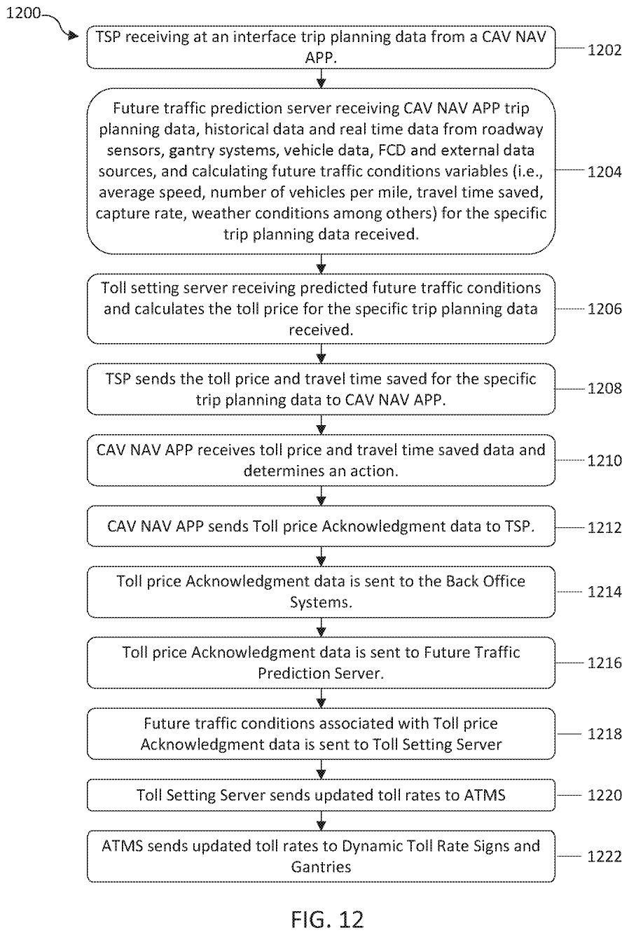

FIG. 12 illustrates a process flow for assigning a future toll price interval and determining travel time saved 1200 according to some embodiments. The illustrative process flow describes many of the systems shown in FIG. 11, but it is also applicable to any of the embodiments described herein.

At block 1202, the TSP receives trip planning data from a CAV. The trip planning data includes the TP data described herein, which may include one or more of a starting point, a destination, a route, the route containing a managed lane and a general-purpose lane, an entry point to the managed lane, an exit point from the managed lane, and a time to reach the entry point.

At block 1204, the future traffic prediction server receives the TP data, and retrieves historical data, and real-time data from roadway sensors, gantry systems, vehicle data, FCD and external data sources, and determines, through a trained machine learning model, predicted future traffic conditions. The predicted future traffic conditions include one or more of average vehicle speed, number of vehicles per mile (density), travel time saved, capture rate, weather conditions, among others. In addition, based on the future traffic predicted, the future traffic prediction server will also determine the time difference between the route planning received from the CAV for the general-purpose lane and if the CAV were to use the managed lane, to thereby determine a travel time saved for the specific route by using the managed lane.

At block 1206, the toll setting server receives predicted future traffic conditions from the future traffic condition prediction server and the travel time saved, and determines the toll price for the specific trip planning data received. The determined toll price is based largely on an expected level of service for the roadway and in an effort to ease congestion. For example, if the traffic on the roadway is slow because of congestion and the managed lane is relatively empty, the toll setting server may reduce the toll for the managed lane to encourage more drivers to use the managed lane. If, however, the managed lane becomes busy and traffic in the lane slows, then the toll setting server may increase the price thereby reducing the likely number of vehicles opting for the managed lane.

At block 1208, the TSP sends the toll price and travel time saved for the specific trip planning data to the CAV. At block 1210, the CAV receives the toll price and travel time saved and determines an action. As will be appreciated, in some cases the toll price and travel time saved may be displayed for the driver or an occupant of the vehicle to review and either accept or reject. However, in some cases, the toll price and travel time saved may be decided by the CAV without immediate input from a vehicle occupant. In some cases, the CAV is an autonomous vehicle and it decides whether to accept or reject the managed lane entry based on the toll price and the travel time saved.

At block 1212, the CAV sends the Toll price Acknowledgment (TAck) data back to the TSP. As described elsewhere herein, the CAV communicates with the TSP through any suitable electronic communication protocol, such as, without limitation, cellular, wifi, cellular vehicle to everything networks (C-V2X), vehicle to everything (V2X)(such as vehicle to vehicle (V2V), vehicle to infrastructure (V2I), or vehicle to network (V2N)), or some other suitable wireless or satellite communication technology.

At block 1214 the TAck data is sent to the back office systems which may then automatically process payment, log the capture, among other activities.

At block 1216 the TAck data is sent to the future traffic prediction server, which uses this new information to iteratively predict future traffic conditions based at least in part upon whether or not the vehicle has accepted or rejected the managed lane.

At block 1218, the future traffic conditions associated with the TAck data is sent to the toll setting server, which in turn, may use this updated future traffic conditions to adjust a toll either up or down to incentivize more CAVs to enter or avoid the managed lane in order to maintain a level of service of the roadway.

At block 1220, the toll setting server sends updated toll rates to the ATMS, and then at block 1222, the ATMS send updated toll rates to dynamic toll rate signs and/or gantries.

The result of the disclosed systems and processes are machine learning models that can process and analyze large, complex traffic datasets in real-time, far beyond what human operators could ever achieve. This ability allows for immediate adjustments in toll rates to smooth traffic flow. Moreover, adjusting toll rates based on predictive models with additional insights from communication with CAVs, the system improves the overall utilization and service level of managed lanes as well as nearby roadways. This results in reduced congestion and enhanced travel time reliability, which directly improves the infrastructure's performance and capacity. The machine learning models improve the efficiency of traffic data processing, enabling rapid adjustments in toll rates based on current and predicted traffic patterns. This is a dramatic improvement over conventional traffic management systems, which typically lack real-time, predictive control.

In addition, the disclosed systems and methods automate the setting of toll rates based on future predictions, which is a technical advancement over traditional static or manually adjusted toll rates. The machine learning based system uses technical data analysis to decide optimal toll rates automatically, which a technically more sophisticated than simple threshold-based adjustments and further allow real-time decision by continuously adjusting incentives for managed lane utilization in response to predicted congestion levels. This type of process requires both rapid computation and specific decision algorithms that would otherwise be impossible to implement manually.

The disclosed systems and methods continually learn and improve over time through iterative training and thereby adapt to evolving traffic patterns, weather conditions, or event-based spikes in traffic. This adaptive learning characteristic is a technical improvement to traffic science and enables the system to dynamically refine its predictive accuracy and response rate, resulting in improved traffic flow and roadway service levels. Moreover, as connected-automated vehicles become more prevalent, the disclosed system provides a methodology for communication with, guiding, and maintaining high throughput services levels on roadways, especially where connected-automated vehicles and conventional vehicles are sharing the roadways.

By optimizing traffic flow and distributing roadway usage more evenly, the system may reduce wear and tear on infrastructure, resulting in technical improvements in road longevity and reduced maintenance costs. The system further integrates diverse data sources into a unified predictive model, which is an improvement in the way toll systems interact with and leverage roadway sensor networks.

The culmination of the systems and methods described herein result in an improved driver experience by reducing congestion and increasing predictability of travel times and also provides timely feedback to drivers and connected-automated vehicles alike, which is a technical improvement in user-device interaction within the tolling system.

In prior systems, static or manually adjustable toll systems fail to meet the demands of real-time dynamic traffic management. The systems described herein utilize advanced machine learning models that provide adaptive learning, integration with internet of things (IoT), and predictive analytics that fundamentally improve the traffic management systems.

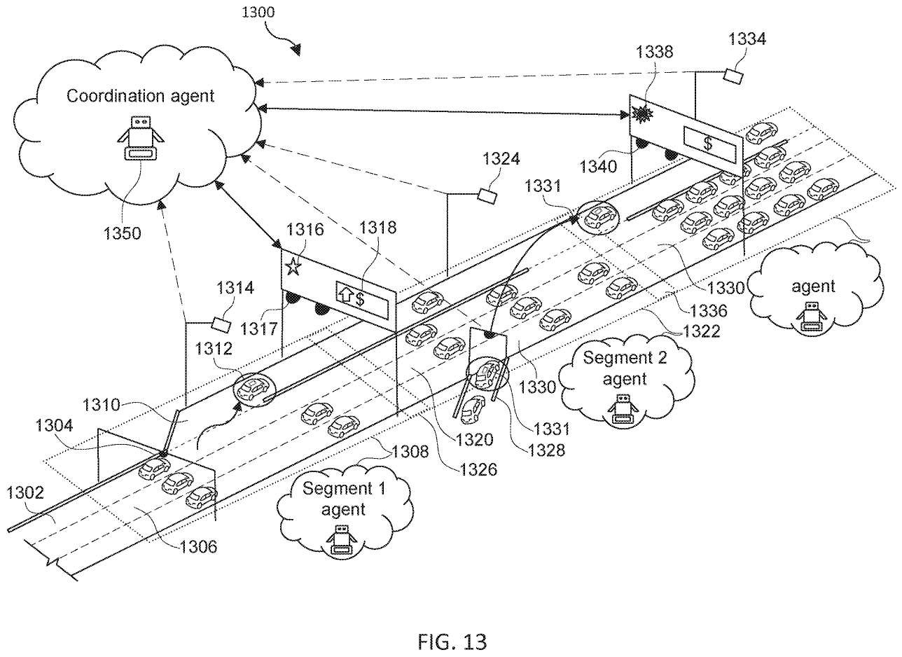

FIG. 13 illustrates a multi-agent reinforced machine learning system 1300 that monitors segments of a roadway to maximize throughput. A roadway 1302 has a plurality of lanes and is divided into two or more segments. An entry point to a first segment 1306 of the roadway 1302 may be monitored by one or more sensors 1304. The sensors may monitor all lanes and may measure roadway density, vehicle volumes and speeds. These data points may determine the travel time in the general purpose lanes which determines the travel time saved for using the managed lane.

Accurate data collection on highways requires reliable and well-maintained sensors. Issues like sensor malfunctions, calibration errors, or data transmission problems can lead to inaccurate density measurements. In some cases, backup sensors are provided for verification and validation of the measurements from the primary sensors.

This method assumes a relatively uniform flow of traffic, which is often not the case on highways. Traffic can be influenced by external factors like toll booths, weigh stations, bottlenecks, leading to non-uniform flow patterns.

By locating sensors 1304 along the roadway, an accurate determination of vehicle volume and density is possible. In some cases, the sensors 1304 are configured to identify individual CAV's or accounts associated with individual drivers. The sensors may be placed adjacent to the roadway, within the roadway, or above the roadway, such as by positioning the sensors on a gantry that extends over the roadway. Suitable sensors include, for example, mmWave radar detectors, automatic license plate recognition (ALPR) cameras, RFID tag readers, and Bluetooth readers.

As vehicles proceed along the roadway 1302, they pass through an entrance into a managed section 1306, and the vehicles may be quantified, and their speed measured, among other things. The first managed section 1306 may include a segment 1 agent 1308 that has responsibility for traffic detection and communication coverage for the first managed section 1306 of the roadway.

Along the first section of roadway 1306, a managed lane 1310 may begin and one or more vehicles 1312 may enter the managed lane 1310. A first node 1314 associated with the first managed section 1306 of the roadway may be configured with AI enabled smart cameras that capture images and/or video in the visible and/or IR spectrum of light, LiDAR, mmWave radar, Bluetooth readers, inductive loops, and communication devices such as ultra small cells, CV2X roadside unit (RSU), among others.

In particular, a CV2X RSU facilitates direct communication between vehicles and infrastructure to enhance road safety and traffic efficiency. This communication protocol allows both direct communication and network-based communications, providing low-latency and high-reliability interactions. In some embodiments, CV2X RSUs are fixed communication devices installed along the roadway, such as on traffic signals, sign posts, poles, gantries, or the like. These units serve as intermediaries between vehicles and the broader traffic management system. Their functions include broadcasting safety messages, facilitating vehicle coordination, and data collection and analysis. The segment 1 agent 1308 utilizes the node 1314 to collect and transmit data associated with the first managed section 1306 of roadway.

As a vehicle 1312 enters the managed lane 1310, it passes through a first gantry 1316. The first gantry 1316 is configured with one or more sensors 1317 configured to detect and identify vehicles, including connected-automated vehicles. These include Automatic License Plate Readers (ALPR), 2-D Laser curtains for profiling the vehicle size, RFID toll tag readers, and other cameras to detect make and model or number of axles. It can also include communication devices to the vehicle including designated short-range communications or cellular V2X technology, and in some cases, can determine a number of occupants in the vehicle. The gantry may also display some human-readable indicia 1318 that may include one or more of an open/closed indication, a time of permissible lane usage, lane usage restrictions, a price for lane usage, among other things. Of course, this same indicia may be provided directly to connected-automated vehicles or CAV's in general through wireless digital communication means, as described herein.

After passing through a first gantry 1316, the vehicle 1312 may enter a second managed segment 1320. The second managed segment 1320 may be associated with a segment 2 agent 1322 that is associated with a second node 1324. The segment 2 agent 1322 may provide detection and communication coverage, and onramp detection, among other things for the second managed segment 1320 and may have some geographic overlap 1326 with the first managed segment. The second node 1324 may be similar to the first node 1314 and may have correspondingly similar sensor and communication capabilities.

An on ramp 1328 may be configured with sensors 1333 to monitor the on ramp 1328 to the general-purpose lanes of the second segment 1320 of the roadway. As with other sensors along the roadway, these may include mmWave radar detectors, ALPR cameras, RFID tag readers, and Bluetooth readers such as to identify the CAV. The on ramp 1328 may have a gantry or some other mounting point for the sensors 1333, which communicate with the segment 2 agent 1322. As a CAV 1331 travels on the on ramp 1328 onto the general-purpose lanes, the segment 2 agent 1322 adds this vehicle count to the total vehicle count on the roadway. If the vehicle then proceeds to enter the managed lane 1310, it can be determined, such as by another gantry in the downstream roadway segment.

After passing through the second managed segment 1320, a vehicle may enter a third managed segment 1330. The third managed segment 1330 may be associated with a segment 3 agent 1332 that is associated with a third node 1334. The segment 3 agent may provide detection and communication coverage, onramp detection, among other things for the third managed segment 1330 and may have some geographic overlap 1336 with the second managed segment 1320. The third node 1334 may be similar to the first node 1314 and may have correspondingly similar sensor and communication capabilities.

The third segment 1330 may include a second gantry 1338 which may be associated with an exit point from the managed lane 1310. The second gantry 1338 may include one or more sensors 1340 such as those described in conjunction with other gantries described herein. The second gantry 1338 can further detect that additional vehicles have entered the managed lane 1310, such as by comparing a time-wise vehicle count with a similar count from an upstream gantry system. The second gantry 1338 may also be a last gantry along the managed lane 1310 and can send data, through the segment 3 agent 1332 associated with billing an appropriate account for use of the managed lane 1310.

In some cases, the segment 1 agent 1308, the segment 2 agent 1322, and the segment 3 agent 1332 all communicate with a coordination agent 1350. The coordination agent 1350 may sit at the highest level of the system, be responsible for the entire roadway asset, and communicate with each agent along the roadway 1302. The system is thus configured to monitor each segment of the roadway, including any on or off ramps, managed lanes, and can determine the volume, density, and speed of the traffic on the roadway.

By monitoring all entry and exit points of the facility each agent can detect the presence of registered CAVs through their account details such as a toll tag, license plate, mac address, etc. The segment agents can share this information with the coordination agent for future traffic conditions prediction. For example, the coordination agent 1350 can learn patterns or preferences of CAVs under various traffic conditions, and the correlating toll prices and travel time saved (what did the CAV accept/reject under certain conditions). In addition, it can learn what discounts or incentives the CAV has a propensity to accept and ones it rejects and can tailor it to be more effective in future offerings that meet the objectives of the coordination agent. In some embodiments, the segment agents can offer discounts or incentives to individual CAVs based on prior behaviors and history. In some cases, the coordination agent can override individual decisions of each segment agent and can send instructions for segment agents to follow. For example, the coordination agent may have upstream information indicating that an emergency vehicle will soon be entering the first managed section 1306 and each segment agent can control traffic ingress and egress accordingly. Similar, in the case of an accident or first responders on scene, the coordination agent 1350 can issue instructions to each segment agent to manage traffic to increase first responder safety during an incident.

As a further practical example, a tolled expressway with multiple segments may be each monitored by its own agent. CAVs planning to travel on this express lane share their route plans with the coordination agent 1350. The coordination agent 1350 predicts a high volume of traffic in Segment 3 1330 during the morning rush hour which will correlate to a higher capture rate for the managed lane 1310. It informs the Segment 1 agent 1308, which raises toll prices to manage the capture rate flow. Throughout this process, agents continuously share data and feedback to optimize overall traffic flow.

The integration of CAV data into a multi-agent system allows for a more responsive and efficient traffic management approach, leveraging real-time information to make proactive adjustments. This has the effect of smoothing and optimizing traffic flow, increasing predictability in travel times, and managed lane capture rates.

For example, the CAV 1331 could request toll prices and travel time saved for multiple routes such as entering the through segment 1 or 2. The multi-agent monitoring system coordinates across multiple agents/segments to identify the optimal path based on the CAV's estimated time of arrival for each route. Based on CAV information and information from the Segment 3 Agent 1332, the Segment 2 Agent 1322 warns that based on their time of arrival the agent will likely be initiating ramp metering to smooth traffic flow to reduce stop-and-go conditions, create better utilization of road space that will allow more vehicles to switch lanes and access the express lane if so desired. However, this will increase the dwelling time to access the facility increasing the travel time for the CAV 1331, but this is also the last access point to the express lane 1310 which will also have a lower price than Segment 1 to access the express lane. The Segment 1 Agent 1308 does not have ramp metering as it directly connects to a free highway however because the Segment 3 Agent 1332 is anticipating congestion it informs the Coordination Agent that it anticipates these traffic conditions and will instruct Agent 1 1308 to raise the toll price by the time the CAV arrives; however accessing the express lane at this location will avoid the possibility of dwelling at a ramp meter and increase the travel time saved.

In some instances, the multi-agent reinforced learning system described may override what it would normally do in order to influence speed, harmonization of traffic, and decisions of the CAV. For example, the multi-agent reinforced learning system may provide additional, or alternative, types of incentives to induvial CAVs that may be different from what the CAV originally requested. The system may determine that a CAV rejects certain prices, during certain times of the day or week. If the future traffic conditions predictions indicate the managed lanes will have excess capacity at the CAVs arrival time to the managed lanes the system may then provide a discount to encourage the CAV to take the managed lane. As a further example, the system may may provide other benefits to the CAV to encourage managed lane usage, such as, for example loyalty reward points that can be redeemed for discounts on future trips or partnership discounts, to name a few.

The result of the above-described embodiments results in a system that uses real-time traffic data and communication with CAVs (including connected-automated vehicles), and using trained machine learning algorithms, to predict future traffic conditions and deploy traffic optimization strategies in order to smooth traffic flow, reduce congestion, increase the predictability in travel times, and reduce environmental impacts from traffic inefficiencies. The system thus knows where each CAV is coming from, its route of travel, where it's going, and whether it accepted the manage lane, which thus enables the reinforced learning systems described herein.

### New Disclosure Begins Here

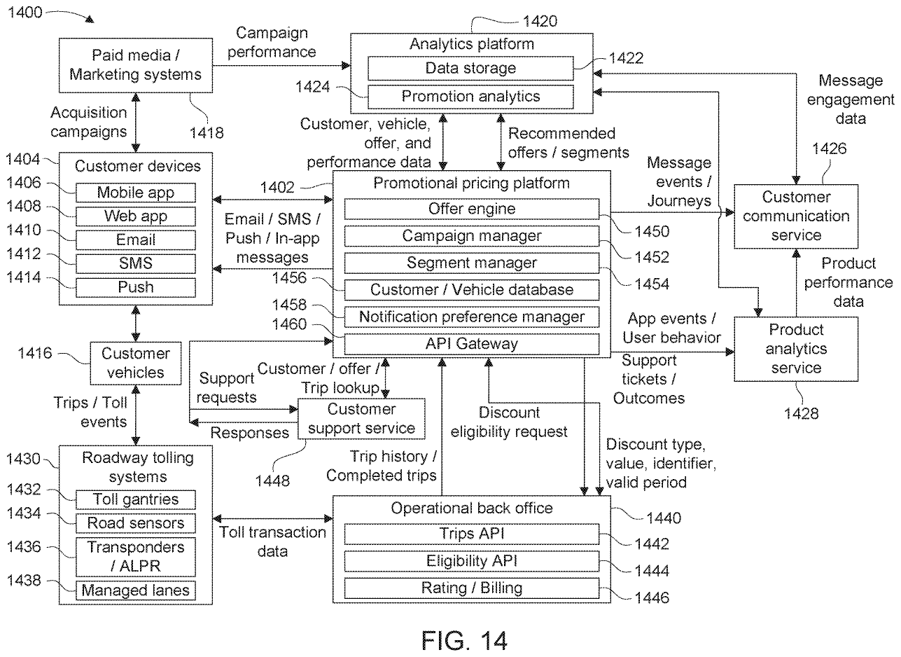

FIG. 14 shows one embodiment of a promotional pricing platform system architecture 1400 configured to acquire customers, associate customers with vehicles, generate and administer promotional offers for managed lane usage, communicate the promotional offers to customers and/or vehicles, and receive tolling and promotional performance feedback. The architecture 1400 can be implemented using one or more processing systems 100 and/or cloud computing environments 200. In some embodiments, the architecture 1400 can be operated by a service provider for a roadway concession, a toll service provider 704, a roadway authority, and/or another managed lane operator.

The architecture 1400 includes a promotional pricing platform 1402 communicatively coupled to customer devices 1404. The customer devices 1404 can include a mobile application 1406, a web application 1408, an email interface 1410, a short message service (SMS) interface 1412, and/or a push notification interface 1414. The customer devices 1404 can include smartphones, tablet computers, laptop computers, desktop computers, in-vehicle infotainment systems, wearable devices, vehicle head units, and/or computing devices associated with the CAV 702. The customer devices 1404 can be used to enroll a customer, receive customer profile data, receive vehicle data, present available promotional offers, receive offer claims, present savings information, receive notification preferences, and/or manage one or more customer vehicles 1416.

The customer vehicles 1416 can include passenger vehicles, commercial vehicles, fleet vehicles, robotaxis, autonomous vehicles, connected vehicles, and/or CAVs 702. Each customer vehicle 1416 can be associated with one or more vehicle identifiers, such as a license plate number, a license plate state, a transponder identifier, a vehicle nickname, a vehicle account identifier, and/or a device identifier. The promotional pricing platform 1402 can associate a customer account with a plurality of customer vehicles 1416, thereby enabling vehicle-specific offers, vehicle-specific savings records, household accounts, fleet accounts, and/or multi-vehicle customer accounts.

The promotional pricing platform 1402 includes an offer engine 1450, a campaign manager 1452, a segment manager 1454, a customer/vehicle database 1456, a notification preference manager 1458, and an API gateway 1460. The offer engine 1450 can create, store, evaluate, and/or update offer records having offer parameters such as threshold type, threshold minimum, discount type, discount value, cap value, subscription condition, validity period, redemption limit, and/or eligibility rule. The campaign manager 1452 can schedule and administer campaigns by associating one or more offers with one or more customer and/or vehicle segments. The segment manager 1454 can create and update segments based on tags, trip history, vehicle attributes, account attributes, inactivity periods, usage frequency, managed lane acceptance history, employer affiliation, geographic area, and/or other segmentation criteria.

The customer/vehicle database 1456 can store customer account data, customer profile data, login data, consent data, notification preferences, vehicle data, license plate data, transponder data, tags, offer claim data, campaign data, discount data, trip progress data, and/or savings data. The customer/vehicle database 1456 can segregate records by concession, roadway, facility, jurisdiction, and/or operator so that data associated with a first managed lane facility can be maintained separately from data associated with a second managed lane facility. The notification preference manager 1458 can store and enforce customer-selected communication preferences for categories such as new offers, expiring offers, redeemed offers, account messages, service messages, and/or support messages across communication channels such as email, SMS, push notifications, in-app messages, and/or web messages.

The API gateway 1460 can provide one or more interfaces through which external systems exchange data with the promotional pricing platform 1402. For example, the API gateway 1460 can receive customer enrollment data from the customer devices 1404, transmit offer data to the customer devices 1404, receive offer claim data from the customer devices 1404, exchange trip and eligibility data with an operational back office 1440, transmit message events to a customer communication service 1426, receive and/or transmit analytics data with an analytics platform 1420, and/or provide customer lookup data to a customer support service 1448. The API gateway 1460 can include authentication, authorization, rate limiting, logging, encryption, and/or data validation functions.

The one or more interfaces of the API gateway 1460 can include an analytics interface communicatively linked to the analytics platform 1420. The analytics interface can transmit customer data, vehicle data, offer data, claimed-offer data, trip data, discount data, savings data, application engagement data, customer support data, and/or campaign performance data to the analytics platform 1420. The analytics interface can also receive recommended offer data, recommended segment data, recommended campaign data, message variant rankings, channel rankings, send-time rules, eligibility rule updates, and/or model parameters from the analytics platform 1420. The analytics interface can be implemented as a synchronous API endpoint, an asynchronous event stream, a batch file transfer, a database replication channel, and/or another data exchange mechanism. In some embodiments, the analytics interface is implemented as part of the API gateway 1460. In other embodiments, the analytics interface is implemented as a separate network interface communicatively linked to the analytics platform 1420.

The architecture 1400 also includes paid media and/or marketing systems 1418 communicatively coupled to the customer devices 1404 and/or the analytics platform 1420. The paid media and/or marketing systems 1418 can deliver acquisition campaigns that invite customers to enroll in the promotional pricing platform 1402. The paid media and/or marketing systems 1418 can generate marketing performance data such as campaign identifiers, source identifiers, channel identifiers, click identifiers, device identifiers, creative identifiers, impressions, clicks, cost data, landing page data, and/or conversion data. The analytics platform 1420 can receive the marketing performance data and use the marketing performance data to evaluate acquisition effectiveness and/or inform future promotional strategies.

The analytics platform 1420 includes a data storage module 1422 and a promotion analytics module 1424. The data storage module 1422 can store customer data, vehicle data, trip data, toll spend data, offer history, claim history, redemption history, savings history, notification engagement data, product engagement data, support data, roadway condition data, and/or marketing attribution data. The promotion analytics module 1424 can analyze the stored data to generate customer segments, vehicle segments, recommended offers, discount values, campaign schedules, channel selections, message variants, and/or predicted promotional outcomes. In some embodiments, the promotion analytics module 1424 can execute one or more trained models configured to predict offer acceptance, incremental managed lane usage, discount cannibalization, customer churn, customer win-back likelihood, expected revenue impact, expected savings, and/or expected roadway level-of-service impact.

The customer communication service 1426 can be communicatively coupled to the promotional pricing platform 1402, the customer devices 1404, and/or the analytics platform 1420. The promotional pricing platform 1402 can transmit message events, customer journey events, campaign identifiers, offer identifiers, message personalization fields, and/or notification preferences to the customer communication service 1426. The customer communication service 1426 can transmit offer messages, onboarding messages, claim confirmations, expiration reminders, savings notifications, redeemed-offer notifications, and/or support messages to the customer devices 1404 through email, SMS, push notification, in-app notification, and/or web notification channels. The customer communication service 1426 can transmit message engagement data, such as sent status, delivery status, open data, click data, bounce data, unsubscribe data, claim conversion data, and/or downstream redemption data, to the analytics platform 1420.

The product analytics service 1428 can be communicatively coupled to the customer devices 1404, the promotional pricing platform 1402, and/or the analytics platform 1420. The product analytics service 1428 can receive application event data such as account creation events, login events, offer view events, offer detail events, offer claim events, vehicle addition events, transponder addition events, savings view events, notification preference events, and/or account deletion events. In some example, the product analytics service 1428 can transmit product performance data to the analytics platform 1420 so that customer engagement behavior can be used to adjust future segments, offers, campaigns, and/or communication strategies.

The architecture 1400 further includes roadway tolling systems 1430 communicatively coupled to the customer vehicles 1416 and the operational back office 1440. The roadway tolling systems 1430 can include toll gantries 1432, roadway sensors 1434, transponder and/or automatic license plate recognition (ALPR) readers 1436, and/or a managed lane facility 1438 having one or more managed lanes 1310. The toll gantries 1432 can include roadside gantries, tolling portals, dynamic toll rate signs and/or gantries 1014, and/or the gantries 1316, 1338. The roadway sensors 1434 can include lidar sensors, radar sensors, infrared sensors, microwave sensors, optical sensors, doppler sensors, cameras, inductive loops, Bluetooth readers, and/or other traffic detection devices. The transponder and/or ALPR readers 1436 can identify a customer vehicle 1416 using a transponder identifier, a license plate identifier, a vehicle classification, and/or another vehicle identifier.

The operational back office 1440 can be communicatively coupled to the roadway tolling systems 1430 and the promotional pricing platform 1402. The operational back office 1440 can implement, be implemented as part of, and/or be communicatively coupled to the ATMS and back office systems 1118. The operational back office 1440 includes a trips API 1442, an eligibility API 1444, and a rating and billing module 1446. The rating and billing module 1446 can receive toll transaction data from the roadway tolling systems 1430, rate toll transactions, request discount eligibility from the promotional pricing platform 1402 through the eligibility API 1444, apply eligible discounts, and generate final billing records. The eligibility API 1444 can transmit, to the promotional pricing platform 1402, a discount eligibility request including a license plate number, license plate state, transponder identifier, account identifier, vehicle identifier, trip time, gantry identifier, facility identifier, and/or lane identifier. The promotional pricing platform 1402 can respond with a discount type, discount value, discount identifier, valid period, redemption limit, and/or other eligibility data.

The trips API 1442 can provide completed trip data from the operational back office 1440 to the promotional pricing platform 1402. The completed trip data can include a trip identifier, entry gantry, exit gantry, entry date, exit date, tag data, trip status, trip type, original trip amount, final trip amount, discount identifier, and/or vehicle identifier. The promotional pricing platform 1402 can use the completed trip data to update claimed-offer progress, determine whether a threshold has been satisfied, update a monthly cap accumulator, update a subscription usage record, calculate savings, display savings to a customer through the customer devices 1404, and/or provide feedback to the analytics platform 1420.

The customer support service 1448 can be communicatively coupled to the customer devices 1404, the promotional pricing platform 1402, and/or the analytics platform 1420. The customer support service 1448 can receive support requests by email, phone, chat, in-app messaging, and/or web messaging. The customer support service 1448 can access customer, vehicle, offer, trip, discount, and/or savings data from the promotional pricing platform 1402 so that a support agent can respond to questions regarding enrollment, offer activation, vehicle registration, transponder registration, claimed offers, discount application, savings, and/or account settings. The customer support service 1448 can transmit support ticket data, transcript data, support outcome data, resolution time data, satisfaction data, and/or issue category data to the analytics platform 1420 for use in future promotional strategy generation.

In one example operation, the paid media and/or marketing systems 1418 deliver an acquisition campaign to a customer device 1404. The customer enrolls through the mobile application 1406 and/or the web application 1408, enters customer profile data and vehicle data, and claims a welcome offer or other available offer generated by the promotional pricing platform 1402. The customer vehicle 1416 later travels through the managed lane facility 1438 and is detected by the roadway tolling systems 1430. The operational back office 1440 receives toll transaction data, requests discount eligibility from the promotional pricing platform 1402, applies an eligible discount during rating and/or billing, and returns completed trip data through the trips API 1442. The promotional pricing platform 1402 updates offer progress and savings records, transmits updated information to the customer devices 1404, and provides performance data to the analytics platform 1420. The analytics platform 1420 can then refine future offers, segments, campaign timing, message variants, communication channels, and/or discount values based on the closed-loop performance data.

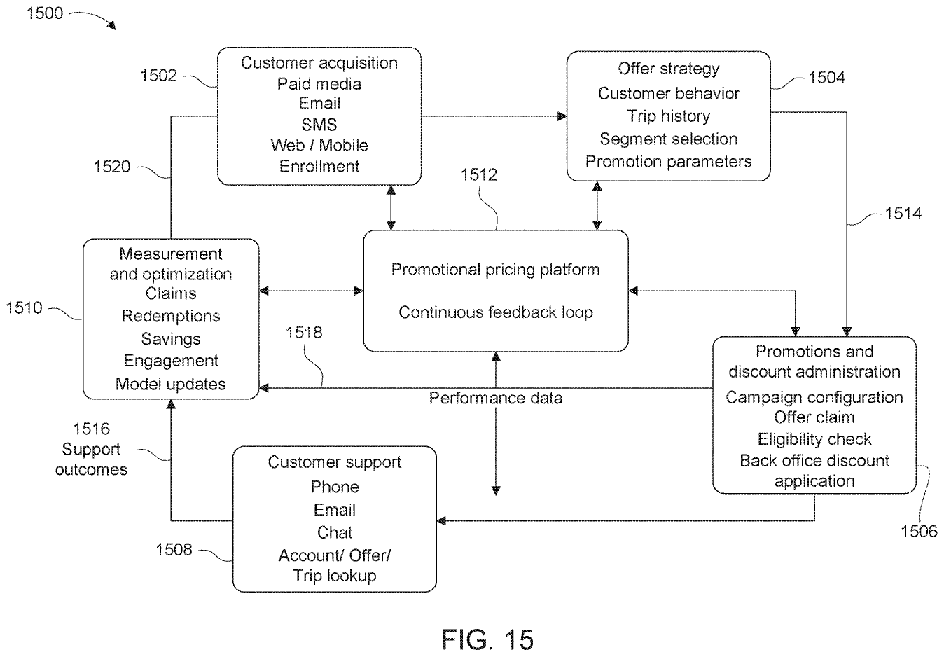

FIG. 15 shows one embodiment of a promotional pricing lifecycle 1500 executable by the promotional pricing platform 1402. The promotional pricing lifecycle 1500 includes a customer acquisition stage 1502, an offer strategy stage 1504, a promotions and discount administration stage 1506, a customer support stage 1508, and a measurement and optimization stage 1510. The stages 1502, 1504, 1506, 1508, 1510 can be coordinated by the promotional pricing platform 1402 through a continuous feedback loop 1512. Rather than merely presenting advertisements or discounts, the promotional pricing lifecycle 1500 can implement a technical data processing loop in which customer identity data, vehicle identity data, toll transaction data, offer eligibility data, communication event data, and/or support event data are converted into machine-readable records used to configure and update promotional offers and back-office discount eligibility rules.

During the customer acquisition stage 1502, the promotional pricing platform 1402 can receive acquisition events from the paid media and/or marketing systems 1418 and enrollment events from the customer devices 1404. Of course, other acquisition channels are contemplated herein, such as organic growth, word of mouth, referrals, social media campaigns, and others. The acquisition events can include campaign identifiers, channel identifiers, click identifiers, device identifiers, landing page identifiers, timestamp data, and/or other attribution data. The enrollment events can include a customer name, email address, phone number, license plate number, license plate state, transponder identifier, consent data, notification preferences, and/or device data. The promotional pricing platform 1402 can validate the received data, detect duplicate accounts, detect duplicate license plates and/or transponders, generate a customer account record, generate one or more vehicle records, and couple the customer account record to the one or more vehicle records in the customer/vehicle database 1456. In some embodiments, the promotional pricing platform 1402 can also generate an acquisition source record that is coupled to the customer account record so that later offer performance can be attributed to a particular acquisition channel and/or campaign.

The customer acquisition stage 1502 can improve operation of the promotional pricing platform 1402 by transforming otherwise disconnected tolling identifiers into a unified customer-vehicle record usable by downstream eligibility checks. For example, a license plate identifier detected by the roadway tolling systems 1430 and/or a transponder identifier detected by the transponder and/or ALPR readers 1436 can be matched to the customer account through the customer/vehicle database 1456. This technical linkage allows an offer claimed through the customer devices 1404 to be applied by the operational back office 1440 when the customer vehicle 1416 is later detected at the managed lane facility 1438.

During the offer strategy stage 1504, the promotional pricing platform 1402 and/or analytics platform 1420 can retrieve customer, vehicle, trip, toll spend, offer history, application engagement, marketing attribution, support, and/or roadway condition data. The promotion analytics module 1424 can normalize the retrieved data, resolve customer and vehicle identities across multiple data sources, and generate feature vectors representing customer and vehicle behavior. The feature vectors can include features such as managed lane usage frequency, inactivity duration, trip count during a time window, toll spend during a time window, offer views, offer claims, offer redemptions, offer expirations, savings amount, preferred travel time, roadway segment usage, and/or responsiveness to communication channels. The promotion analytics module 1424 can evaluate the feature vectors using one or more predictive models to predict an expected acceptance probability, expected incremental usage, expected discount cost, expected revenue impact, expected roadway level-of-service impact, and/or expected probability of reactivating an inactive customer.

The offer strategy stage 1504 can generate an offer strategy record that includes a target segment, an offer type, a threshold type, a threshold minimum, a discount type, a discount amount, a campaign period, an offer validity period, a day-of-week validity rule, a time-of-day validity rule, a redemption limit, and/or a communication strategy. The offer strategy record can be passed to the promotions and discount administration stage 1506 through a strategy-to-administration data path 1514. In some embodiments, the offer strategy record can be generated automatically by the promotion analytics module 1424. In other embodiments, the offer strategy record can be generated by an administrative user through an administrative interface, with the promotion analytics module 1424 providing recommended values, warnings, and/or predicted outcomes.

During the promotions and discount administration stage 1506, the promotional pricing platform 1402 can convert the offer strategy record into one or more executable platform records. The executable platform records can include an offer record, a campaign record, a segment rule, a customer journey event, and/or a back-office eligibility rule. In some instances, a back-office eligibility rule is developed by the promotional pricing platform for the back-office. The offer engine 1450 can store the offer record, the campaign manager 1452 can store the campaign record, and the segment manager 1454 can store and evaluate the segment rule. The API gateway 1460 can expose the back-office eligibility rule to the operational back office 1440 through the eligibility API 1444 so that the rating and billing module 1446 can determine whether a particular toll transaction qualifies for a promotional discount.

The promotions and discount administration stage 1506 can also synchronize the consumer-facing state of an offer with the back-office state of a discount. For example, when a customer claims an offer through the mobile application 1406 and/or web application 1408, the promotional pricing platform 1402 can generate a claimed-offer record that identifies the customer account, vehicle record, campaign record, offer record, claim time, and current progress state. The promotional pricing platform 1402 can then make the claimed-offer record available to the eligibility API 1444. When the operational back office 1440 later rates a toll transaction for the customer vehicle 1416, the operational back office 1440 can query the eligibility API 1444 and receive a discount identifier, discount type, discount value, valid period, and/or redemption limit. This synchronization reduces discrepancies between a discount shown to a customer and a discount applied during toll rating.

The promotions and discount administration stage 1506 can receive completed trip data from the trips API 1442 and update the claimed-offer record. For a trip-threshold offer, the promotional pricing platform 1402 can increment a trip counter associated with the claimed-offer record. For a spend-threshold offer, the promotional pricing platform 1402 can increment a spend accumulator associated with the claimed-offer record. For a monthly cap offer, the promotional pricing platform 1402 can update a period accumulator and determine whether subsequent trips during the period are eligible for reduced pricing, free trips, and/or capped billing treatment. For a subscription offer, the promotional pricing platform 1402 can verify subscription status and transmit subscription-based eligibility data to the operational back office 1440.

The customer support stage 1508 can provide controlled access to customer, vehicle, offer, trip, discount, and/or savings records. A support agent interface can retrieve the customer account record, vehicle records, claimed-offer records, discount records, trip records, and/or savings records from the promotional pricing platform 1402. The customer support service 1448 can generate support event records that include ticket type, ticket status, issue category, response time, resolution time, communication channel, customer sentiment, satisfaction score, and/or resolution outcome. The support event records can be coupled to the customer account record, the vehicle record, the claimed-offer record, and/or the trip record so that support outcomes can be analyzed by the measurement and optimization stage 1510 through a support outcome data path 1516.

During the measurement and optimization stage 1510, the promotional pricing platform 1402 and/or analytics platform 1420 can receive performance data from the promotions and discount administration stage 1506 through a performance data path 1518. The performance data can include offer impressions, message deliveries, message opens, message clicks, offer views, offer claims, offer rejections, threshold progress, threshold completion, redemption events, discount amounts, final billed amounts, savings amounts, and/or completed trip counts. The measurement and optimization stage 1510 can also receive product analytics data from the product analytics service 1428 and message engagement data from the customer communication service 1426.

The measurement and optimization stage 1510 can reconcile multiple event streams having different sources and timing characteristics. For example, an offer claim event from the customer devices 1404 can occur before a toll transaction is detected by the roadway tolling systems 1430, while a discount application event from the operational back office 1440 can occur after toll rating. The promotional pricing platform 1402 can use common identifiers, such as customer account identifiers, vehicle identifiers, license plate identifiers, transponder identifiers, campaign identifiers, offer identifiers, claim identifiers, trip identifiers, and/or discount identifiers, to correlate these asynchronous events. The correlated data can be stored as a performance record that identifies whether an offer was viewed, claimed, progressed, redeemed, expired, replaced, and/or applied to one or more toll trips.

The measurement and optimization stage 1510 can update one or more technical parameters used by the offer strategy stage 1504 through a model update data path 1520. The updated parameters can include model weights, feature importance values, segment membership rules, offer eligibility thresholds, discount value ranges, cap amounts, communication channel rankings, send-time rules, message variant rankings, and/or budget constraints. The updated parameters can be used by the offer strategy stage 1504 to generate future offer strategy records with improved predicted performance. In this manner, the promotional pricing lifecycle 1500 can reduce stale or ineffective offer distribution by automatically incorporating toll transaction feedback and customer response feedback into subsequent offer generation.

The continuous feedback loop 1512 can also use roadway condition data and/or predicted roadway condition data from the future traffic conditions prediction server 1110. For example, if the future traffic conditions prediction server 1110 predicts excess capacity in a managed lane during a future time window, the offer strategy stage 1504 can select customers and/or vehicles having a high predicted likelihood of incremental managed lane usage during that time window. If the future traffic conditions prediction server 1110 predicts that a managed lane is likely to approach a service-level limit, the offer strategy stage 1504 can reduce promotion intensity, delay messages, adjust a discount value, change a target segment, and/or restrict offer validity to a different time window. This coupling of promotional pricing records with predicted roadway condition data can improve computer-controlled allocation of promotional discounts while maintaining traffic-flow objectives of the managed lane facility 1438.

In some embodiments, the lifecycle 1500 can be implemented using event-driven processing. The customer acquisition stage 1502, promotions and discount administration stage 1506, customer support stage 1508, and measurement and optimization stage 1510 can each emit structured event records to an event stream. The promotional pricing platform 1402 can process the event records using idempotent event handlers so that repeated messages do not produce duplicate claims, duplicate discounts, duplicate savings records, or duplicate vehicle tags. The event records can be timestamped and versioned so that the promotional pricing platform 1402 can reconstruct offer eligibility at the time a toll transaction occurred. This event-driven architecture can improve reliability of discount administration in a distributed tolling environment where customer devices 1404, roadway tolling systems 1430, operational back office 1440, communication services, analytics services, and/or support services operate asynchronously.

In some embodiments, the lifecycle 1500 can maintain audit data for each state transition. For example, the promotional pricing platform 1402 can store when a customer accepted terms, when a vehicle was added, when an offer was displayed, when the offer was claimed, when each qualifying trip was received from the operational back office 1440, when a threshold was satisfied, when a discount eligibility response was transmitted, when a discount was applied, and/or when savings were displayed. The audit data can be used to resolve customer support issues, verify back-office discount application, train promotional models, and/or confirm that offer terms were applied according to the stored offer record.

The promotional pricing lifecycle 1500 therefore provides a technical framework in which customer acquisition, offer generation, discount eligibility, toll transaction rating, customer support, and performance measurement are coupled through machine-readable records and feedback paths. The lifecycle 1500 can improve the operation of the promotional pricing platform 1402 by reducing latency between customer behavior and offer configuration, synchronizing customer-facing offer states with back-office discount states, reconciling asynchronous tolling and application events, and updating predictive models and eligibility rules based on measured tolling outcomes.

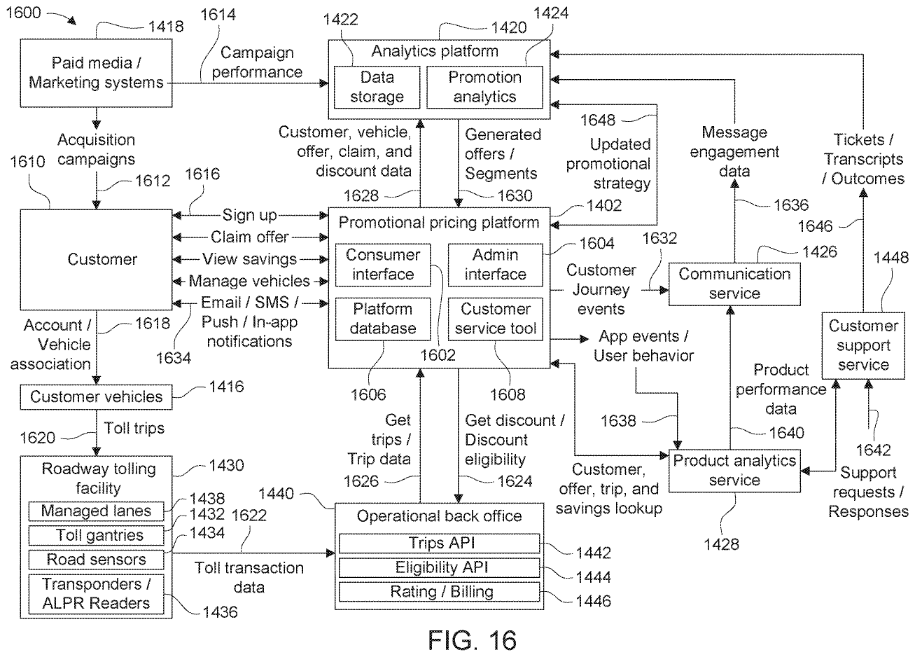

FIG. 16 shows one embodiment of an end-to-end promotional pricing data flow 1600 for coordinating customer acquisition, offer generation, campaign delivery, toll discount administration, trip reconciliation, customer support, and performance feedback. The data flow 1600 can be implemented using the promotional pricing platform 1402, the customer devices 1404, the paid media and/or marketing systems 1418, the analytics platform 1420, the customer communication service 1426, the product analytics service 1428, the roadway tolling systems 1430, the operational back office 1440, and the customer support service 1448 described with respect to FIG. 14.

The promotional pricing platform 1402 can include a consumer interface 1602, an administrative interface 1604, a platform database 1606, and a platform customer service tool 1608. The consumer interface 1602 can be presented through the mobile application 1406, the web application 1408, and/or an in-vehicle interface associated with a customer vehicle 1416. The consumer interface 1602 can receive customer sign-up data, terms acceptance data, privacy consent data, vehicle data, transponder data, offer claim data, notification preference data, and/or account management data. The administrative interface 1604 can receive campaign configuration data, offer configuration data, segment configuration data, bulk vehicle tag data, message variant data, validity window data, redemption limit data, and/or publication schedule data from an administrative user.

The platform database 1606 can store data records generated and/or used by the consumer interface 1602 and the administrative interface 1604. In some embodiments, the platform database 1606 can include the customer/vehicle database 1456. The platform database 1606 can store customer account records, vehicle records, license plate records, transponder records, tag records, segment records, offer records, campaign records, claimed-offer records, notification preference records, eligibility records, trip progress records, discount records, and/or savings records. The platform customer service tool 1608 can provide controlled access to selected records stored in the platform database 1606 so that support personnel can determine account status, vehicle status, offer claim status, discount progress, trip history, discount application, and/or savings history without directly modifying underlying toll rating data.

The data flow 1600 can begin when the paid media and/or marketing systems 1418 deliver an acquisition campaign to a customer 1610 through an acquisition campaign data path 1612. The acquisition campaign can include a digital advertisement, email, SMS message, push message, in-app message, QR code, web link, direct mail code, and/or other acquisition prompt. The paid media and/or marketing systems 1418 can also transmit campaign performance data to the analytics platform 1420 through a marketing performance data path 1614. The campaign performance data can include impressions, clicks, cost per click, cost per impression, click identifiers, device identifiers, campaign identifiers, creative identifiers, audience identifiers, placement identifiers, geographic data, and/or landing page engagement data. The analytics platform 1420 can store this data in the data storage module 1422 so that later customer enrollment, offer claim, redemption, and savings data can be attributed to a particular acquisition source.

The customer 1610 can interact with the promotional pricing platform 1402 through a sign-up and claim data path 1616. During sign-up, the consumer interface 1602 can receive customer identity data, contact data, credential data, and/or consent data. The consumer interface 1602 can also receive vehicle data such as license plate number, license plate state, vehicle nickname, and/or transponder identifier. The promotional pricing platform 1402 can validate the received data, normalize the received data into a canonical format, and store the validated data in the platform database 1606. For example, a license plate can be normalized by removing spaces and/or punctuation, converting alphabetic characters to a common case, and coupling the plate number to a license plate state. A transponder identifier can be checked for valid length, valid character set, checksum pattern, and/or duplicate association. These validation and normalization operations allow the promotional pricing platform 1402 to later match vehicle identifiers received from the operational back office 1440 to customer-facing offer claims stored in the platform database 1606.

The customer 1610 can be associated with a customer vehicle 1416 through an account and vehicle association data path 1618. The customer vehicle 1416 can be identified by a license plate, transponder, mobile device identifier, vehicle identifier, fleet identifier, and/or CAV identifier. The customer vehicle 1416 can travel through the roadway tolling systems 1430, such as toll gantries 1432, roadway sensors 1434, transponder and/or ALPR readers 1436, and/or the managed lane facility 1438. A toll trip data path 1620 can carry trip detection events from the customer vehicle 1416 to the roadway tolling systems 1430. The roadway tolling systems 1430 can generate toll transaction data including entry data, exit data, gantry identifiers, lane identifiers, transponder data, license plate data, timestamp data, vehicle classification data, and/or roadway facility data.

The roadway tolling systems 1430 can transmit toll transaction data to the operational back office 1440 through a toll transaction data path 1622. The operational back office 1440 can create a toll transaction record and process the toll transaction record using the rating and billing module 1446. During rating, the operational back office 1440 can request discount eligibility from the promotional pricing platform 1402 through the eligibility API 1444. The eligibility API 1444 can transmit a discount eligibility query to the API gateway 1460 and/or another interface of the promotional pricing platform 1402. The discount eligibility query can include a vehicle identifier, license plate number, license plate state, transponder identifier, roadway identifier, gantry identifier, lane identifier, timestamp, trip type, and/or transaction identifier.

The promotional pricing platform 1402 can process the discount eligibility query by matching one or more identifiers in the query against the platform database 1606. The promotional pricing platform 1402 can determine whether a corresponding customer account exists, whether the customer vehicle 1416 is enrolled, whether a claimed-offer record is active, whether the claimed-offer record is associated with the customer vehicle 1416, whether the trip time falls within an offer window, whether day-of-week and/or time-of-day restrictions are satisfied, whether a threshold has been met, and/or whether a redemption limit remains available. The promotional pricing platform 1402 can then return eligibility data to the operational back office 1440 through a discount eligibility data path 1624. The eligibility data can include a discount identifier, discount type, discount value, cap amount, valid period, redemption limit, and/or status value indicating that no discount is available.

The operational back office 1440 can apply the returned eligibility data during toll rating and/or billing. After a toll transaction is rated, the operational back office 1440 can provide completed trip data to the promotional pricing platform 1402 through the trips API 1442 and a trip data path 1626. The completed trip data can include a trip identifier, entry gantry, exit gantry, entry date, exit date, tag information, trip status, trip type, original trip amount, final trip amount, discount identifier, and/or applied discount amount. For example, in some cases, an original trip amount is the amount before any discounts are applied, and the final trip amount is an amount after any discounts are applied. The final trip amount may be affected by other independent factors as well, such as discounts offered by the roadway manager for example. The promotional pricing platform 1402 can store the completed trip data and/or a derived trip progress record in the platform database 1606. The promotional pricing platform 1402 can also update a claimed-offer progress value, a trip counter, a spend accumulator, a cap accumulator, a redemption counter, and/or a savings record.

The promotional pricing platform 1402 can transmit customer, vehicle, offer, claim, discount, savings, and performance data to the analytics platform 1420 through a platform analytics data path 1628. The transmitted data can be structured as event records and/or batch records. The event records can include account-created events, vehicle-added events, offer-viewed events, offer-claimed events, threshold-progress events, threshold-reached events, discount-applied events, offer-expired events, offer-replaced events, trip-completed events, savings-calculated events, and/or notification-preference events. The analytics platform 1420 can store the data in the data storage module 1422 and process the data using the promotion analytics module 1424.

The promotion analytics module 1424 can generate recommended offers, recommended segments, recommended discount values, recommended campaign schedules, and/or recommended communication strategies. The analytics platform 1420 can transmit these generated offers and segments to the promotional pricing platform 1402 through a generated strategy data path 1630. In some embodiments, the generated strategy data path 1630 can include an automated data interface. In other embodiments, the generated strategy data path 1630 can include a file transfer, scheduled data export, and/or administrative upload. The promotional pricing platform 1402 can convert received offer and/or segment recommendations into platform records that are editable, reviewable, publishable, and/or executable through the administrative interface 1604.

The customer communication service 1426 can be coupled to the promotional pricing platform 1402 through a customer journey event data path 1632. The promotional pricing platform 1402 can transmit journey events, campaign identifiers, customer identifiers, vehicle identifiers, offer identifiers, message personalization fields, notification category data, and/or channel preference data to the customer communication service 1426. The customer communication service 1426 can then transmit messages to the customer 1610 through a customer message data path 1634. The messages can include enrollment confirmations, welcome offers, new offer notifications, expiring offer reminders, threshold progress notifications, threshold reached notifications, discount received notifications, savings summaries, and/or account messages. The customer communication service 1426 can provide message engagement data to the analytics platform 1420 through a message engagement data path 1636. The message engagement data can include delivery status, open events, click events, bounce events, unsubscribe events, time-to-open values, time-to-click values, and/or conversion events.

The product analytics service 1428 can receive application event data from the promotional pricing platform 1402 and/or the customer devices 1404 through an application event data path 1638. The application event data can include session starts, screen views, offer card views, offer detail views, offer claims, menu actions, account edits, notification preference changes, vehicle additions, transponder additions, savings views, and/or transaction detail views. The product analytics service 1428 can process the application event data into product performance data and transmit the product performance data to the analytics platform 1420 through a product performance data path 1640. The analytics platform 1420 can use the product performance data to determine whether a user interface change, offer wording, claim flow, notification setting, and/or vehicle onboarding step affects offer acceptance and/or redemption.

The customer 1610 can communicate with the customer support service 1448 through a support request data path 1642. The support request data path 1642 can include email, phone, chat, in-app messaging, and/or web messaging. The customer support service 1448 can access customer, offer, trip, and savings data in the promotional pricing platform 1402. For example, a support agent can retrieve whether a customer vehicle 1416 is enrolled, whether a transponder identifier is coupled to the correct vehicle record, whether a claimed-offer record is active, whether the operational back office 1440 applied a discount, and/or whether a savings record was generated. The customer support service 1448 can transmit ticket data, transcript data, issue category data, response time data, resolution time data, and/or satisfaction data to the analytics platform 1420 through a support outcome data path 1646.

The analytics platform 1420 can generate updated promotional strategy data and transmit the updated promotional strategy data to the promotional pricing platform 1402 through an updated strategy feedback path 1648. The updated promotional strategy data can include revised segment membership, revised offer thresholds, revised discount values, revised campaign timing, revised message variants, revised communication channels, and/or revised targeting rules. In some embodiments, the updated promotional strategy data can be generated by a model trained using the platform analytics data path 1628, the marketing performance data path 1614, the message engagement data path 1636, the product performance data path 1640, the support outcome data path 1646, and/or trip records received through the trip data path 1626. In this manner, the promotional pricing platform 1402 can update future campaigns based on measured toll transactions and measured customer engagement, rather than relying only on static discount rules.

The data flow 1600 can provide technical improvements in synchronizing distributed systems that operate on different event timelines. The customer 1610 can claim an offer before a trip occurs, the roadway tolling systems 1430 can detect a trip while the customer vehicle 1416 is traveling, the operational back office 1440 can rate the trip after detection, and the promotional pricing platform 1402 can update progress and savings after receiving completed trip data. The data flow 1600 can correlate these asynchronous events using persistent identifiers such as customer account identifiers, vehicle identifiers, license plate identifiers, transponder identifiers, campaign identifiers, offer identifiers, claim identifiers, trip identifiers, and/or discount identifiers. This correlation can reduce mismatches between consumer-facing offer states and back-office discount states.

The data flow 1600 can also improve reliability by using validated API messages and idempotent updates. For example, an eligibility API request can be evaluated using a stored claimed-offer record and a versioned offer rule, so that the same toll transaction receives the same eligibility result if the request is retried. A completed trip received through the trips API 1442 can be associated with a unique trip identifier so that duplicate trip messages do not double-count threshold progress and/or savings. Similarly, offer claim events, vehicle addition events, and/or notification events can be stored with unique event identifiers to reduce duplicate claims, duplicate vehicle associations, and/or duplicate customer communications.

The data flow 1600 can further improve computer-controlled offer administration by separating offer generation, offer publication, discount eligibility, toll rating, and savings display into interoperable records. The promotional pricing platform 1402 can generate a customer-facing offer state through the consumer interface 1602 while also generating a machine-readable eligibility state used by the operational back office 1440. The eligibility state can be evaluated during toll rating without requiring manual review of each trip. The completed trip state can then be reconciled back into the promotional pricing platform 1402 to update offer progress and savings displays. This closed-loop data processing allows the platform to administer threshold offers, spend-based offers, monthly cap offers, subscription offers, and/or vehicle-specific offers across separate tolling and customer engagement systems. In some cases, a threshold offer includes a benefit once a customer has taken a certain number of trips in managed lanes, or exceeded a threshold spend. In some instances, a monthly cap may be applied where a customer is offered unlimited lane usage for a fixed, capped, spend amount.

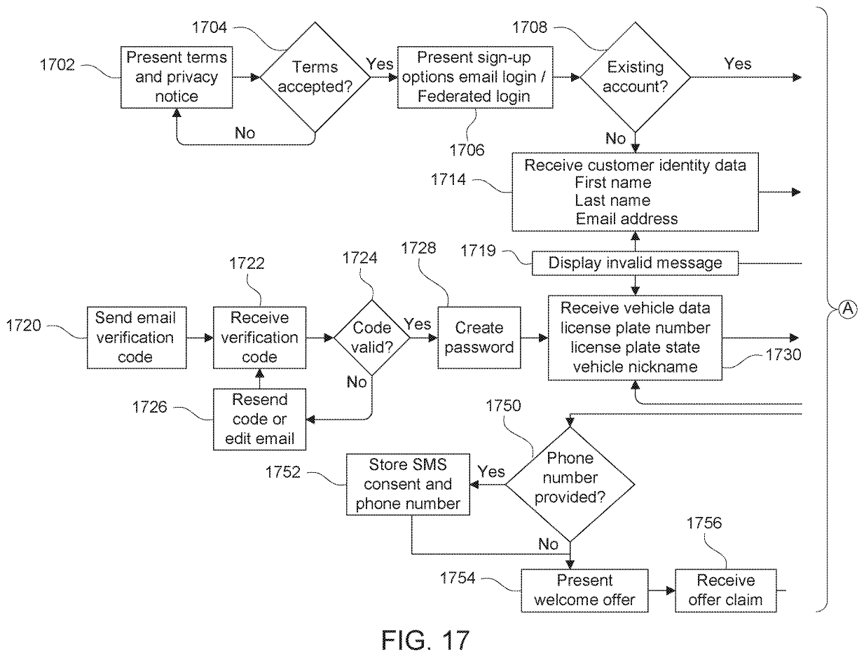

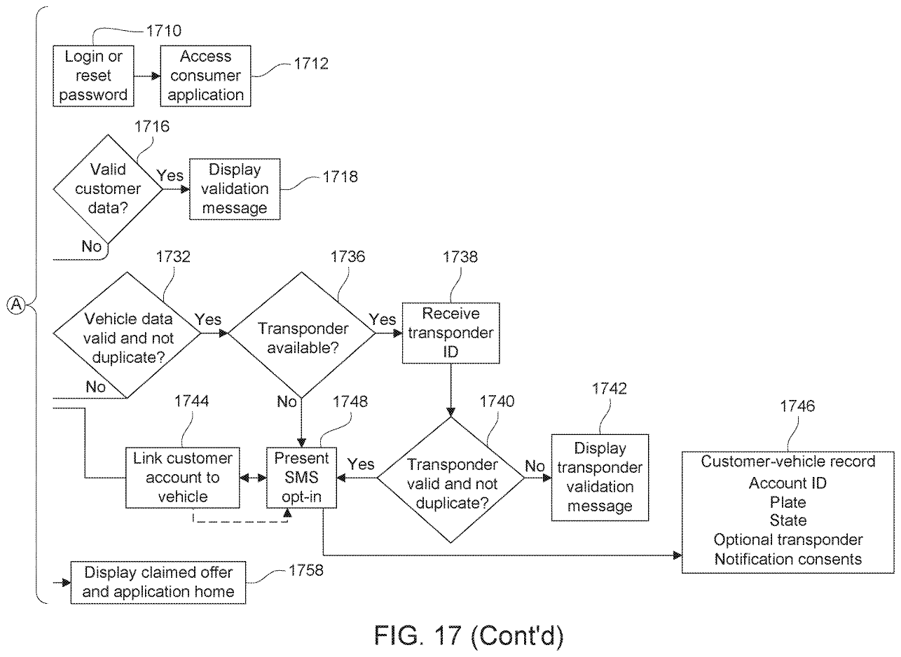

FIG. 17 shows one embodiment of a customer acquisition and onboarding flow 1700 executable by the promotional pricing platform 1402 through the customer devices 1404. The onboarding flow 1700 can be used to create a customer account, verify customer contact information, couple the customer account to one or more customer vehicles 1416, store notification consent data, and present an initial promotional offer. The onboarding flow 1700 can convert customer-entered data into validated machine-readable records that can be matched to toll transaction data received from the operational back office 1440 and/or roadway tolling systems 1430.

The onboarding flow 1700 begins with presenting a terms and privacy notice at block 1702. The terms and privacy notice can be presented through the mobile application 1406, the web application 1408, an in-vehicle interface, and/or another interface of the customer devices 1404. The promotional pricing platform 1402 can receive an acceptance input at decision block 1704. If the terms and privacy notice is not accepted, the promotional pricing platform 1402 can continue presenting the terms and privacy notice, block access to account creation, and/or store a non-enrollment event. If the terms and privacy notice is accepted, the promotional pricing platform 1402 can generate a consent record that includes a consent version, consent timestamp, customer device identifier, session identifier, Internet Protocol address, and/or roadway program identifier. The consent record can be stored in the customer/vehicle database 1456 and later coupled to a customer account record.

At block 1706, the promotional pricing platform 1402 presents sign-up options. The sign-up options can include email-based account creation, email-based login, and/or federated login through a third-party identity provider. The promotional pricing platform 1402 can use the API gateway 1460 to initiate authentication requests, receive identity tokens, validate token signatures, and/or map a federated identity to an internal customer account identifier. Decision block 1708 determines whether the customer is associated with an existing account. For example, the promotional pricing platform 1402 can compare a normalized email address, federated login identifier, phone number, and/or other identity value against existing records in the customer/vehicle database 1456. If an existing account is detected, the flow can proceed to a login or reset password operation at block 1710. After authentication is completed, the customer can access the consumer application at block 1712.

If the promotional pricing platform 1402 determines at decision block 1708 that the customer is not associated with an existing account, the promotional pricing platform 1402 receives customer identity data at block 1714. The customer identity data can include a first name, a last name, an email address, an acquisition source identifier, a campaign identifier, a referral identifier, and/or other enrollment data. The promotional pricing platform 1402 can normalize the customer identity data before storage. For example, the promotional pricing platform 1402 can trim extraneous characters, convert email addresses to a standardized case, check name fields against permitted character rules, and/or associate the enrollment data with a roadway program identifier so that customer records for different toll facilities can be maintained separately.

At decision block 1716, the promotional pricing platform 1402 validates the customer identity data. The validation can include determining whether a first name field is populated, whether a last name field is populated, whether an email address is formatted correctly, whether the email address is already associated with an existing account, whether a federated identity is already associated with an existing account, and/or whether the customer has previously opted out of the program. If validation fails, the promotional pricing platform 1402 displays a validation message at block 1719 and returns to block 1714. The validation message can identify a missing name field, invalid email format, existing account condition, and/or another validation condition. This validation can reduce duplicate account creation and can improve later matching between customer-facing offer records and back-office tolling records.

If the customer identity data is valid, the promotional pricing platform 1402 sends an email verification code at block 1720. The verification code can be a one-time code, token, and/or link generated by the promotional pricing platform 1402 and transmitted through the customer communication service 1426. The verification code can be stored as a hashed value, associated with an expiration time, and coupled to the pending customer account record. At block 1722, the promotional pricing platform 1402 receives a verification code entered through the customer device 1404. At decision block 1724, the promotional pricing platform 1402 determines whether the received verification code is valid. The validation can include comparing a hash of the received code to a stored hash, checking expiration data, checking attempt count data, and/or checking whether the code corresponds to the pending customer account. If the code is not valid, the promotional pricing platform 1402 can present a resend code or edit email operation at block 1726 and return to block 1722.

If the verification code is valid, the promotional pricing platform 1402 creates login credentials at block 1728. In an email-based embodiment, the promotional pricing platform 1402 can receive a password and a confirmed password, verify that the password and confirmed password match, evaluate password complexity rules, hash the password using a secure hashing function, and store the password hash in association with the customer account record. In a federated login embodiment, the promotional pricing platform 1402 can store a verified identity provider identifier and omit storage of a platform password. After credentials are created, the promotional pricing platform 1402 can change the pending customer account record to a verified account state.

At block 1730, the promotional pricing platform 1402 receives vehicle data. The vehicle data can include a license plate number, a license plate state, a vehicle nickname, a vehicle type, a vehicle make, a vehicle model, and/or a vehicle classification. The license plate state can be stored with the license plate number because the same plate number can exist in multiple states or jurisdictions. The vehicle nickname can be used in the customer interface to distinguish multiple vehicles associated with the same account. The promotional pricing platform 1402 can normalize the license plate number by removing spaces, punctuation, and/or special characters, converting alphabetic characters to a standardized case, and storing the normalized plate number with the license plate state.

At decision block 1732, the promotional pricing platform 1402 determines whether the vehicle data is valid and not duplicate. The validation can include checking that the license plate number has a permitted format, checking that the license plate state is selected, checking that the vehicle nickname satisfies a character and/or length rule, and checking that the same license plate number and license plate state are not already associated with another active customer account. The duplicate check can be performed by querying a normalized license plate index in the customer/vehicle database 1456. If the vehicle data fails validation, the promotional pricing platform 1402 displays a vehicle validation message and returns to block 1730. The vehicle validation message can indicate an invalid license plate number, missing license plate state, invalid nickname, and/or plate already in use condition.

If the vehicle data is valid, the promotional pricing platform 1402 determines at decision block 1736 whether a transponder is available for the customer vehicle 1416. If the customer indicates that a transponder is available, the promotional pricing platform 1402 receives a transponder identifier at block 1738. The promotional pricing platform 1402 can also present help information, such as instructions for finding a transponder identifier on a toll tag. At decision block 1740, the promotional pricing platform 1402 determines whether the transponder identifier is valid and not duplicate. The validation can include checking a permitted length, permitted character set, checksum rule, issuer prefix, facility-specific format, and/or active use status. The duplicate check can include determining whether the transponder identifier is already associated with another active vehicle record.

If the transponder identifier is not valid or is already in use, the promotional pricing platform 1402 displays a transponder validation message at block 1742 and returns to block 1738. If the transponder identifier is valid, or if the customer indicates at decision block 1736 that no transponder is available, the promotional pricing platform 1402 links the customer account to the vehicle at block 1744. The linking operation can create a customer-vehicle record 1746 in the customer/vehicle database 1456. The customer-vehicle record 1746 can include an account identifier, a vehicle identifier, a license plate number, a license plate state, a vehicle nickname, an optional transponder identifier, a roadway program identifier, a vehicle status, a tag set, and/or timestamp data. In some embodiments, the customer-vehicle record 1746 can be indexed by license plate number and license plate state, transponder identifier, vehicle identifier, and/or customer account identifier to support rapid discount eligibility checks when a toll transaction is rated.

The customer-vehicle record 1746 can improve operation of the overall system by providing a technical bridge between customer-facing offer actions and tolling-system identifiers. For example, an offer claim entered through the customer device 1404 can be coupled to the vehicle identifier in the customer-vehicle record 1746. When the operational back office 1440 later receives a toll transaction involving the same license plate and/or transponder identifier, the eligibility API 1444 can use the customer-vehicle record 1746 to determine whether the corresponding toll trip is associated with an active claimed offer. This bridge reduces reliance on manual reconciliation and reduces risk that a promotional discount is applied to the wrong vehicle or omitted from an eligible vehicle.

At block 1748, the promotional pricing platform 1402 presents an SMS opt-in interface. The SMS opt-in interface can receive a phone number and present consent language describing SMS notifications. At decision block 1750, the promotional pricing platform 1402 determines whether a phone number is provided. If a phone number is provided, the promotional pricing platform 1402 stores SMS consent and the phone number at block 1752. The promotional pricing platform 1402 can normalize the phone number, check formatting, store a consent timestamp, store a consent source, and/or update notification preferences associated with the customer account. If a phone number is not provided, the promotional pricing platform 1402 can continue the onboarding flow 1700 without enabling SMS notifications. In either case, the notification preference manager 1458 can store one or more channel preferences for email, SMS, push notifications, and/or in-app messages.

At block 1754, the promotional pricing platform 1402 presents a welcome offer. The welcome offer can be generated by the offer engine 1450 and/or retrieved from a stored welcome-offer campaign configured by the campaign manager 1452. The welcome offer can be associated with an “all new users” segment, a particular roadway facility, a particular validity period, a redemption limit, and/or a vehicle-specific eligibility rule. In some embodiments, the promotional pricing platform 1402 can determine whether the customer account and/or customer vehicle 1416 qualifies for the welcome offer before presenting the offer. The determination can include checking whether a prior welcome offer has been claimed, whether the vehicle is already associated with another account, whether the account is verified, and/or whether the vehicle record is active.

At block 1756, the promotional pricing platform 1402 receives an offer claim. The offer claim can be generated when the customer selects a claim control through the consumer interface 1602. In response, the promotional pricing platform 1402 can create a claimed-offer record that couples the customer account identifier, vehicle identifier, offer identifier, campaign identifier, claim timestamp, validity data, redemption limit, and/or current progress value. The claimed-offer record can be stored in the platform database 1606 and can be made accessible through the eligibility API 1444. In some embodiments, the promotional pricing platform 1402 can enforce a single-active-offer rule, such that a newly claimed offer deactivates or replaces a prior active offer for the same customer vehicle 1416 after confirmation from the customer.

At block 1758, the promotional pricing platform 1402 displays a claimed offer and application home screen. The home screen can include an offers interface showing claimed offers and available offers, a savings interface showing discount savings, a vehicles interface showing registered vehicles, and/or an account interface showing notification preferences and profile settings. The promotional pricing platform 1402 can also emit onboarding completion data, vehicle addition data, SMS consent data, welcome-offer display data, welcome-offer claim data, and/or application home view data to the product analytics service 1428 and/or analytics platform 1420.

The onboarding flow 1700 can be implemented as a state machine in which each customer account progresses through states such as terms presented, terms accepted, identity entered, email verified, credentials created, vehicle added, transponder linked, SMS preference stored, welcome offer presented, and welcome offer claimed. The promotional pricing platform 1402 can store each state transition with a timestamp and event identifier. This state-based processing can prevent later operations from occurring before supporting data exists. For example, the promotional pricing platform 1402 can prevent a claimed-offer record from being activated until the customer account is verified and the customer-vehicle record 1746 is created.

The onboarding flow 1700 can also support idempotent processing. If a customer device 1404 retransmits an identity submission, verification code submission, vehicle submission, or offer claim because of a network interruption, the promotional pricing platform 1402 can use event identifiers, account identifiers, normalized license plate identifiers, transponder identifiers, and/or claim identifiers to determine whether a corresponding record has already been created. This can reduce duplicate accounts, duplicate vehicle records, duplicate transponder associations, and duplicate claimed-offer records.

The onboarding flow 1700 can provide technical improvements to the promotional pricing platform 1402 by creating a validated and indexed customer-vehicle identity layer that is usable by the distributed tolling environment. The validated customer-vehicle record 1746 allows the promotional pricing platform 1402 to match consumer offer claims to roadway tolling events using license plate and/or transponder data received from the operational back office 1440. The flow also improves reliability of discount eligibility by preventing duplicate vehicle and transponder associations, storing consent and notification preferences as structured records, and creating an auditable sequence of account verification, vehicle linkage, and offer activation events.

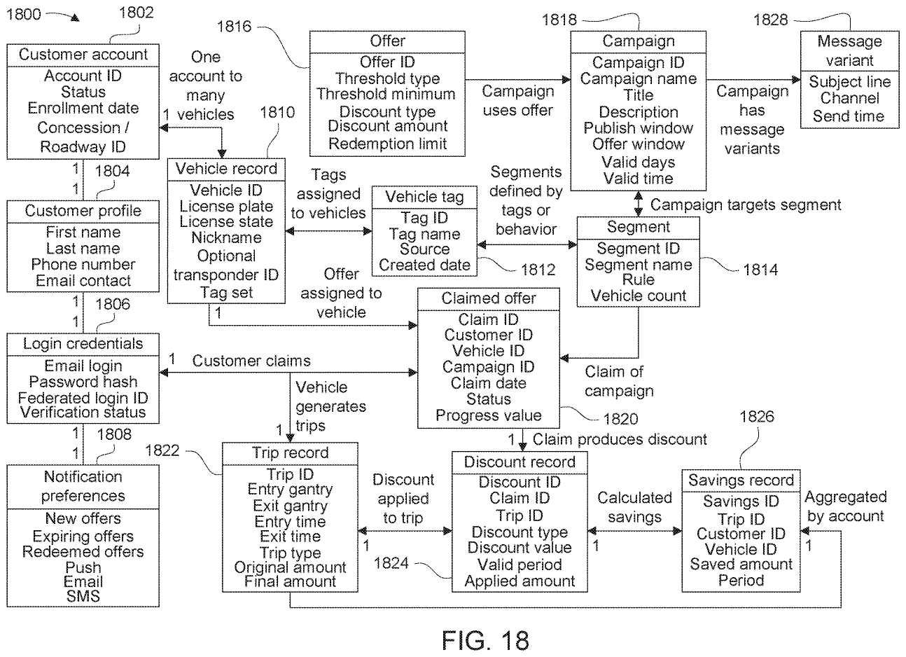

FIG. 18 shows one embodiment of a promotional pricing platform data model 1800 that can be stored in the customer/vehicle database 1456, the platform database 1606, and/or another data storage system coupled to the promotional pricing platform 1402. The data model 1800 can organize customer account data, vehicle identity data, offer data, campaign data, toll trip data, discount data, and/or savings data into machine-readable records that can be queried by the promotional pricing platform 1402, the analytics platform 1420, the operational back office 1440, the customer communication service 1426, the product analytics service 1428, and/or the customer support service 1448.

The data model 1800 includes a customer account record 1802. The customer account record 1802 can include an account identifier, an account status, an enrollment date, a concession identifier, a roadway identifier, a program identifier, and/or account lifecycle metadata. The concession identifier and/or roadway identifier can allow the promotional pricing platform 1402 to separate accounts associated with different managed lane facilities, roadway operators, and/or concession programs. In some embodiments, the customer account record 1802 can include a tenant identifier so that a common promotional pricing platform 1402 can support multiple roadway programs while maintaining separate customer, vehicle, offer, and/or tolling data domains.

The customer account record 1802 can be coupled to a customer profile record 1804. The customer profile record 1804 can store customer-facing profile data such as a first name, a last name, a phone number, an email contact, and/or other contact attributes. In some embodiments, profile data is stored separately from login credentials so that profile updates can be processed without changing authentication records. For example, a customer can update a phone number used for SMS notifications while maintaining the same email login and/or federated login identity.

The customer account record 1802 can also be coupled to a login credential record 1806. The login credential record 1806 can include an email login, a password hash, a federated login identifier, a verification status, a verification timestamp, an identity provider identifier, and/or credential recovery metadata. The login credential record 1806 can support email-based login and/or third-party identity provider login. In some embodiments, the login credential record 1806 can store a verification status indicating whether an email verification code has been successfully validated. The verification status can be used by the promotional pricing platform 1402 to determine whether a claimed-offer record can be activated for a customer account.

The customer account record 1802 can be coupled to one or more notification preference records 1808. Each notification preference record 1808 can store preferences for notification categories such as new offers, expiring offers, redeemed offers, savings summaries, account alerts, and/or support messages. Each notification preference record 1808 can also store channel preferences for push notifications, email messages, SMS messages, in-app messages, and/or web messages. The notification preference manager 1458 can use the notification preference record 1808 when deciding whether to send a customer journey event to the customer communication service 1426.

The customer account record 1802 can be coupled to one or more vehicle records 1810. Each vehicle record 1810 can store a vehicle identifier, a license plate number, a license plate state, a vehicle nickname, an optional transponder identifier, a tag set, a vehicle status, and/or vehicle metadata. In some embodiments, the vehicle record 1810 can be created during the onboarding flow 1700 and can be coupled to or implemented as part of the customer-vehicle record 1746. The vehicle record 1810 can be indexed by a normalized plate-and-state value, a transponder identifier, a customer account identifier, and/or a vehicle identifier. These indexes allow the promotional pricing platform 1402 to quickly match an eligibility request from the operational back office 1440 to a customer account and an enrolled customer vehicle 1416.

The vehicle record 1810 can be coupled to one or more vehicle tag records 1812. The vehicle tag record 1812 can include a tag identifier, a tag name, a tag source, a created date, an expiration date, and/or tag metadata. Tags can be created through bulk vehicle tagging, analytics output, customer behavior analysis, support activity, marketing source data, employer group data, inactivity analysis, and/or managed lane usage analysis. A vehicle tag record 1812 can indicate that a vehicle is associated with a category such as inactive thirty days, inactive sixty days, commuter, high-frequency user, low-frequency user, employer group, geographic group, and/or promotional test group.

One or more vehicle tag records 1812 can be used to define a segment record 1814. The segment record 1814 can include a segment identifier, a segment name, a segment rule, a vehicle count, a created date, a modified date, and/or a segment status. The segment rule can include Boolean logic, tag membership, customer account attributes, vehicle attributes, trip behavior, toll spend behavior, claim behavior, redemption behavior, and/or inactivity behavior. For example, a segment rule can identify vehicles having a particular tag, vehicles with no managed lane trips during a time window, vehicles with toll spend above a threshold, and/or vehicles associated with a particular customer acquisition campaign.

The data model 1800 includes an offer record 1816. The offer record 1816 can include an offer identifier, an offer name, a threshold type, a threshold minimum, a discount type, a discount value, a cap value, a validity rule, a redemption limit, an eligibility rule, and/or an offer status. The threshold type can include no threshold, trip threshold, spend threshold, monthly cap, subscription status, and/or another condition evaluated before a discount is applied. The discount type can include a percentage discount, fixed amount discount, free trip, capped billing amount, subscription-based discount, and/or other promotional pricing treatment. The offer engine 1450 can use the offer record 1816 to generate eligibility parameters for the operational back office 1440.

The offer record 1816 can be coupled to a campaign record 1818. The campaign record 1818 can include a campaign identifier, a campaign name, a title, a short description, a long description, a publish window, an offer window, valid days, valid time of day, a redemption limit, and/or a campaign status. The campaign record 1818 can define when an offer is communicated to customers, when the offer can be claimed, and when the resulting discount can be applied to toll trips. In some embodiments, the campaign record 1818 can include separate fields for a publication start time, publication end time, offer start time, offer end time, day-of-week validity, and/or time-of-day validity so that a campaign can be active for communication during one time window and eligible for discount application during a different time window.

The campaign record 1818 can be coupled to one or more segment records 1814. In this arrangement, the campaign manager 1452 can target the campaign record 1818 to vehicles and/or customer accounts identified by the segment record 1814. The campaign record 1818 can also be coupled to one or more offer records 1816. In some embodiments, a campaign record 1818 can be generated by selecting a segment record 1814 and an offer record 1816 through the administrative interface 1604. The promotional pricing platform 1402 can store the association between the campaign record 1818, the offer record 1816, and the segment record 1814 so that offer eligibility and customer communications are derived from the same campaign configuration.

The campaign record 1818 can be coupled to one or more message variant records 1828. Each message variant record 1828 can include a subject line, a message body, a communication channel, a journey step, a send time, a message status, and/or performance metrics. The customer communication service 1426 can use the message variant record 1828 to transmit different email, SMS, push, and/or in-app message variants to customers. Engagement data associated with the message variant record 1828 can be returned to the analytics platform 1420 and used to determine which message variant is more likely to cause an offer view, an offer claim, a threshold completion, and/or a discount redemption.

The data model 1800 includes a claimed-offer record 1820. The claimed-offer record 1820 can include a claim identifier, a customer account identifier, a vehicle identifier, a campaign identifier, an offer identifier, a claim date, a status, a progress value, a threshold value, a remaining redemption count, and/or claim lifecycle metadata. The claimed-offer record 1820 can couple a customer account record 1802, a vehicle record 1810, an offer record 1816, and a campaign record 1818. This coupling allows the promotional pricing platform 1402 to determine which offer a specific enrolled vehicle has claimed and whether a toll trip detected by the operational back office 1440 should progress, unlock, or redeem the claimed offer.

The claimed-offer record 1820 can store a progress value that is updated using completed trip data received through the trips API 1442. For a trip-threshold offer, the progress value can identify a number of qualifying trips completed during the offer window. For a spend-threshold offer, the progress value can identify a cumulative spend amount during the offer window. For a monthly cap offer, the progress value can identify an accumulated billed amount during a billing period. For a subscription offer, the progress value can identify a subscription status, covered trip count, covered spend amount, and/or usage amount. The promotional pricing platform 1402 can expose the claimed-offer record 1820 to the consumer interface 1602 so that the customer can view progress toward a discount.

The data model 1800 includes a trip record 1822. The trip record 1822 can include a trip identifier, an entry gantry, an exit gantry, an entry time, an exit time, a trip type, tag information, an original amount, a final amount, a trip status, and/or a facility identifier. The trip record 1822 can be generated from completed trip data received from the operational back office 1440. The trip record 1822 can be coupled to the vehicle record 1810 using a license plate number and license plate state, a transponder identifier, a vehicle identifier, and/or another tolling identifier. The trip record 1822 can provide the machine-readable data used to update the claimed-offer record 1820 and calculate savings.

The data model 1800 includes a discount record 1824. The discount record 1824 can include a discount identifier, a claim identifier, a trip identifier, a discount type, a discount value, a valid period, an applied amount, a rating status, and/or billing metadata. The discount record 1824 can couple a claimed-offer record 1820 to a trip record 1822. In some embodiments, the discount record 1824 can store the discount parameters returned to the operational back office 1440 through the eligibility API 1444, as well as the discount actually applied by the rating and billing module 1446. This allows the promotional pricing platform 1402 to reconcile customer-facing offer terms with back-office billing outcomes.

The data model 1800 includes a savings record 1826. The savings record 1826 can include a savings identifier, a trip identifier, a customer account identifier, a vehicle identifier, a saved amount, a period, an original amount, a final amount, and/or aggregation metadata. The savings record 1826 can be derived from the trip record 1822 and the discount record 1824. The promotional pricing platform 1402 can aggregate savings records 1826 by customer account, vehicle, campaign, offer, segment, roadway facility, time period, and/or discount type. The consumer interface 1602 can use the savings record 1826 to display transaction-level savings and total savings for a selected period.

The relationships shown in the data model 1800 can be implemented using relational tables, document records, graph edges, event streams, key-value indexes, and/or a hybrid storage architecture. In a relational implementation, the customer account record 1802, customer profile record 1804, login credential record 1806, notification preference record 1808, vehicle record 1810, vehicle tag record 1812, segment record 1814, offer record 1816, campaign record 1818, claimed-offer record 1820, trip record 1822, discount record 1824, savings record 1826, and/or message variant record 1828 can be stored in tables coupled by foreign key relationships. In a document implementation, related subrecords can be embedded within account, campaign, and/or claim documents. In a graph implementation, vehicles, tags, segments, campaigns, offers, trips, discounts, and/or savings can be represented as nodes coupled by typed edges.

The data model 1800 can improve performance of discount eligibility processing by separating relatively static configuration records from frequently updated transaction records. For example, offer records 1816, campaign records 1818, segment records 1814, and/or message variant records 1828 can be updated when an administrator creates or edits a campaign. Trip records 1822, discount records 1824, savings records 1826, and/or claimed-offer progress values can be updated as toll transactions are processed. This separation allows the promotional pricing platform 1402 to cache campaign and offer rules while updating trip progress and discount records as completed trips arrive from the operational back office 1440.

The data model 1800 can also improve reliability of distributed toll discount administration by providing stable identifiers across systems. For example, the claimed-offer record 1820 can store the claim identifier used by the promotional pricing platform 1402, while the discount record 1824 can store the discount identifier used by the operational back office 1440. The trip record 1822 can store the trip identifier generated by the operational back office 1440. The savings record 1826 can couple the claim identifier, discount identifier, trip identifier, customer account identifier, and/or vehicle identifier. These identifier relationships allow the promotional pricing platform 1402 to correlate an offer claim, a toll trip, a back-office discount application, and a customer-facing savings display even when the underlying events occur at different times.

The data model 1800 can support idempotent processing and duplicate prevention. For example, a unique composite index on license plate number and license plate state can reduce duplicate vehicle registration. A unique index on active transponder identifiers can reduce duplicate transponder association. A unique index on a trip identifier can reduce double-counting of trip progress if a trip API message is retransmitted. A unique association between a claim identifier and a trip identifier can reduce duplicate application of a discount record 1824 to the same trip. These database-level relationships can improve the operational stability of the promotional pricing platform 1402 when messages are retried, delayed, or received out of order.

The data model 1800 can further support versioning of offer and campaign rules. An offer record 1816 and/or campaign record 1818 can include a version identifier, effective time, and/or publication status. Each stored version of an offer record 1816, a campaign record 1818, and/or an eligibility rule derived from the offer record 1816 and/or campaign record 1818 can be referred to as a versioned rule, and the eligibility rule applied by the eligibility and application rules module 2056 in response to an eligibility API request can be referred to as a versioned eligibility rule. A versioned rule and/or a versioned eligibility rule can be associated with the version identifier, the effective time, an expiration time, the publication status, a configuration hash, and/or an administrator identifier. A claimed-offer record 1820 can store the version of the offer record 1816 and/or campaign record 1818 that was active when the customer claimed the offer. When the operational back office 1440 requests eligibility, the promotional pricing platform 1402 can evaluate the same stored version rather than a later edited version. The promotional pricing platform 1402 can evaluate the versioned rule and/or the versioned eligibility rule that was effective at the time the toll transaction occurred, even when the underlying offer record 1816 or campaign record 1818 has since been edited, expired, replaced, or unpublished. This versioned rule evaluation can reduce mismatches between offer terms shown to a customer and discount rules applied during toll rating.

The data model 1800 can provide a technical foundation for machine learning and optimization because each customer response and tolling outcome is coupled to the relevant account, vehicle, offer, campaign, segment, trip, discount, and/or savings record. The analytics platform 1420 can use the data model 1800 to build feature vectors for offer acceptance models, incremental usage models, cannibalization models, revenue impact models, level-of-service impact models, and/or churn models. Because the data model 1800 couples customer-facing events to tolling-system events through stable identifiers, the analytics platform 1420 can train models using measured claim, redemption, trip, spend, and/or savings outcomes rather than only message interaction data.

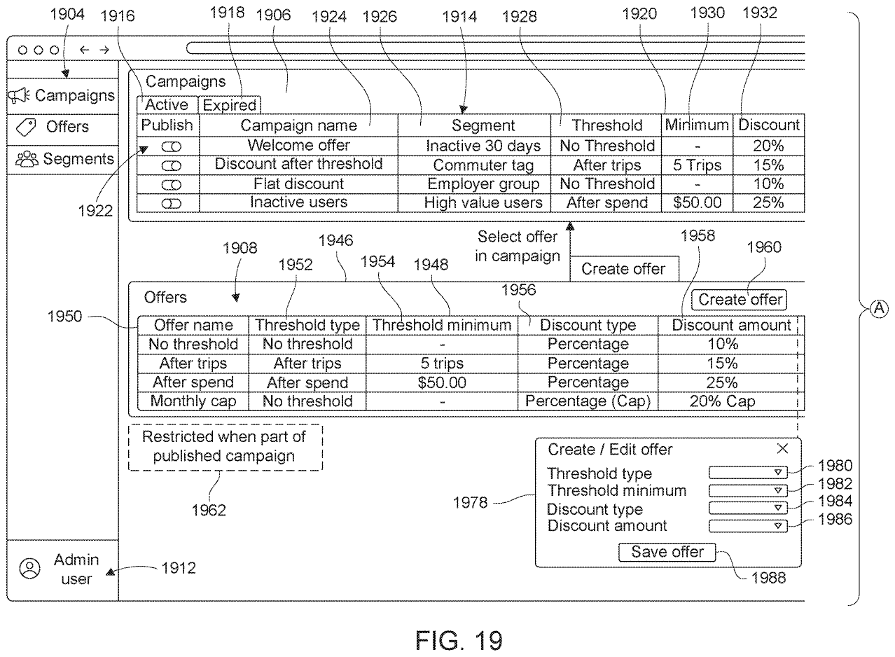

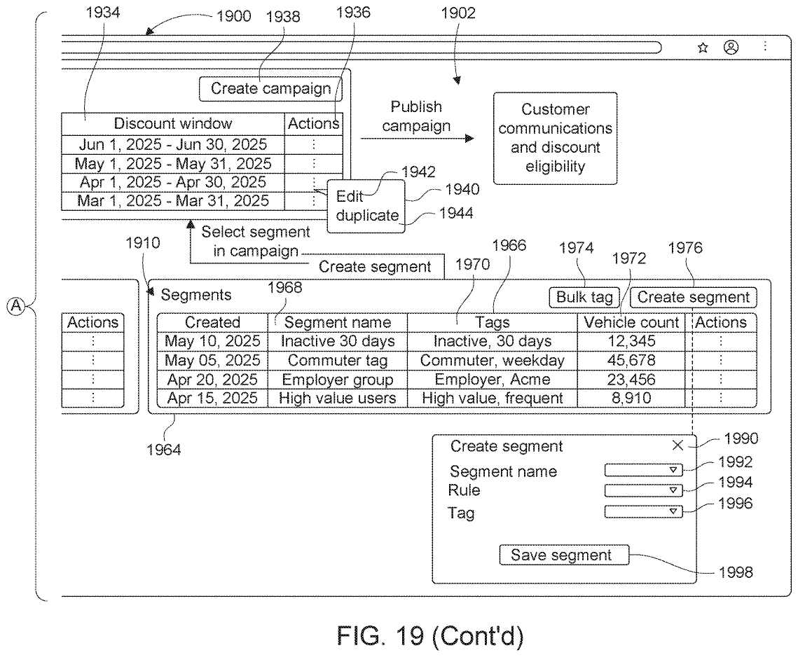

FIG. 19 shows one embodiment of an administrative interface 1900 for configuring promotional pricing operations performed by the promotional pricing platform 1402. The administrative interface 1900 can be implemented as part of the administrative interface 1604 and can be rendered through a web application, desktop application, tablet interface, and/or other administrative computing interface. The administrative interface 1900 can allow an administrative user to create, view, edit, duplicate, publish, and/or restrict campaign, offer, and/or segment records that are later used by the promotional pricing platform 1402 to present customer-facing offers and to generate machine-readable discount eligibility responses for the operational back office 1440.

The administrative interface 1900 includes an administrative dashboard frame 1902 having a navigation sidebar 1904. The navigation sidebar 1904 includes a campaigns navigation control 1906, an offers navigation control 1908, a segments navigation control 1910, and an administrative user control 1912. Selection of the campaigns navigation control 1906 can cause the promotional pricing platform 1402 to retrieve campaign records 1818 from the platform database 1606 and render a campaigns panel 1914. Selection of the offers navigation control 1908 can cause the promotional pricing platform 1402 to retrieve offer records 1816 and render an offers panel 1946. Selection of the segments navigation control 1910 can cause the promotional pricing platform 1402 to retrieve segment records 1814 and render a segments panel 1964. The administrative user control 1912 can be coupled to administrator authentication, authorization, role management, audit logging, and/or session control functions.

The campaigns panel 1914 can include an active tab 1916 and an expired tab 1918. The active tab 1916 can filter the displayed campaign records 1818 to campaigns having a current and/or future publish state, offer window, and/or discount window. The expired tab 1918 can filter the displayed campaign records 1818 to campaigns having an expired publish window, offer window, and/or discount window. In some embodiments, the campaign manager 1452 can compute campaign status dynamically by comparing stored publication times and/or offer validity times with a system clock. In other embodiments, campaign status can be stored as a field in the campaign record 1818 and updated by a scheduled job and/or event processor.

The campaigns panel 1914 includes a campaign table 1920. The campaign table 1920 can include a publish field 1922, a campaign name field 1924, a segment field 1926, a threshold field 1928, a minimum field 1930, a discount field 1932, a discount window field 1934, and/or an action field 1936. The publish field 1922 can display a publication start date, publication start time, publication state, and/or publication status. The campaign name field 1924 can display an internal campaign name and/or customer-facing campaign title. The segment field 1926 can display the segment record 1814 targeted by the campaign record 1818. The threshold field 1928 can identify a threshold type, such as no threshold, trip threshold, spend threshold, monthly cap, and/or subscription condition. The minimum field 1930 can identify a trip count, spend amount, cap amount, and/or other value evaluated by the offer engine 1450. The discount field 1932 can display a discount type and/or discount value. The discount window field 1934 can display a time period during which the discount can be applied to toll transactions. The action field 1936 can display one or more row-level actions for editing, duplicating, archiving, and/or reviewing a campaign.

The campaigns panel 1914 includes a create campaign control 1938. In response to selection of the create campaign control 1938, the campaign manager 1452 can generate a campaign configuration workflow in which the administrative user selects a segment record 1814, selects an offer record 1816, enters campaign content, configures notification variants, configures a publication schedule, configures an offer window, configures valid days and/or valid times, and/or configures redemption limits. When the administrative user saves the campaign configuration, the campaign manager 1452 can validate the selected offer record 1816 and segment record 1814, create a new campaign record 1818, assign a campaign identifier, store the campaign record 1818 in the platform database 1606, and update campaign indexes used by the promotional pricing platform 1402 and/or the analytics platform 1420.

The action field 1936 can include a campaign action menu 1940. The campaign action menu 1940 can include an edit campaign control 1942 and/or a duplicate campaign control 1944. Selection of the edit campaign control 1942 can cause the campaign manager 1452 to retrieve a selected campaign record 1818 and render editable campaign fields according to an administrator permission level and campaign state. Selection of the duplicate campaign control 1944 can cause the campaign manager 1452 to create a new draft campaign record by copying selected fields from an existing campaign record 1818 while assigning a new campaign identifier and a new publication state. Duplicating campaign records can reduce data entry errors and can preserve technical consistency between prior offer parameters and future campaign parameters.

The offers panel 1946 can include an offer table 1948. The offer table 1948 can include an offer name field 1950, an offer threshold type field 1952, an offer threshold minimum field 1954, an offer discount type field 1956, an offer discount amount field 1958, and/or an offer action field. The offer name field 1950 can display a human-readable name assigned to the offer record 1816. The offer threshold type field 1952 and offer threshold minimum field 1954 can display the conditions evaluated before a discount becomes active and/or applicable. The offer discount type field 1956 and offer discount amount field 1958 can display the pricing treatment returned to the operational back office 1440 through the eligibility API 1444. In some embodiments, the offer table 1948 can also display whether the offer record 1816 is a welcome offer, a threshold offer, a cap offer, a subscription offer, and/or a published-campaign offer.

The offers panel 1946 includes a create offer control 1960. Selection of the create offer control 1960 can cause the offer engine 1450 to render an offer configuration modal 1978. The offer configuration modal 1978 can include a threshold type input 1980, a threshold minimum input 1982, a discount type input 1984, a discount amount input 1986, and/or a save offer control 1988. The threshold type input 1980 can receive a selection of no threshold, trip threshold, spend threshold, monthly cap, subscription condition, and/or another offer condition. The threshold minimum input 1982 can receive a numeric value such as a number of trips, a spend value, and/or a cap value. The discount type input 1984 can receive a selection of percentage discount, fixed amount discount, free trip discount, capped billing discount, subscription access discount, and/or another discount type. The discount amount input 1986 can receive a percentage, fixed dollar value, cap amount, and/or subscription value. In response to selection of the save offer control 1988, the offer engine 1450 can validate the selected values, create and/or update the offer record 1816, and store the offer record 1816 in the platform database 1606.

The offers panel 1946 can display a restriction notice 1962 when an offer record 1816 is associated with a published campaign record 1818. The restriction notice 1962 can indicate that a published-campaign offer cannot be changed and/or can be changed only through a restricted administrative operation. In some embodiments, the promotional pricing platform 1402 can enforce the restriction notice 1962 by locking one or more fields of the offer record 1816 after the associated campaign record 1818 is published. In other embodiments, the promotional pricing platform 1402 can create a new version of the offer record 1816 rather than modifying the published version. This versioned configuration can preserve the offer terms that were presented to customers and can allow later eligibility checks to evaluate the same offer parameters that existed when a customer claimed the offer.

The segments panel 1964 can include a segment table 1966. The segment table 1966 can include a segment name field 1968, a tag field 1970, a vehicle count field 1972, and/or a segment action field. The segment name field 1968 can identify a segment record 1814. The tag field 1970 can identify one or more vehicle tag records 1812 and/or customer behavior tags used by a segment rule. The vehicle count field 1972 can display a number of vehicle records 1810 satisfying the segment rule at a time the segment table 1966 is rendered. In some embodiments, the vehicle count field 1972 can be computed by executing the segment rule against an indexed tag table and/or behavior table. In other embodiments, the vehicle count field 1972 can be precomputed by a batch process and updated when tags, vehicle records, and/or segment rules change.

The segments panel 1964 includes a bulk tag control 1974 and a create segment control 1976. Selection of the bulk tag control 1974 can cause the segment manager 1454 to receive a file containing vehicle identifiers and tag values. The segment manager 1454 can parse the file, normalize license plate data, validate license plate state data, check for vehicle record matches, and assign vehicle tag records 1812 to matching vehicle records 1810. Selection of the create segment control 1976 can cause the segment manager 1454 to render a segment configuration modal 1990. The segment configuration modal 1990 can include a segment name input 1992, a segment rule input 1994, and/or a segment tag input 1996. The segment name input 1992 can receive a segment name. The segment rule input 1994 can receive a logical operator and/or condition, such as has tag, lacks tag, inactive for a selected time period, spend above a selected value, trip count above a selected value, and/or offer response condition. The segment tag input 1996 can receive a tag value and/or behavior attribute. The segment manager 1454 can validate the segment configuration and create a segment record 1814 that can be selected by the campaign manager 1452 during campaign creation.

The administrative interface 1900 can enforce technical consistency between segment records 1814, offer records 1816, and campaign records 1818. For example, the campaign manager 1452 can prevent publication of a campaign record 1818 unless the campaign record 1818 is coupled to a valid segment record 1814 and a valid offer record 1816. The offer engine 1450 can prevent creation of an offer record 1816 having an invalid combination of threshold type and discount type. The segment manager 1454 can prevent creation of a segment record 1814 having a missing tag value, nonunique segment name, and/or rule that cannot be evaluated against the customer/vehicle database 1456. These validation operations can reduce malformed discount eligibility records before they are exposed to the operational back office 1440.

In some embodiments, the administrative interface 1900 can generate schema-validated configuration records. When an administrative user saves an offer, segment, and/or campaign, the promotional pricing platform 1402 can validate the entered data against a configuration schema. The configuration schema can specify permitted field types, permitted value ranges, date and time relationships, allowed threshold-discount combinations, required associations, and/or permitted publication states. The promotional pricing platform 1402 can reject configuration records that fail schema validation and can display a validation message through the administrative interface 1900. This schema-based validation can improve the reliability of downstream eligibility processing because the operational back office 1440 receives discount eligibility responses derived from validated configuration records.

In some embodiments, the administrative interface 1900 can use role-based access control to determine which controls are presented to an administrative user. For example, a first administrative role can view campaigns and performance data but cannot publish campaigns. A second administrative role can create draft offers and segments but cannot edit published campaigns. A third administrative role can approve and publish campaigns. The administrative user control 1912 can be coupled to an identity and access management system that provides administrator role data to the promotional pricing platform 1402. The promotional pricing platform 1402 can use the administrator role data to enable, disable, hide, or lock controls such as the create campaign control 1938, the edit campaign control 1942, the create offer control 1960, the bulk tag control 1974, and/or the create segment control 1976.

The administrative interface 1900 can also maintain audit records for administrative actions. For example, the promotional pricing platform 1402 can store an audit event when an administrator creates an offer record 1816, edits an offer record 1816, creates a segment record 1814, bulk-tags vehicles, creates a campaign record 1818, duplicates a campaign record 1818, edits a campaign record 1818, publishes a campaign record 1818, and/or expires a campaign record 1818. The audit event can include an administrator identifier, a timestamp, an affected record identifier, a previous value, a new value, a source device identifier, and/or a reason code. Audit records can support later reconciliation of customer-facing offer terms, back-office eligibility rules, and support inquiries.

Once a campaign record 1818 is published through the administrative interface 1900, the promotional pricing platform 1402 can generate a campaign publication output 1938. The campaign publication output 1998 can include one or more customer communication events for the customer communication service 1426 and one or more discount eligibility rules for the operational back office 1440. The customer communication events can identify target customers and/or vehicles, message variants, communication channels, and/or send times. The discount eligibility rules can identify the offer identifier, campaign identifier, valid period, valid days, valid times, threshold rule, discount type, discount value, redemption limit, and/or eligible vehicle identifiers. By deriving customer communications and back-office eligibility rules from the same stored campaign record 1818, the promotional pricing platform 1402 can maintain consistency between what is presented to customers and what is applied during toll rating.

The administrative interface 1900 can provide a technical improvement to the promotional pricing platform 1402 by converting administrator-entered promotional concepts into validated, versioned, and machine-readable records that can be used by distributed systems. The campaign table 1920, offer table 1948, and segment table 1966 provide controlled views into related configuration records, while the create and edit controls cause the promotional pricing platform 1402 to enforce associations, schemas, status transitions, and/or version locks. This reduces the likelihood that customer communications, offer progress displays, and toll discount eligibility responses become inconsistent across the customer devices 1404, customer communication service 1426, promotional pricing platform 1402, and operational back office 1440.

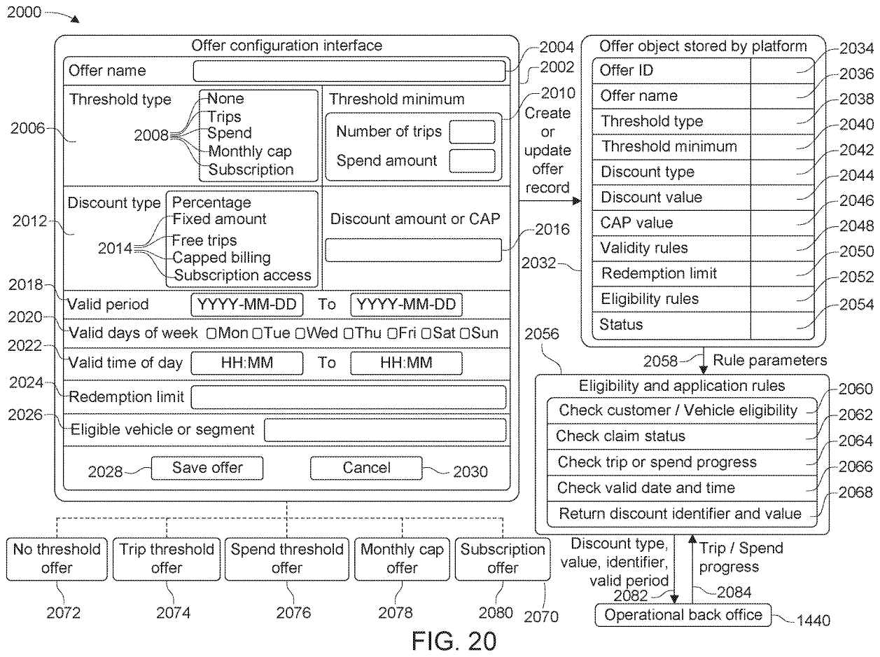

FIG. 20 shows one embodiment of an offer configuration architecture 2000 configured to convert administrator-entered offer parameters into a stored offer object and into executable eligibility rules usable by the promotional pricing platform 1402 and the operational back office 1440. The offer configuration architecture 2000 can be implemented using the offer engine 1450, the campaign manager 1452, the segment manager 1454, the platform database 1606, and/or the API gateway 1460. The offer configuration architecture 2000 can be used to create and update offer records 1816 that are later coupled to campaign records 1818 and claimed-offer records 1820.

The offer configuration architecture 2000 includes an offer configuration interface 2002. The offer configuration interface 2002 can be rendered as part of the administrative interface 1604 and/or the administrative interface 1900. The offer configuration interface 2002 can include an offer name input 2004, a threshold type input 2006, threshold type options 2008, a threshold minimum input 2010, a discount type input 2012, discount type options 2014, a discount amount or cap input 2016, a valid period input 2018, a valid days input 2020, a valid time input 2022, a redemption limit input 2024, an eligible vehicle or segment input 2026, a save offer control 2028, and/or a cancel control 2030.

The threshold type input 2006 can receive a selection from the threshold type options 2008. The threshold type options 2008 can include no threshold, trip threshold, spend threshold, monthly cap, subscription, and/or other threshold conditions. When the threshold type input 2006 receives a no-threshold selection, the offer engine 1450 can deactivate, hide, or ignore the threshold minimum input 2010. When the threshold type input 2006 receives a trip-threshold selection, the offer engine 1450 can configure the threshold minimum input 2010 to receive a trip count. When the threshold type input 2006 receives a spend-threshold or monthly-cap selection, the offer engine 1450 can configure the threshold minimum input 2010 to receive a currency amount. When the threshold type input 2006 receives a subscription selection, the offer engine 1450 can configure the threshold minimum input 2010 to receive a subscription period, subscription tier, subscription charge, and/or subscription usage parameter.

The discount type input 2012 can receive a selection from the discount type options 2014. The discount type options 2014 can include a percentage discount, fixed amount discount, free trip discount, capped billing discount, subscription access discount, and/or another discount type. The offer engine 1450 can dynamically configure the discount amount or cap input 2016 based on the selected discount type. For example, when the discount type input 2012 receives a percentage discount selection, the discount amount or cap input 2016 can receive a percentage value. When the discount type input 2012 receives a fixed amount discount selection, the discount amount or cap input 2016 can receive a currency value. When the discount type input 2012 receives a capped billing selection, the discount amount or cap input 2016 can receive a cap value for a selected time period. When the discount type input 2012 receives a subscription access selection, the discount amount or cap input 2016 can receive a subscription value, covered trip parameter, covered spend parameter, and/or access period.

The valid period input 2018 can define a start date, start time, end date, and/or end time for the offer. The valid days input 2020 can define one or more days of the week on which the offer can be claimed, progressed, redeemed, and/or applied. The valid time input 2022 can define a time-of-day window, such as a peak-period window, off-peak window, rush-hour window, all-day window, and/or custom time window. The redemption limit input 2024 can define a number of times the offer can be claimed, redeemed, applied to trips, applied per vehicle, applied per account, and/or applied during a billing period. The eligible vehicle or segment input 2026 can receive a vehicle identifier, customer identifier, segment identifier, tag identifier, roadway identifier, facility identifier, and/or campaign eligibility value.

In response to selection of the save offer control 2028, the offer engine 1450 can generate a candidate offer object 2032. The candidate offer object 2032 can be stored as, or converted into, an offer record 1816. The offer object 2032 can include an offer identifier field 2034, an offer name field 2036, a threshold type field 2038, a threshold minimum field 2040, a discount type field 2042, a discount value field 2044, a cap value field 2046, a validity rule field 2048, a redemption limit field 2050, an eligibility rule field 2052, and/or a status field 2054. The offer identifier field 2034 can store a unique offer identifier generated by the promotional pricing platform 1402. The validity rule field 2048 can encode the valid period input 2018, valid days input 2020, and/or valid time input 2022 into a machine-readable rule. The eligibility rule field 2052 can encode the eligible vehicle or segment input 2026 and can be evaluated by the eligibility API 1444 during toll transaction rating.

The offer engine 1450 can validate the candidate offer object 2032 before storing the candidate offer object 2032 in the platform database 1606. The validation can include checking that numeric values have permitted data types, checking that dates and times form a valid time window, checking that selected threshold types and discount types are compatible, checking that a percentage value is within a permitted range, checking that a currency value has a permitted format, checking that a redemption limit is nonnegative, checking that an eligibility rule references an existing segment record 1814 and/or vehicle record 1810, and/or checking that the offer name is unique within a roadway program. If validation fails, the offer engine 1450 can return a validation response to the offer configuration interface 2002 and can prevent storage of the candidate offer object 2032 until the validation response is resolved.

In some embodiments, the offer engine 1450 can generate a version identifier, configuration hash, and/or effective timestamp for the offer object 2032. The version identifier can allow a claimed-offer record 1820 to reference the version of the offer object 2032 that was active when the customer claimed the offer. The configuration hash can allow the promotional pricing platform 1402 to detect whether an offer configuration was changed after publication. The effective timestamp can allow the eligibility and application rules module 2056 to evaluate a toll transaction using the offer parameters that were effective when the toll transaction occurred.

The offer configuration architecture 2000 includes an eligibility and application rules module 2056. The eligibility and application rules module 2056 can be implemented by the offer engine 1450, the API gateway 1460, and/or a rules service coupled to the promotional pricing platform 1402. The eligibility and application rules module 2056 can receive rule parameters from the offer object 2032 through a rule parameter data path 2058. The rule parameters can include threshold type, threshold minimum, discount type, discount value, cap value, validity rules, redemption limits, segment rules, vehicle eligibility rules, campaign identifiers, and/or offer status values.

The eligibility and application rules module 2056 can execute a customer and/or vehicle eligibility check 2060, a claim status check 2062, a trip or spend progress check 2064, a valid date and time check 2066, and/or a discount response generation operation 2068. The customer and/or vehicle eligibility check 2060 can determine whether a license plate number, license plate state, transponder identifier, vehicle identifier, customer account identifier, tag value, and/or segment membership value matches the eligibility rule field 2052. The claim status check 2062 can determine whether a claimed-offer record 1820 exists for the customer account and/or vehicle record 1810 and whether the claimed-offer record 1820 is active, expired, replaced, redeemed, or otherwise unavailable. The trip or spend progress check 2064 can determine whether a trip counter, spend accumulator, monthly cap accumulator, subscription status, and/or other progress value satisfies the threshold minimum field 2040. The valid date and time check 2066 can compare a toll transaction time, local facility time, day of week, and/or rating time against the validity rule field 2048. The discount response generation operation 2068 can generate a machine-readable eligibility response containing a discount identifier, discount type, discount value, cap value, valid period, redemption limit, and/or response status.

The offer configuration architecture 2000 can include offer templates 2070 that are coupled to the offer configuration interface 2002 and/or the eligibility and application rules module 2056. The offer templates 2070 can include a no-threshold offer template 2072, a trip-threshold offer template 2074, a spend-threshold offer template 2076, a monthly-cap offer template 2078, and/or a subscription offer template 2080. The no-threshold offer template 2072 can generate an offer that becomes eligible after claim and satisfaction of validity rules. The trip-threshold offer template 2074 can generate an offer that becomes eligible after a selected number of qualifying trips. The spend-threshold offer template 2076 can generate an offer that becomes eligible after a selected amount of toll spend. The monthly-cap offer template 2078 can generate an offer in which toll charges for a customer, vehicle, and/or account are capped during a selected period. The subscription offer template 2080 can generate an offer in which a customer obtains access to a pricing treatment during a subscription period.

The offer templates 2070 can reduce configuration errors by pre-populating compatible combinations of threshold types, discount types, progress metrics, accumulator fields, and/or back-office response fields. For example, when an administrative user selects the monthly-cap offer template 2078, the offer engine 1450 can automatically configure the threshold type field 2038 to a spend accumulator, configure the cap value field 2046, configure the validity rule field 2048 to a monthly period, and configure the discount response generation operation 2068 to return a capped billing response after the cap is reached. When an administrative user selects the trip-threshold offer template 2074, the offer engine 1450 can configure the progress metric used by the trip or spend progress check 2064 to a qualifying-trip counter.

The eligibility and application rules module 2056 can be coupled to the operational back office 1440 through a discount parameter data path 2082 and a progress data path 2084. The discount parameter data path 2082 can transmit discount type, discount value, discount identifier, cap value, valid period, and/or redemption limit data to the operational back office 1440 through the eligibility API 1444. The progress data path 2084 can transmit trip data, spend data, toll transaction data, original amount data, final amount data, and/or discount application data from the operational back office 1440 to the promotional pricing platform 1402 through the trips API 1442 and/or another interface. The promotional pricing platform 1402 can use the progress data path 2084 to update the claimed-offer record 1820 and to update savings records 1826.

In one example of a trip-threshold offer, the offer configuration interface 2002 receives a trip-threshold selection through the threshold type input 2006, a ten-trip value through the threshold minimum input 2010, a percentage discount selection through the discount type input 2012, and a one-hundred-percent value through the discount amount or cap input 2016. The offer engine 1450 validates the values, stores the offer object 2032, and configures the eligibility and application rules module 2056 to count qualifying trips received through the trips API 1442. When the progress value in the claimed-offer record 1820 reaches ten qualifying trips, the eligibility and application rules module 2056 can return a one-hundred-percent discount response to the operational back office 1440 for eligible toll transactions occurring during the valid period.

In one example of a spend-threshold offer, the offer configuration interface 2002 receives a spend-threshold selection and a spend amount through the threshold minimum input 2010. The eligibility and application rules module 2056 can maintain a spend accumulator using original trip amount data and/or final trip amount data received from the operational back office 1440. Once the spend accumulator satisfies the threshold minimum field 2040, the eligibility and application rules module 2056 can return a discount response for subsequent eligible trips. The spend accumulator can be reset at the end of a campaign period, billing period, calendar month, and/or another period defined by the validity rule field 2048.

In one example of a monthly-cap offer, the offer configuration interface 2002 receives a monthly cap threshold type and a cap value through the discount amount or cap input 2016. The eligibility and application rules module 2056 can maintain a period-based charge accumulator for a customer account, vehicle record 1810, and/or group of vehicles. Before the cap value is reached, the operational back office 1440 can apply normal toll pricing. After the charge accumulator reaches the cap value, the eligibility and application rules module 2056 can return a capped billing response, zero-price response, reduced-price response, fixed-price response, and/or other pricing response for remaining eligible toll trips during the period. At the end of the period, the promotional pricing platform 1402 can reset the charge accumulator and begin a new cap period.

In one example of a subscription offer, the offer configuration interface 2002 receives a subscription selection and subscription parameters. The subscription parameters can include a subscription price, subscription period, covered facility, covered vehicle set, covered trip count, covered time window, and/or covered discount value. The eligibility and application rules module 2056 can verify whether the customer account record 1802 and/or vehicle record 1810 has an active subscription status. When the subscription status is active and the toll transaction satisfies validity rules, the eligibility and application rules module 2056 can return a subscription-based discount response to the operational back office 1440. The promotional pricing platform 1402 can update usage counts and/or savings records as covered toll trips are processed.

The offer configuration architecture 2000 can support publication controls and immutability controls. After an offer object 2032 is associated with a published campaign record 1818, the offer engine 1450 can lock selected fields, generate a new version for future edits, and/or preserve the published offer version for existing claimed-offer records 1820. This can prevent a later administrative edit from changing the discount terms used by an active claimed-offer record 1820. The campaign manager 1452 can reference the locked offer version when generating customer messages and the eligibility and application rules module 2056 can reference the same locked offer version when responding to the operational back office 1440.

The offer configuration architecture 2000 can also support simulation before publication. The offer engine 1450 and/or promotion analytics module 1424 can evaluate the candidate offer object 2032 against historical trip data, vehicle data, and/or segment membership data to estimate eligible vehicle count, expected claim count, expected discount cost, expected incremental trips, expected roadway usage, and/or expected revenue impact. The administrative interface 1604 can display the simulation output before the save offer control 2028 or a campaign publication control is selected. This simulation can reduce malformed campaigns and can help align the offer object 2032 with roadway service-level objectives.

The offer configuration architecture 2000 can provide technical improvements by compiling user-entered promotional parameters into validated, versioned, and machine-readable eligibility rules that can be evaluated automatically during toll transaction rating. The same stored offer object 2032 can drive customer-facing offer displays, claimed-offer progress calculations, eligibility API responses, discount records, and savings calculations. This common source of offer configuration data can reduce discrepancies among the administrative interface 1604, customer devices 1404, operational back office 1440, and analytics platform 1420. The eligibility and application rules module 2056 can further improve system operation by evaluating customer, vehicle, claim, progress, and validity conditions at transaction-rating time and returning a structured discount response without manual intervention.

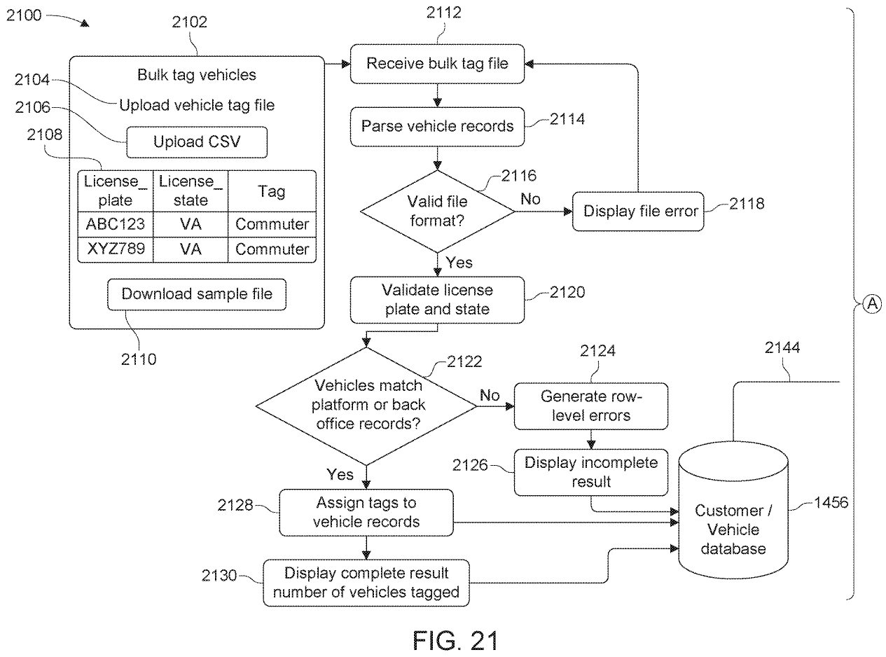

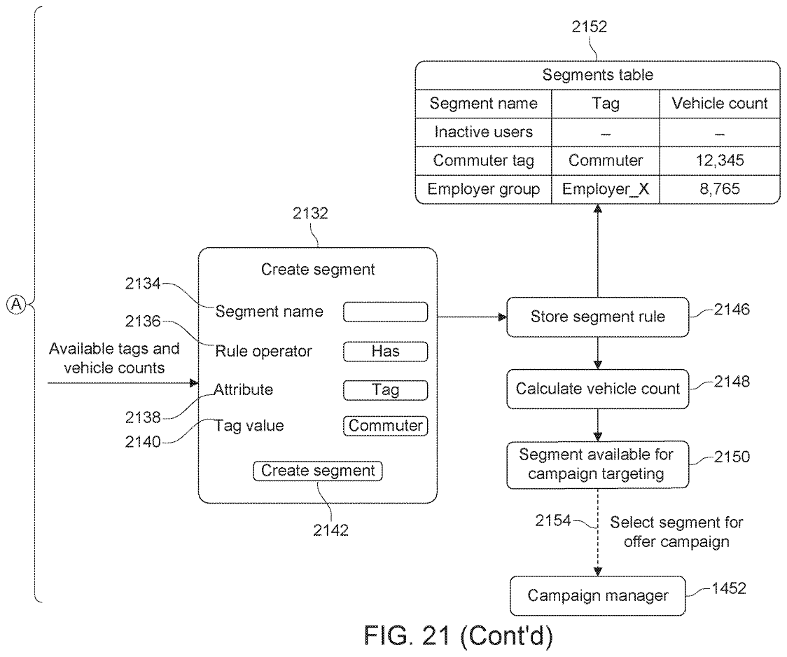

FIG. 21 shows one embodiment of a segment creation and bulk vehicle tagging process 2100 executable by the promotional pricing platform 1402. The process 2100 can be implemented through the administrative interface 1604 and/or the administrative interface 1900 and can allow an administrative user to associate large groups of vehicle records 1810 with one or more vehicle tag records 1812. The vehicle tag records 1812 can then be used by the segment manager 1454 to create segment records 1814 that are selectable by the campaign manager 1452 for promotional offer targeting.

The process 2100 includes a bulk tag vehicles interface 2102. The bulk tag vehicles interface 2102 can be rendered in response to selection of the bulk tag control 1974 shown in FIG. 19. The bulk tag vehicles interface 2102 can include an upload instruction 2104, an upload file control 2106, a sample file display 2108, and a download sample file control 2110. The upload instruction 2104 can prompt an administrative user to upload a vehicle tag file. The upload file control 2106 can receive a file, such as a comma-separated values (CSV) file, tab-separated values file, spreadsheet file, JavaScript Object Notation (JSON) file, extensible markup language (XML) file, and/or another structured data file. The sample file display 2108 can display a template including fields such as license plate, license state, tag, and/or other vehicle matching values. The download sample file control 2110 can provide a template file having a schema accepted by the segment manager 1454.

The vehicle tag file can include multiple vehicle tag rows. Each vehicle tag row can include a license plate value, a license state value, a tag value, a tag source value, an expiration value, and/or a campaign or segment identifier. In some embodiments, each vehicle tag row can include a transponder identifier, a customer account identifier, a vehicle identifier, an employer group value, a geographic value, a roadway facility value, a customer acquisition source value, and/or a behavior classification. The segment manager 1454 can use the vehicle tag file to update the customer/vehicle database 1456 without individually editing each vehicle record 1810 through the administrative interface 1900.

At block 2112, the promotional pricing platform 1402 receives the vehicle tag file from the bulk tag vehicles interface 2102. The received file can be stored temporarily in a staging location, memory buffer, object store, temporary database table, and/or queue. The promotional pricing platform 1402 can generate an upload identifier and associate the upload identifier with an administrative user identifier, upload timestamp, file name, file hash, file size, roadway program identifier, and/or processing status. The file hash can be used to detect duplicate uploads and can allow the promotional pricing platform 1402 to avoid processing the same file multiple times.

At block 2114, the segment manager 1454 parses vehicle records from the received vehicle tag file. The parsing operation can identify column headers, detect delimiter type, decode character encoding, trim blank spaces, normalize line endings, and/or convert each row into a structured vehicle tag input record. The structured vehicle tag input record can include normalized fields such as normalized license plate, normalized license state, normalized tag value, row number, and/or source file identifier. The normalized license plate can be generated by removing spaces, punctuation, and/or special characters and converting alphabetic characters to a common case. The normalized license plate and normalized license state can be stored together because a plate value can be reused across different states and/or jurisdictions.

At decision block 2116, the segment manager 1454 determines whether the received vehicle tag file has a valid file format. The format validation can include checking that expected headers are present, checking that each row has a permitted number of fields, checking that plate and state fields are populated, checking that tag values satisfy a permitted character set, checking that the file size is within an accepted range, and/or checking that row count is within an accepted range. If the file format is not valid, the segment manager 1454 can display a file error at block 2118. The file error can identify missing columns, invalid delimiter, invalid encoding, empty file, excess row count, and/or another file-level validation condition. The process 2100 can then return to block 2112 so that a corrected file can be received.

If the file format is valid, the segment manager 1454 validates license plate and state data at block 2120. The validation can include verifying that license plate values satisfy jurisdiction-specific length and character rules, verifying that license state values correspond to known state or jurisdiction codes, removing duplicate rows, detecting conflicting tag assignments, and/or comparing uploaded plate and state combinations against active vehicle records 1810. In some embodiments, the segment manager 1454 can validate transponder identifiers, vehicle identifiers, and/or customer account identifiers when such identifiers are included in the vehicle tag file.

At decision block 2122, the segment manager 1454 determines whether vehicles identified in the vehicle tag file match platform records and/or back-office records. The segment manager 1454 can query the customer/vehicle database 1456 using a normalized license plate and license state index, a transponder index, and/or a vehicle identifier index. In some embodiments, the segment manager 1454 can query the operational back office 1440 and/or a synchronized back-office vehicle table to determine whether an uploaded vehicle corresponds to a tolling record, a transponder account, an ALPR account, and/or another tolling-system identifier. The matching operation can return a matched vehicle identifier, matched account identifier, match confidence value, and/or match status for each uploaded row.

If one or more uploaded rows cannot be matched or cannot be validated, the segment manager 1454 can generate row-level error data at block 2124. The row-level error data, which can also be referred to as row-level errors, can identify a row number, plate value, state value, tag value, error type, and/or corrective action. The row-level error data can be stored in association with the upload identifier in the platform database 1606, exposed through the bulk tag vehicles interface 2102 so that an administrative user can review and remediate the failed rows, and/or transmitted to the analytics platform 1420 to track validation patterns over time. Example row-level errors can include unmatched plate and state, duplicate plate entry, invalid state, invalid tag value, already assigned tag, conflicting tag, inactive vehicle, and/or vehicle associated with another roadway program.

If the uploaded rows match vehicle records and pass validation, the segment manager 1454 assigns tags to vehicle records at block 2128. The assignment can create and/or update vehicle tag records 1812 coupled to the corresponding vehicle records 1810. Each vehicle tag record 1812 can include a vehicle identifier, tag identifier, tag name, tag source, upload identifier, created timestamp, expiration timestamp, administrator identifier, roadway program identifier, and/or tag status. In some embodiments, the segment manager 1454 can store the tag assignment as an event rather than overwriting a prior value. Event-based tag assignment can allow the promotional pricing platform 1402 to reconstruct which vehicles had a particular tag at a previous campaign publication time.

At block 2130, the promotional pricing platform 1402 displays a complete result. The complete result can identify a number of vehicles successfully tagged, a number of vehicle tag records 1812 created, a number of existing vehicle tag records 1812 updated, and/or a number of duplicate rows ignored. The complete result can also provide a link to an audit record, updated segment table, and/or updated vehicle count. The segment manager 1454 can store the processing result in the platform database 1606 so that the uploaded file, validation result, and tag assignment result can be reviewed by an administrative user and/or support personnel.

The process 2100 also includes a create segment interface 2132. The create segment interface 2132 can be rendered in response to selection of the create segment control 1976 shown in FIG. 19. The create segment interface 2132 can include a segment name input 2134, a rule operator input 2136, an attribute input 2138, a tag value input 2140, and a create segment control 2142. The segment name input 2134 can receive a name for a segment record 1814. The rule operator input 2136 can receive a logical operator such as has, lacks, equals, not equals, greater than, less than, within, outside, and/or another operator. The attribute input 2138 can receive an attribute such as tag, inactivity period, trip count, spend amount, offer claim status, offer redemption status, vehicle type, employer group, acquisition source, and/or notification preference. The tag value input 2140 can receive a tag value or other attribute value used by the segment rule.

The customer/vehicle database 1456 can provide available tag and vehicle count data to the create segment interface 2132 through an available tag data path 2144. The available tag and vehicle count data can include known tag values, tag sources, active tag counts, expired tag counts, and/or a number of vehicles that currently satisfy a selected rule. The segment manager 1454 can update this information in response to changes in the rule operator input 2136, attribute input 2138, and/or tag value input 2140. This can allow an administrative user to understand the size of a proposed segment before the segment record 1814 is saved.

In response to selection of the create segment control 2142, the segment manager 1454 stores a segment rule at block 2146. The segment rule can be stored as part of a segment record 1814 and can include a segment identifier, segment name, rule expression, selected operator, selected attribute, selected tag value, roadway program identifier, creator identifier, creation timestamp, and/or status. The rule expression can be stored in a structured format, such as JSON, a database query expression, a rules-engine expression, and/or another machine-readable format. Storing the rule expression in a structured format allows the promotional pricing platform 1402 to evaluate segment membership consistently during campaign creation, campaign publication, and campaign execution.

At block 2148, the segment manager 1454 calculates a vehicle count for the segment rule. The vehicle count calculation can evaluate the segment rule against the customer/vehicle database 1456 and can count active vehicle records 1810 that satisfy the rule. In some embodiments, the segment manager 1454 can store the calculated vehicle count in the segment record 1814. In other embodiments, the vehicle count can be calculated dynamically when the segments panel 1964 is rendered. The vehicle count can be recalculated after a bulk tag upload, after vehicle records 1810 are added or removed, after tag expirations, and/or after trip behavior changes cause vehicles to enter or leave behavior-based segments.

At block 2150, the segment manager 1454 makes the segment available for campaign targeting. Once available, the campaign manager 1452 can display the segment record 1814 in a segment selection control during campaign creation and/or campaign editing. The segment record 1814 can be used to identify customer accounts and/or vehicles that are eligible to receive a campaign communication, claim an offer, and/or receive a discount eligibility response. In some embodiments, segment availability can depend on administrator approval, minimum vehicle count, maximum vehicle count, roadway program permissions, and/or publication status.

The process 2100 includes a segments table 2152. The segments table 2152 can display segment records 1814 created by the segment manager 1454. The segments table 2152 can include columns such as segment name, tag, rule, vehicle count, creation date, status, and/or actions. The segments table 2152 can be updated after tags are assigned at block 2128 and/or after a segment rule is stored at block 2146. In some embodiments, the segments table 2152 can include behavior-based segments created from analytics output and tag-based segments created from uploaded vehicle tag files.

The segment available for campaign targeting block 2150 can be coupled to the campaign manager 1452 through a segment selection data path 2154. The segment selection data path 2154 can allow the campaign manager 1452 to retrieve a list of active segment records 1814 and associated vehicle counts for selection in a campaign record 1818. When a campaign record 1818 is published, the campaign manager 1452 can evaluate the selected segment rule to generate a target set of customer accounts and/or vehicle records 1810. The target set can be provided to the customer communication service 1426 for message delivery and/or to the eligibility and application rules module 2056 for discount eligibility evaluation.

In some embodiments, the segment manager 1454 can create immutable segment snapshots at campaign publication time. A segment snapshot can store the list of vehicle identifiers and/or customer account identifiers that satisfied a segment record 1814 when the campaign record 1818 was published. The segment snapshot can be used to determine which customers were eligible for a campaign even if the underlying tags or vehicle behavior later change. In other embodiments, the campaign manager 1452 can evaluate segment membership dynamically at claim time and/or eligibility check time. The promotional pricing platform 1402 can store a segment evaluation mode in the campaign record 1818 so that the targeting behavior is reproducible and auditable.

In some embodiments, the process 2100 can use staged processing to improve reliability. For example, the segment manager 1454 can first store parsed rows in a staging table, validate each row, generate a proposed tag assignment table, and then commit the proposed tag assignments to the customer/vehicle database 1456 in a transaction. If an error occurs during the commit operation, the segment manager 1454 can roll back the proposed tag assignments so that a partially applied upload does not leave inconsistent vehicle tag records 1812. For large files, the segment manager 1454 can process rows in batches and store batch completion status so that processing can resume after a network interruption and/or server restart.

The process 2100 can also support asynchronous processing. After the vehicle tag file is received at block 2112, the promotional pricing platform 1402 can enqueue a bulk tag job and return a processing status to the administrative interface 1604. A background worker can parse, validate, match, and apply vehicle tags while periodically updating job status. The administrative interface 1604 can poll the job status or receive event notifications and can display a progress indicator, incomplete result, or complete result. Asynchronous processing can improve responsiveness of the administrative interface 1604 when thousands or millions of vehicle records are processed.

The process 2100 can include audit and access controls. The promotional pricing platform 1402 can store audit events identifying who uploaded a file, when the file was uploaded, which vehicle records 1810 were tagged, which tag values were applied, which rows failed validation, and which segment records 1814 were created. The segment manager 1454 can also determine whether an administrative user has permission to upload vehicle tag files, assign particular tag values, create segments, and/or make segments available for campaign targeting. These controls can reduce accidental or unauthorized changes to discount targeting records.

The process 2100 can provide technical improvements to the promotional pricing platform 1402 by converting batch vehicle identifier data into validated vehicle tag records 1812 and executable segment records 1814. Rather than relying on manual selection of individual vehicles, the segment manager 1454 can normalize uploaded identifiers, match the identifiers to stored vehicle records 1810 and/or tolling records, generate row-level error data, apply tags transactionally, and expose the resulting segments to the campaign manager 1452. This improves scalability and data consistency when campaign targeting depends on large vehicle populations, historical behavior classifications, employer groups, inactivity groups, and/or other dynamically changing vehicle sets.

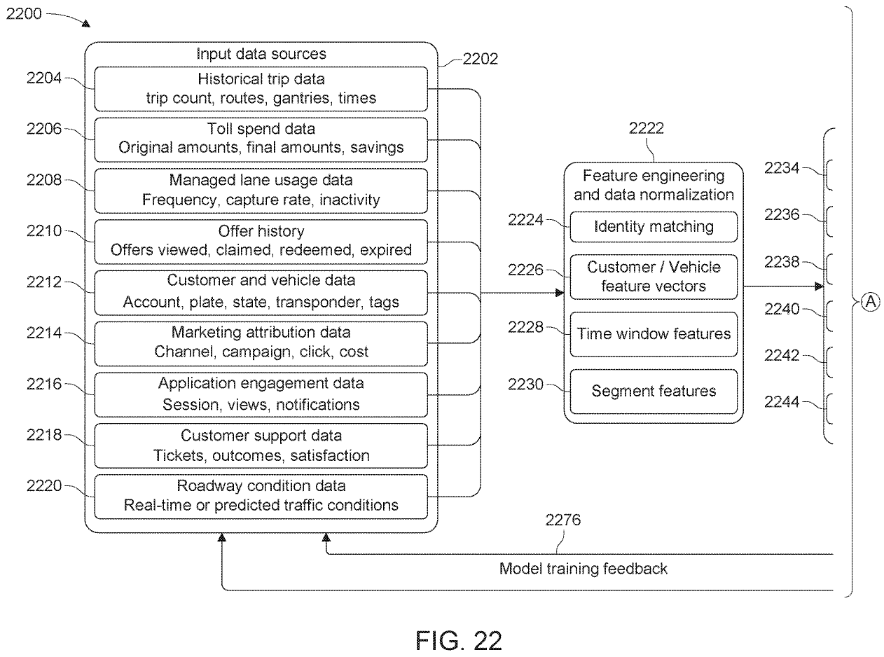

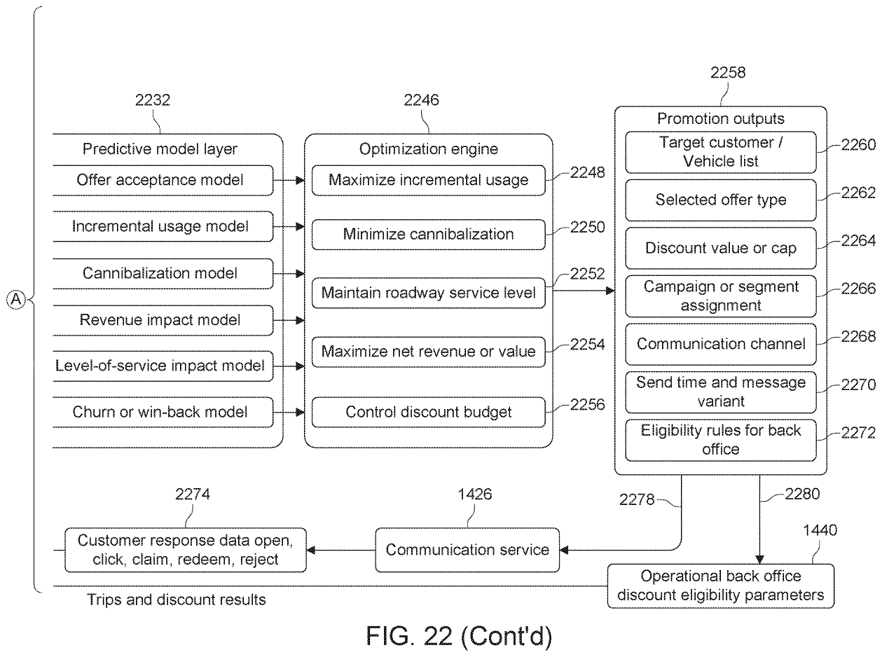

FIG. 22 shows one embodiment of a personalized offer generation and optimization system 2200 configured to generate promotional offer outputs using tolling data, customer engagement data, customer support data, roadway condition data, and/or back-office transaction data. The system 2200 can be implemented by the promotional pricing platform 1402, the analytics platform 1420, the data storage module 1422, the promotion analytics module 1424, and/or one or more cloud computing components of the cloud computing environment 200. The system 2200 can generate customer-specific, vehicle-specific, segment-specific, roadway-specific, and/or time-window-specific promotional offer records that can be administered through the offer engine 1450, campaign manager 1452, segment manager 1454, customer communication service 1426, and operational back office 1440.

The system 2200 includes input data sources 2202. The input data sources 2202 can include historical trip data 2204, toll spend data 2206, managed lane usage data 2208, offer history data 2210, customer and vehicle data 2212, marketing attribution data 2214, application engagement data 2216, customer support data 2218, and/or roadway condition data 2220. The input data sources 2202 can be stored in the data storage module 1422 and/or retrieved from external systems through batch transfers, streaming events, API calls, files, database views, and/or message queues.

The historical trip data 2204 can include trip identifiers, entry gantries, exit gantries, entry times, exit times, trip durations, trip routes, lane identifiers, roadway facility identifiers, vehicle identifiers, transponder identifiers, license plate identifiers, and/or trip status values. In some embodiments, the historical trip data 2204 can be received from the operational back office 1440 through the trips API 1442 and/or from the roadway tolling systems 1430. The historical trip data 2204 can be used to determine trip frequency, time-of-day travel patterns, day-of-week travel patterns, roadway segment usage, managed lane usage, non-managed lane usage, and/or route consistency for a customer account and/or vehicle record 1810.

The toll spend data 2206 can include original toll amounts, final toll amounts, discounts applied, billed amounts, refunded amounts, cap amounts, subscription amounts, and/or savings values. The toll spend data 2206 can be derived from trip records 1822, discount records 1824, savings records 1826, and/or rating and billing data generated by the operational back office 1440. The toll spend data 2206 can be used to generate spend accumulators, average toll values, monthly spend values, peak-period spend values, discount sensitivity features, and/or cap eligibility features.

The managed lane usage data 2208 can include managed lane trip frequency, general-purpose lane trip frequency, managed lane capture rate, managed lane acceptance history, managed lane rejection history, inactivity duration, reactivation history, time saved, toll paid, and/or predicted travel time difference. In some embodiments, the managed lane usage data 2208 can be generated using data from the future traffic conditions prediction server 1110, the toll setting server 1116, the ATMS and back office systems 1118, and/or the promotional pricing platform 1402. The managed lane usage data 2208 can indicate whether a promotional offer is likely to create incremental managed lane usage or merely discount travel that would have occurred without the offer.

The offer history data 2210 can include offers viewed, offers claimed, offers rejected, offers replaced, offers expired, threshold progress values, threshold completion events, redeemed offers, discount applications, and/or historical offer parameters. The offer history data 2210 can be derived from offer records 1816, campaign records 1818, claimed-offer records 1820, discount records 1824, and/or message variant records 1828. The offer history data 2210 can be used to calculate responsiveness to specific offer types, discount values, threshold structures, monthly cap structures, subscription structures, validity windows, and/or message variants.

The customer and vehicle data 2212 can include customer account identifiers, customer profile attributes, notification preferences, enrollment dates, license plate numbers, license plate states, vehicle nicknames, optional transponder identifiers, tag sets, vehicle statuses, segment memberships, and/or concession or roadway identifiers. The customer and vehicle data 2212 can be stored in the customer/vehicle database 1456 and/or the platform database 1606. In some embodiments, the customer and vehicle data 2212 can be normalized so that license plate numbers, transponder identifiers, customer identifiers, and/or vehicle identifiers can be joined to trip records, offer records, support records, and/or message engagement records.

The marketing attribution data 2214 can include campaign identifiers, channel identifiers, click identifiers, creative identifiers, placement identifiers, impression counts, click counts, acquisition costs, landing page events, source identifiers, and/or conversion events. The marketing attribution data 2214 can be received from the paid media and/or marketing systems 1418 and used to determine which acquisition channels produce customers that respond to specific offer structures, maintain higher managed lane usage, and/or generate lower support burden.

The application engagement data 2216 can include application session events, screen views, offer card views, offer detail views, claim button selections, vehicle addition events, transponder addition events, savings dashboard views, transaction detail views, notification preference changes, menu interactions, and/or account management events. The application engagement data 2216 can be received from the product analytics service 1428. The application engagement data 2216 can be used to determine whether a customer is actively engaging with available offers, ignoring messages, abandoning the claim flow, changing notification preferences, and/or reviewing savings after discounts are applied.

The customer support data 2218 can include support ticket identifiers, ticket categories, ticket statuses, support channels, conversation transcripts, response times, resolution times, reopened-ticket indicators, satisfaction scores, and/or support outcomes. The customer support data 2218 can be received from the customer support service 1448. The customer support data 2218 can be used to reduce repeated delivery of offers that cause confusion, identify customers requiring additional explanation, detect discount application issues, and/or adjust offer wording and message timing.

The roadway condition data 2220 can include real-time traffic data, predicted traffic data, managed lane density, general-purpose lane density, non-managed lane density, travel time savings, predicted travel time savings, toll prices, level-of-service indicators, roadway service level, predicted roadway service level, incident data, weather data, special event data, ramp metering status, and/or roadway segment data. As used herein, “general-purpose lane density” and “non-managed lane density” refer to a vehicle density measurement for one or more lanes that are not actively managed for promotional or tolling restrictions, and the terms are used interchangeably. Similarly, “level-of-service indicator,” “roadway service level,” and “predicted roadway service level” refer to a measure of roadway performance, with “predicted roadway service level” referring to a level-of-service value generated by the future traffic conditions prediction server 1110 for a future time window.

The system 2200 includes a feature engineering and data normalization module 2222 coupled to the input data sources 2202. The feature engineering and data normalization module 2222 can clean, normalize, encode, aggregate, and/or join input data from different systems. For example, the feature engineering and data normalization module 2222 can convert timestamps to a facility-local time zone, map gantry identifiers to roadway segments, normalize license plate values, normalize transponder identifiers, map campaign identifiers across the promotional pricing platform 1402 and customer communication service 1426, and convert categorical values into model-ready encoded values.

The feature engineering and data normalization module 2222 can include an identity matching module 2224. The identity matching module 2224 can resolve records associated with a customer, vehicle, license plate, transponder, device, email address, phone number, and/or federated login identifier. For example, the identity matching module 2224 can match a trip record received from the operational back office 1440 to a vehicle record 1810 using a license plate-and-state index and/or a transponder identifier. The identity matching module 2224 can then match the vehicle record 1810 to a customer account record 1802, claimed-offer record 1820, segment record 1814, and/or message engagement record. This identity resolution can produce a joined training and inference record that couples customer-facing events to tolling-system events.

The feature engineering and data normalization module 2222 can generate customer and vehicle feature vectors 2226. Each customer and vehicle feature vector 2226 can include numerical, categorical, temporal, and/or Boolean values representing a customer account and/or vehicle. Example features include trips per week, trips per month, peak-period trips, off-peak trips, managed lane capture rate, days since last trip, average toll paid, monthly toll spend, prior offer claim rate, prior redemption rate, prior discount amount, number of vehicles on an account, transponder availability, notification channel preferences, and/or support ticket count. The customer and vehicle feature vectors 2226 can be stored in a feature store and reused for training and inference.

The feature engineering and data normalization module 2222 can generate time window features 2228. The time window features 2228 can represent behavior and roadway conditions during specific windows, such as morning peak, evening peak, weekend, holiday, campaign period, billing month, and/or offer validity period. The time window features 2228 can include rolling trip counts, rolling spend amounts, rolling claim rates, rolling redemption rates, rolling savings amounts, predicted managed lane density, predicted general-purpose lane density, predicted time savings, and/or predicted toll price. The time window features 2228 allow the system 2200 to generate offers that are valid during specific time periods and that correspond to predicted roadway usage.

The feature engineering and data normalization module 2222 can generate segment features 2230. The segment features 2230 can include tag membership, behavior-based segment membership, employer-group membership, inactivity group membership, high-value customer membership, low-usage customer membership, acquisition source membership, and/or experimental cohort membership. The segment features 2230 can be derived from vehicle tag records 1812, segment records 1814, campaign records 1818, and/or analytics-generated segment outputs. The segment features 2230 can be used by downstream models to compare customer and vehicle behavior within and across segments.

The system 2200 includes a predictive model layer 2232 coupled to the feature engineering and data normalization module 2222. The predictive model layer 2232 can include an offer acceptance model 2234, an incremental usage model 2236, a cannibalization model 2238, a revenue impact model 2240, a level-of-service impact model 2242, and/or a churn or win-back model 2244. Each model in the predictive model layer 2232 can be implemented using logistic regression, gradient boosted trees, random forests, neural networks, recurrent neural networks, uplift models, causal models, contextual bandit models, reinforcement learning models, and/or other trained machine learning models. In some embodiments, multiple model outputs can be generated for each candidate customer-vehicle-offer combination.

The offer acceptance model 2234 can predict a probability that a customer and/or vehicle will claim a candidate offer. The offer acceptance model 2234 can use features such as prior claim behavior, offer value, threshold type, threshold minimum, notification channel, message variant, application engagement, customer segment, and/or validity window. The output of the offer acceptance model 2234 can include an acceptance score and/or confidence interval for each candidate offer.

The incremental usage model 2236 can predict whether a candidate offer will cause additional managed lane trips that would not otherwise occur. The incremental usage model 2236 can use historical managed lane usage, inactivity duration, current roadway usage patterns, expected travel time savings, threshold type, discount type, and/or time window features 2228. In some embodiments, the incremental usage model 2236 can be trained using prior campaigns in which similarly situated customers received or did not receive offers, allowing the model to estimate incremental trip lift attributable to an offer.

The cannibalization model 2238 can predict whether a candidate offer would discount trips that the customer would likely take without the offer. The cannibalization model 2238 can use features such as high-frequency managed lane usage, consistent commute patterns, prior willingness to pay, repeated peak-period managed lane use, and/or historical capture rate. The output of the cannibalization model 2238 can be used to reduce or prevent offering high-value discounts to customers and/or vehicles that are predicted to use the managed lane without promotional incentives.

The revenue impact model 2240 can predict a net revenue or value impact of presenting a candidate offer. The revenue impact model 2240 can use predicted acceptance, predicted incremental usage, predicted discount cost, predicted toll revenue, predicted subscription revenue, predicted capped billing impact, and/or predicted long-term retention value. The revenue impact model 2240 can output an expected value for each candidate offer and can account for the cost of a discount as well as the benefit of additional trips and/or customer retention.

The level-of-service impact model 2242 can predict how a candidate offer affects roadway performance. The level-of-service impact model 2242 can use roadway condition data 2220, predicted traffic conditions from the future traffic conditions prediction server 1110, segment-level traffic data, toll prices, time savings, and/or expected additional trips. In some embodiments, the level-of-service impact model 2242 can estimate whether sending an offer to a target group during a particular validity window will keep the managed lane within a desired service level, exceed capacity, reduce unused capacity, and/or shift demand from a congested time period to a less congested time period.

The churn or win-back model 2244 can predict whether a customer is at risk of disengaging from the program and/or whether an inactive customer is likely to return to managed lane usage in response to a specific offer. The churn or win-back model 2244 can output a churn likelihood value and/or a win-back likelihood value. The win-back likelihood is an estimated probability that an inactive customer account record 1802 and/or vehicle record 1810 will resume managed lane usage in response to a particular offer record 1816 during a future time window. The churn likelihood is an estimated probability that an active customer account record 1802 will disengage from the program during the future time window. The win-back likelihood and the churn likelihood can each be expressed as a numeric probability value, a confidence interval, a categorical classification, and/or another score derived by the churn or win-back model 2244. The churn or win-back model 2244 can use inactivity duration, prior managed lane usage, prior satisfaction scores, prior support issues, prior offer responses, and/or application engagement. The output of the churn or win-back model 2244 can be used to target reactivation offers to inactive users and/or retention offers to users with declining engagement.

The system 2200 includes an optimization engine 2246 coupled to the predictive model layer 2232. The optimization engine 2246 can receive model outputs for multiple candidate offers, customers, vehicles, segments, communication channels, and/or send times. The optimization engine 2246 can select promotional outputs by evaluating objective functions and constraints. The objective functions and constraints can include an incremental usage objective 2248, a cannibalization reduction objective 2250, a roadway service-level objective 2252, a revenue or value objective 2254, and/or a discount budget objective 2256.

The incremental usage objective 2248 can cause the optimization engine 2246 to favor offers predicted to increase managed lane usage by customers who would not otherwise use the managed lane. The cannibalization reduction objective 2250 can cause the optimization engine 2246 to penalize offers predicted to discount already-expected managed lane trips. The roadway service-level objective 2252 can cause the optimization engine 2246 to limit promotional volume during time windows in which the managed lane is predicted to approach a service-level threshold and/or to increase promotional volume during time windows having predicted available capacity. The revenue or value objective 2254 can cause the optimization engine 2246 to select offers that satisfy revenue, customer lifetime value, retention, and/or utilization goals. The discount budget objective 2256 can cause the optimization engine 2246 to keep aggregate discount exposure within a campaign budget, segment budget, roadway budget, and/or time-window budget.

In some embodiments, the optimization engine 2246 can solve a constrained optimization problem. For example, the optimization engine 2246 can select a subset of customer-vehicle-offer combinations that maximizes expected incremental trips while satisfying constraints on total discount cost, maximum number of offers sent, maximum predicted managed lane density, minimum expected revenue, and/or channel capacity. In other embodiments, the optimization engine 2246 can rank candidate offers using a composite score and select the highest-ranked offers subject to budget and service-level constraints. The composite score can be computed from weighted outputs of the offer acceptance model 2234, incremental usage model 2236, cannibalization model 2238, revenue impact model 2240, level-of-service impact model 2242, and/or churn or win-back model 2244.

The system 2200 includes promotion outputs 2258 generated by the optimization engine 2246. The promotion outputs 2258 can include a target customer and/or vehicle list 2260, a selected offer type 2262, a discount value or cap 2264, a campaign or segment assignment 2266, a communication channel 2268, a send time and message variant 2270, and/or eligibility rules for back office 2272. The target customer and/or vehicle list 2260 can identify customer account records 1802 and/or vehicle records 1810 selected to receive a promotional offer. The selected offer type 2262 can identify no-threshold, trip-threshold, spend-threshold, monthly-cap, subscription, and/or other offer type. The discount value or cap 2264 can identify a percentage, fixed dollar value, free-trip value, cap value, subscription value, and/or other value.

The promotion outputs 2258 can also be referred to as personalized offer outputs. A personalized offer output is generated by the optimization engine 2246 using one or more of the customer and vehicle feature vectors 2226, time window features 2228, and/or segment features 2230 that represent individual managed lane usage patterns, individual offer response history, individual toll spend behavior, individual application engagement behavior, individual support history, and/or individual roadway segment usage. A personalized offer output can identify a particular customer account record 1802, a particular vehicle record 1810, a particular offer record 1816, a particular campaign record 1818, a particular communication channel 1268, a particular send time, a particular message variant record 1828, and/or a particular discount value selected to satisfy one or more of the incremental usage objective 2248, the cannibalization reduction objective 2250, the roadway service-level objective 2252, the revenue or value objective 2254, and/or the discount budget objective 2256.

The campaign or segment assignment 2266 can identify one or more segment records 1814 and/or campaign records 1818 associated with the promotion outputs 2258. The communication channel 2268 can identify email, SMS, push notification, in-app message, web message, and/or vehicle message channel. The send time and message variant 2270 can identify a message variant record 1828, subject line, message content, journey step, and/or send time. The eligibility rules for back office 2272 can identify the machine-readable discount eligibility rules provided to the operational back office 1440 through the eligibility API 1444, including discount type, value, identifier, valid period, threshold rule, cap rule, subscription rule, and/or redemption limit.

The promotion outputs 2258 can be stored in the platform database 1606 as offer records 1816, campaign records 1818, segment records 1814, message variant records 1828, eligibility records, and/or targeting records. In some embodiments, the promotion outputs 2258 can be transmitted automatically to the promotional pricing platform 1402. In other embodiments, the promotion outputs 2258 can be presented to an administrative user through the administrative interface 1900 for approval, editing, and/or publication. After publication, the promotion outputs 2258 can be used by the customer communication service 1426 and/or operational back office 1440.

The customer communication service 1426 can receive communication-related promotion outputs, such as target customer identifiers, communication channels, send times, message variants, and/or personalization fields. The customer communication service 1426 can transmit customer messages and can return customer response data 2274. The customer response data 2274 can include open events, click events, offer view events, offer claim events, offer rejection events, offer replacement events, threshold progress events, threshold completion events, redemption events, unsubscribe events, and/or message failure events. The customer response data 2274 can be transmitted back to the input data sources 2202 and/or feature engineering and data normalization module 2222 through a model training feedback path 2276.

The operational back office 1440 can receive eligibility-related promotion outputs through an eligibility parameter data path 2278. The eligibility parameter data path 2278 can include discount eligibility rules, discount identifiers, valid periods, redemption limits, and/or cap rules generated by the optimization engine 2246 and/or offer engine 1450. The operational back office 1440 can return trips and discount results through a tolling feedback data path 2280. The trips and discount results can include trip identifiers, original toll amounts, final toll amounts, discount identifiers, applied discount amounts, trip statuses, and/or billing statuses. The tolling feedback data path 2280 can be used to update offer progress, calculate savings, and train the predictive model layer 2232.

The model training feedback path 2276 and tolling feedback data path 2280 can allow the system 2200 to update models using observed outcomes. For example, if the optimization engine 2246 selects a trip-threshold offer for a vehicle and the customer claims the offer, the offer acceptance model 2234 can receive a positive claim outcome. If the customer completes additional managed lane trips after claiming the offer, the incremental usage model 2236 can receive trip-lift data. If the customer would have been predicted to travel in the managed lane without the offer, the cannibalization model 2238 can be updated based on observed redemption and historical baseline behavior. If the offer produces excess demand during a congested managed lane period, the level-of-service impact model 2242 can be updated to reduce future targeting during similar roadway conditions.

In some embodiments, the system 2200 can maintain separate training, validation, and inference pipelines. A training pipeline can periodically retrieve historical outcomes, generate labeled training examples, retrain one or more models in the predictive model layer 2232, and store model versions. A validation pipeline can evaluate the retrained models using holdout data, cross-validation, back-testing, and/or business-rule constraints. An inference pipeline can use an approved model version to score candidate customer-vehicle-offer combinations. The promotional pricing platform 1402 can store the model version used for each promotion output 2258 so that later performance analysis can determine which model generated a particular offer decision.

In some embodiments, the system 2200 can implement exploration and exploitation controls. The optimization engine 2246 can reserve a portion of a campaign audience for test offers, message variants, channel variants, and/or control groups. The system 2200 can store experimental cohort identifiers in the campaign or segment assignment 2266 and can compare outcomes across cohorts. This allows the promotion analytics module 1424 to distinguish between customers who changed behavior because of an offer and customers who would have used the managed lane without the offer.

In some embodiments, the optimization engine 2246 can generate real-time and/or near-real-time promotion outputs. For example, the roadway condition data 2220 can indicate that a managed lane segment has predicted available capacity during an upcoming time window. The feature engineering and data normalization module 2222 can generate candidate customers and vehicles expected to approach the managed lane facility during that time window. The predictive model layer 2232 can score candidate offers, and the optimization engine 2246 can select a targeted offer that is transmitted through the customer communication service 1426, mobile application 1406, in-vehicle interface, and/or CAV communication channel. Acceptance or rejection of the offer can be returned through the customer response data 2274 and used to update the future traffic conditions prediction server 1110 and/or promotion analytics module 1424.

The system 2200 can provide technical improvements to the promotional pricing platform 1402 by converting heterogeneous data from tolling systems, customer devices, marketing systems, support systems, and roadway prediction systems into normalized feature vectors and model-driven promotional outputs. The identity matching module 2224 can couple asynchronous events from different systems using stable customer, vehicle, license plate, transponder, campaign, offer, claim, trip, and discount identifiers. The predictive model layer 2232 can generate quantitative outputs for candidate offer decisions, and the optimization engine 2246 can convert those outputs into validated promotion records and back-office eligibility rules. This architecture can reduce manual campaign targeting, reduce inconsistent discount administration, and improve use of managed lane capacity by aligning promotional offers with measured customer behavior and predicted roadway conditions.

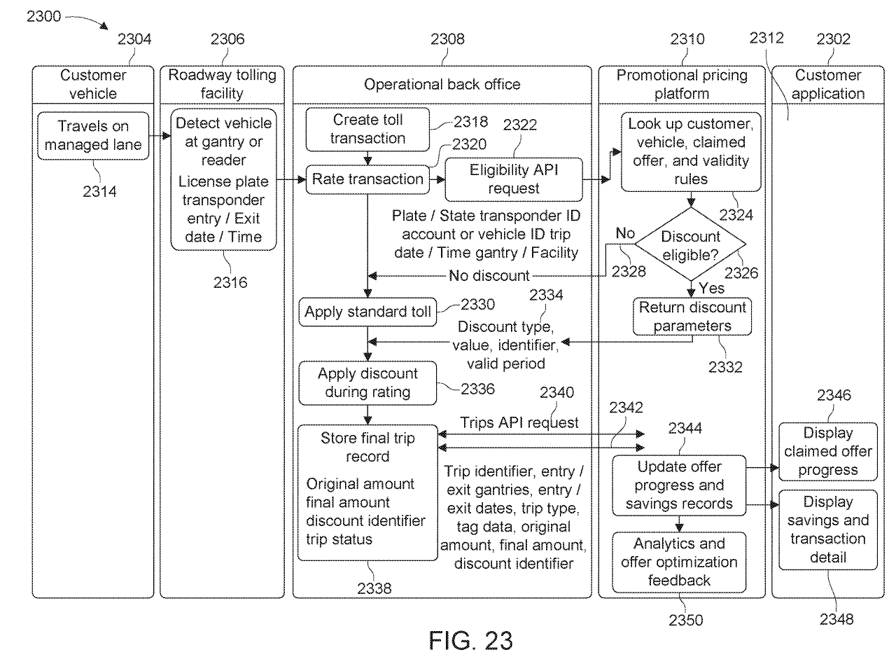

FIG. 23 shows one embodiment of an operational back office integration flow 2300 for applying promotional discounts to toll transactions and updating customer-facing offer progress and savings records. The integration flow 2300 can be implemented using the customer vehicle 1416, the roadway tolling systems 1430, the operational back office 1440, the promotional pricing platform 1402, and a customer application 2302. The customer application 2302 can be implemented as the mobile application 1406, the web application 1408, an in-vehicle application, and/or another consumer interface 1602 presented through one of the customer devices 1404.

The integration flow 2300 can be arranged as a sequence of data exchanges among a customer vehicle lane 2304, a roadway tolling facility lane 2306, an operational back office lane 2308, a promotional pricing platform lane 2310, and a customer application lane 2312. The lanes 2304, 2306, 2308, 2310, 2312 illustrate that different portions of the flow can be performed by distributed systems that operate at different times and under different control domains. The promotional pricing platform 1402 can coordinate the distributed systems by using persistent identifiers, validation logic, and versioned eligibility rules.

At block 2314, the customer vehicle 1416 travels on a managed lane. The customer vehicle 1416 can be associated with a customer account record 1802, a vehicle record 1810, and/or a claimed-offer record 1820 stored by the promotional pricing platform 1402. The customer vehicle 1416 can be identified by a license plate number, license plate state, transponder identifier, vehicle identifier, device identifier, and/or fleet identifier. In some embodiments, the customer vehicle 1416 can include a CAV 702 configured to exchange offer, route, and/or acceptance data with the toll service provider 704 and/or promotional pricing platform 1402.

At block 2316, the roadway tolling systems 1430 detect the customer vehicle 1416 at a gantry, tolling portal, roadside unit, reader, camera, and/or other roadway detection location. The roadway tolling systems 1430 can include toll gantries 1432, roadway sensors 1434, transponder and/or ALPR readers 1436, and/or the managed lane facility 1438. The detected vehicle data can include a license plate number, license plate state, transponder identifier, entry gantry, exit gantry, lane identifier, date, time, roadway facility identifier, direction of travel, vehicle classification, axle count, image data, confidence score, and/or sensor status. The roadway tolling systems 1430 can transmit the detected vehicle data to the operational back office 1440 as toll transaction data.

At block 2318, the operational back office 1440 creates a toll transaction record. The toll transaction record can include a transaction identifier, a trip identifier, entry data, exit data, vehicle identification data, gantry data, lane data, timestamp data, trip type, vehicle class, and/or initial toll amount data. The operational back office 1440 can store the toll transaction record in a toll transaction database and can associate the toll transaction record with an account, transponder, video toll record, license plate record, and/or billing account. In some embodiments, the operational back office 1440 can create a preliminary toll transaction record at vehicle entry and update the toll transaction record after exit data is received.

At block 2320, the operational back office 1440 rates the toll transaction. The rating operation can be performed by the rating and billing module 1446. The rating operation can determine a base toll, dynamic toll, toll class, toll facility, trip distance, and/or trip time. Before finalizing the rated toll transaction, the operational back office 1440 can determine whether an external promotional discount eligibility check is available for the toll transaction. The operational back office 1440 can then generate an eligibility API request 2322.

The eligibility API request 2322 can be transmitted from the operational back office 1440 to the promotional pricing platform 1402 through the eligibility API 1444 and/or the API gateway 1460. The eligibility API request 2322 can include a plate-and-state value, transponder identifier, account identifier, vehicle identifier, transaction identifier, trip identifier, trip date, trip time, gantry identifier, facility identifier, lane identifier, direction identifier, trip type, base toll amount, and/or vehicle class. The eligibility API request 2322 can also include a request timestamp, retry identifier, authentication token, and/or message signature. The authentication token and/or message signature can be used by the promotional pricing platform 1402 to verify that the request originated from an authorized operational back office 1440.

At block 2324, the promotional pricing platform 1402 looks up customer, vehicle, claimed-offer, and validity rule data. The promotional pricing platform 1402 can normalize one or more vehicle identifiers in the eligibility API request 2322 and query the platform database 1606 and/or customer/vehicle database 1456. For example, the promotional pricing platform 1402 can normalize the license plate number by removing spaces and/or punctuation and converting alphabetic characters to a standardized case. The promotional pricing platform 1402 can match the normalized license plate number and license plate state to a vehicle record 1810, match a transponder identifier to the same or a different vehicle record 1810, and determine whether any identifier conflict exists. If multiple identifiers are present, the promotional pricing platform 1402 can apply a priority rule, confidence rule, and/or reconciliation rule to identify the appropriate customer-vehicle record 1746.

The lookup operation at block 2324 can be implemented as an indexed comparison of the vehicle identification data received in the eligibility API request 2322 to indexed fields of the customer-vehicle record 1746 stored in the customer/vehicle database 1456. The indexed comparison can be performed using a normalized plate-and-state index, a transponder identifier index, a vehicle identifier index, and/or a customer account identifier index. By performing an indexed comparison rather than a sequential scan of the customer/vehicle database 1456, the promotional pricing platform 1402 can return a matched customer-vehicle record 1746 within a latency window suitable for transaction-rating operations performed by the operational back office 1440.

At decision block 2326, the promotional pricing platform 1402 determines whether the toll transaction is discount eligible. The eligibility determination can evaluate a customer account status, vehicle status, claimed-offer status, campaign status, offer status, valid period, valid day-of-week, valid time-of-day, facility identifier, lane identifier, direction identifier, trip type, vehicle type, redemption limit, threshold progress value, monthly cap accumulator, subscription status, and/or other eligibility rule. The promotional pricing platform 1402 can evaluate the eligibility determination using the eligibility and application rules module 2056 and a version of the offer object 2032 associated with the claimed-offer record 1820.

If the toll transaction is not eligible, the promotional pricing platform 1402 can return a no-discount response 2328 to the operational back office 1440. The no-discount response 2328 can include a response status, reason code, request identifier, transaction identifier, and/or rule version identifier. The reason code can indicate, for example, no enrolled vehicle, no active claimed offer, invalid time window, threshold not met, redemption limit exhausted, campaign expired, facility mismatch, vehicle mismatch, account inactive, and/or another no-discount condition. The operational back office 1440 can then apply a standard toll at block 2330.

The no-discount response 2328 can include an ineligible status value indicating that the toll transaction is not eligible for a promotional discount. The ineligible status can be transmitted in the eligibility API response 2334 in place of, or in addition to, the discount identifier, discount type, discount value, valid period, and/or redemption limit fields. The operational back office 1440 can interpret the ineligible status as a determination that the toll transaction is to be rated and billed using a standard toll without application of a promotional discount. In some embodiments, the ineligible status can be coupled to a reason code indicating, for example, no enrolled vehicle, no active claimed offer, threshold not met, redemption limit exhausted, campaign expired, facility mismatch, vehicle mismatch, and/or account inactive. In some cases, such as where there may be an error that makes the platform unavailable, the operational back office 2308 could hold the transaction for a set time, retry application of the discount after a time interval, or may process the transactions and tag that the platform is unavailable and reconcile the transaction at a later time when the platform is available.

If the toll transaction is eligible, the promotional pricing platform 1402 returns discount parameters at block 2332. The discount parameters can be transmitted to the operational back office 1440 through an eligibility API response 2334. The eligibility API response 2334 can include a discount identifier, discount type, discount value, cap value, valid period, redemption limit, claim identifier, offer identifier, campaign identifier, customer account identifier, vehicle identifier, response timestamp, and/or rule version identifier. The discount type can include a percentage discount, fixed amount discount, free trip discount, capped billing response, subscription-based response, and/or another toll pricing treatment.

At block 2336, the operational back office 1440 applies the discount during rating and/or billing. The rating and billing module 1446 can adjust the toll transaction according to the eligibility API response 2334. For example, the rating and billing module 1446 can subtract a fixed dollar amount from a base toll, apply a percentage reduction, set a final toll amount to zero, apply a monthly cap rule, apply a subscription rule, and/or apply another promotional pricing treatment. The operational back office 1440 can store the applied discount identifier, discount value, original amount, final amount, and/or discount response metadata with the toll transaction record. If the eligibility API response 2334 includes an expiration time and/or request identifier, the operational back office 1440 can store those values to support audit and reconciliation.

At block 2338, the operational back office 1440 stores a final trip record. The final trip record can include a trip identifier, transaction identifier, entry gantry, exit gantry, entry date, exit date, tag information, trip status, trip type, original amount, final amount, applied discount identifier, applied discount amount, account identifier, vehicle identifier, and/or billing status. The final trip record can be used to update customer-facing offer progress and savings displays. In some embodiments, the final trip record can be stored after the trip is fully rated, after image review is completed, after a billing account is matched, and/or after a final charge is posted.

The promotional pricing platform 1402 can request trip records from the operational back office 1440 using a trips API request 2340. The trips API request 2340 can identify a customer account, vehicle, license plate, transponder, trip time range, claim identifier, campaign identifier, offer identifier, and/or roadway facility. The trips API request 2340 can be initiated on a schedule, in response to an offer progress refresh, in response to a customer viewing the customer application 2302, in response to a webhook event from the operational back office 1440, and/or in response to a support lookup. In some embodiments, completed trip records can be pushed from the operational back office 1440 to the promotional pricing platform 1402 instead of being requested by the promotional pricing platform 1402.

The operational back office 1440 returns trip data through a trip data response 2342. The trip data response 2342 can include trip identifiers, entry and/or exit gantries, entry and/or exit dates, trip type, tag data, license plate data, transponder data, original amount, final amount, applied discount identifier, trip status, and/or billing status. The trip data response 2342 can be transmitted through the trips API 1442 and/or another back-office interface. The promotional pricing platform 1402 can validate the trip data response 2342 by checking authentication data, message signature, trip identifier uniqueness, timestamp ranges, and/or roadway program identifiers.

At block 2344, the promotional pricing platform 1402 updates offer progress and savings records. The promotional pricing platform 1402 can match each returned trip to a vehicle record 1810, claimed-offer record 1820, and/or campaign record 1818. The promotional pricing platform 1402 can update a trip counter, spend accumulator, monthly cap accumulator, subscription usage counter, redemption counter, and/or offer status. The promotional pricing platform 1402 can also create and/or update a trip record 1822, discount record 1824, and savings record 1826. The saved amount can be calculated as a difference between an original amount and a final amount, as an applied discount amount returned by the operational back office 1440, and/or as another reconciliation value defined by the offer object 2032.

The customer application 2302 can display claimed-offer progress at block 2346. The claimed-offer progress can be retrieved from the promotional pricing platform 1402 and can include current progress, threshold value, threshold reached status, discount availability, expiration date, vehicle identifier, and/or campaign information. For a trip-threshold offer, the customer application 2302 can display a progress bar indicating completed trips relative to a threshold trip count. For a spend-threshold offer, the customer application 2302 can display accumulated spend relative to a spend threshold. For a monthly-cap offer, the customer application 2302 can display spend toward a cap and/or remaining period. For a subscription offer, the customer application 2302 can display subscription status and usage.

The customer application 2302 can display savings and transaction detail at block 2348. The savings display can include total savings for a selected time period, transaction-level savings, discount type, discount amount, original amount, final amount, vehicle nickname, license plate, transponder identifier, toll location, trip time, and/or trip status. The transaction detail can show an itemized toll amount, discount applied, and final charged amount. The customer application 2302 can retrieve this data from savings records 1826, trip records 1822, and/or discount records 1824 stored by the promotional pricing platform 1402.

The promotional pricing platform 1402 can provide analytics and offer optimization feedback at block 2350. The feedback can include eligibility requests received, no-discount responses, discount responses, trips rated with discounts, trips rated without discounts, offer progress updates, threshold completion events, redemption events, savings values, and/or customer application display events. The analytics platform 1420 can use the feedback to train and/or update the offer acceptance model 2234, incremental usage model 2236, cannibalization model 2238, revenue impact model 2240, level-of-service impact model 2242, and/or churn or win-back model 2244.

The integration flow 2300 can support idempotent API processing. The eligibility API request 2322 can include a transaction identifier and/or request identifier. If the operational back office 1440 retries the same eligibility API request 2322 because of a network interruption, timeout, or other transient issue, the promotional pricing platform 1402 can return the same no-discount response 2328 or eligibility API response 2334 for the same transaction identifier and rule version. The promotional pricing platform 1402 can store request and response hashes so that repeated requests do not cause duplicate discount reservations, duplicate redemption decrements, and/or inconsistent eligibility decisions.

The trip data response 2342 can also be processed idempotently. The promotional pricing platform 1402 can maintain a processed-trip index that comprises a unique index on trip identifiers and/or a composite index on transaction identifier, vehicle identifier, and trip time. When a completed trip record is received through the trip data response 2342, the promotional pricing platform 1402 can store the trip identifier in the processed-trip index. When subsequently received completed trip data includes a trip identifier already present in the processed-trip index, the promotional pricing platform 1402 can prevent a second update to the progress value of the claimed-offer record 1820, prevent duplicate creation of a trip record 1822, prevent duplicate creation of a discount record 1824, and/or prevent duplicate creation of a savings record 1826. If the same trip data response 2342 is received multiple times, the promotional pricing platform 1402 can update an existing trip record 1822 rather than creating a duplicate trip record. The promotional pricing platform 1402 can similarly prevent a single trip record 1822 from incrementing a trip-threshold progress value more than once unless an updated trip status indicates that a prior progress update should be reversed and recalculated.

In some embodiments, the promotional pricing platform 1402 can implement a transaction state machine for each claimed-offer record 1820. The state machine can include states such as claimed, in progress, threshold reached, discount eligible, discount applied, redemption limit met, expired, replaced, and/or closed. The eligibility API response 2334 and trip data response 2342 can trigger transitions between the states. The state machine can be stored with timestamps and event identifiers so that the promotional pricing platform 1402 can reconstruct how an offer progressed from claim to discount application.

The integration flow 2300 can include validation and conflict handling. If a license plate identifier in the eligibility API request 2322 matches a first vehicle record and a transponder identifier matches a second vehicle record, the promotional pricing platform 1402 can apply a conflict rule. The conflict rule can include rejecting the request, selecting the transponder match, selecting the plate match with higher confidence, selecting an active claimed-offer match, and/or flagging the transaction for review. The promotional pricing platform 1402 can return a no-discount response 2328 with a conflict reason code or can return a discount response only when the conflict rule is satisfied. This can reduce incorrect discount application when vehicle identifiers are missing, misread, or outdated.

The integration flow 2300 can include latency controls. Because toll rating can be performed within a constrained processing window, the promotional pricing platform 1402 can evaluate frequently accessed eligibility data using cached offer rules, indexed customer-vehicle records, and precomputed segment membership. For example, the promotional pricing platform 1402 can cache active claimed-offer records 1820 by vehicle identifier and valid time window. The eligibility and application rules module 2056 can use the cached data to generate the eligibility API response 2334 without scanning all offer and campaign records. The promotional pricing platform 1402 can refresh the cached data when offers are claimed, campaigns are published, vehicles are added, and/or trip progress changes.

The integration flow 2300 can include audit records for reconciliation and support. The promotional pricing platform 1402 can store an eligibility audit record for each eligibility API request 2322 and corresponding response. The eligibility audit record can include request values, matched customer account, matched vehicle, matched claimed offer, rule version, eligibility decision, reason code, discount parameters, and response time. The operational back office 1440 can store a rating audit record identifying the discount response used to rate the toll transaction. The customer support service 1448 can retrieve these audit records to determine whether an offer was active, whether a trip qualified, and whether a discount was applied correctly.

The integration flow 2300 can provide a technical improvement by synchronizing customer-facing offer records with back-office toll rating operations through structured API messages and persistent identifiers. The promotional pricing platform 1402 can evaluate offer rules at transaction-rating time using customer, vehicle, claim, threshold, validity, and redemption data, and can return a machine-readable discount response to the operational back office 1440. Completed trip records can then be reconciled back into the promotional pricing platform 1402 to update offer progress and savings displays. This closed-loop integration can reduce manual reconciliation, reduce duplicate progress updates, improve discount application reliability, and provide auditable linkage among offer claims, toll trips, discount responses, and customer savings.

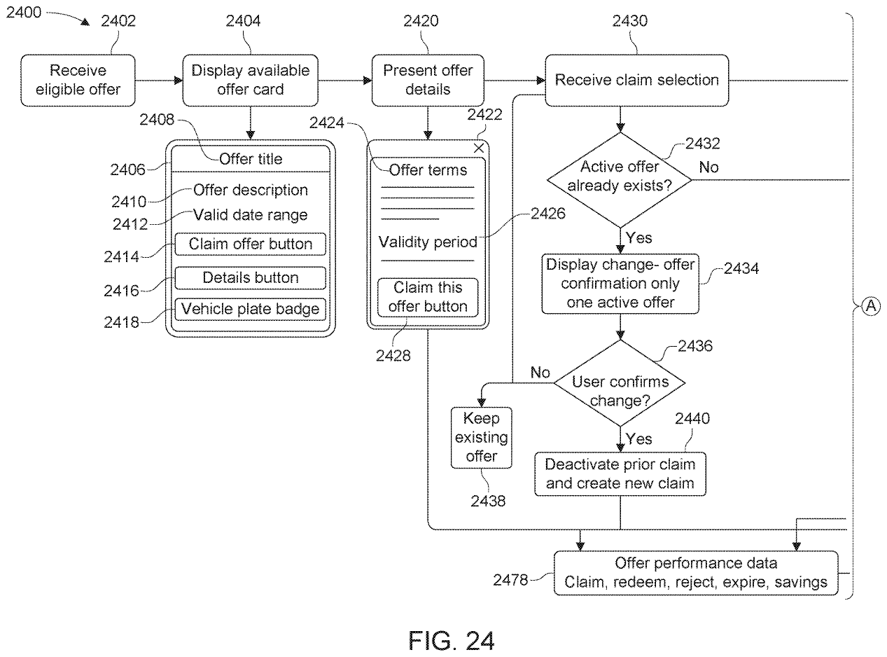

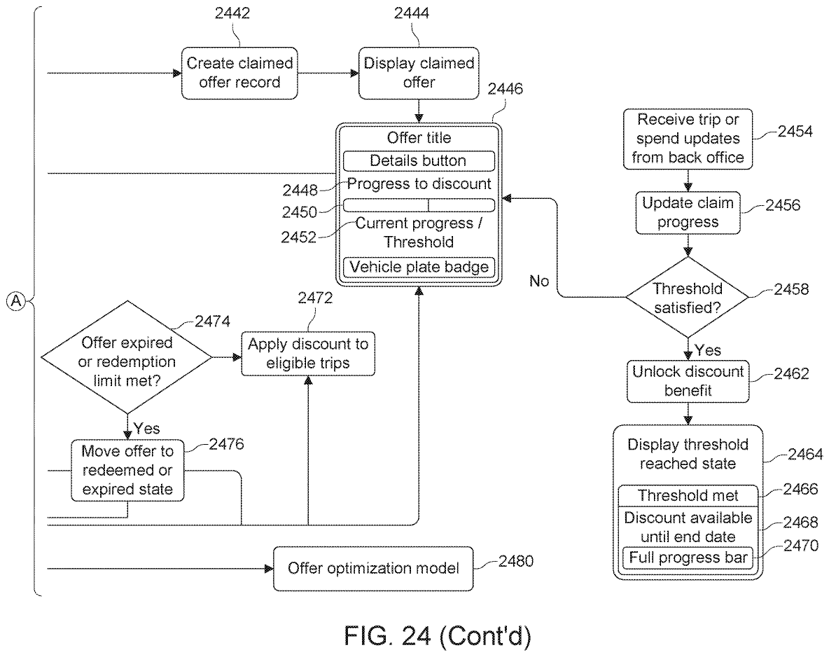

FIG. 24 shows one embodiment of a consumer offer lifecycle 2400 executable by the promotional pricing platform 1402 through the consumer interface 1602. The consumer offer lifecycle 2400 can control how an offer is presented, claimed, progressed, unlocked, applied to toll transactions, and moved to a redeemed and/or expired state. The consumer offer lifecycle 2400 can be implemented using the offer engine 1450, campaign manager 1452, segment manager 1454, customer/vehicle database 1456, platform database 1606, customer communication service 1426, operational back office 1440, trips API 1442, eligibility API 1444, and/or customer devices 1404.

At block 2402, the promotional pricing platform 1402 receives and/or determines an eligible offer. The eligible offer can be determined by evaluating a customer account record 1802, vehicle record 1810, segment record 1814, offer record 1816, campaign record 1818, notification preference record 1808, and/or roadway program identifier. For example, the promotional pricing platform 1402 can determine that a particular customer vehicle 1416 is associated with a segment record 1814 and that the segment record 1814 is targeted by an active campaign record 1818. The promotional pricing platform 1402 can also determine whether the offer record 1816 is within a publication window, whether the customer account is active, whether the vehicle record 1810 is active, whether the offer has already been claimed, and/or whether a redemption limit remains available.

At block 2404, the promotional pricing platform 1402 displays an available offer card 2406 through the consumer interface 1602. The available offer card 2406 can be rendered on the mobile application 1406, the web application 1408, an in-vehicle display, and/or another customer device 1404. The available offer card 2406 can include an offer title 2408, offer description 2410, valid date range 2412, claim offer button 2414, details button 2416, and vehicle plate badge 2418. The offer title 2408 and offer description 2410 can be generated from fields of the campaign record 1818 and/or offer record 1816. The valid date range 2412 can be generated from a publication window, offer window, discount window, and/or validity rule field 2048. The vehicle plate badge 2418 can identify the vehicle record 1810 to which the offer applies, such as by displaying a license plate number and/or vehicle nickname. This vehicle-specific display can reduce confusion in multi-vehicle accounts and can couple the customer-facing offer state to the vehicle identifier used by the eligibility API 1444.

At block 2420, the promotional pricing platform 1402 presents offer details. The offer details can be presented in an offer details modal 2422 and/or another expanded offer view. The offer details modal 2422 can include offer terms 2424, a validity period 2426, and a claim-this-offer control 2428. The offer terms 2424 can include a threshold type, threshold minimum, discount type, discount value, roadway facility, valid days, valid time, redemption limit, vehicle applicability, and/or other conditions derived from the offer object 2032. The validity period 2426 can display when the offer can be claimed, progressed, redeemed, and/or applied. The offer details modal 2422 can cause the customer to review a complete set of offer terms before claim data is stored, and can reduce later mismatch between customer expectations and back-office discount eligibility rules.

At block 2430, the promotional pricing platform 1402 receives a claim selection. The claim selection can be generated when the customer selects the claim offer button 2414 and/or the claim-this-offer control 2428. The claim selection can include a customer account identifier, vehicle identifier, offer identifier, campaign identifier, session identifier, device identifier, timestamp, and/or selected communication source. The promotional pricing platform 1402 can validate the claim selection by determining whether the customer account record 1802 is verified, whether the vehicle record 1810 is active, whether the offer record 1816 is active, whether the campaign record 1818 is published, whether the selected vehicle is eligible, and/or whether the offer window is open. In some cases, offers may be stacked, such as separate offers provided to the vehicle and to the customer which may be combined for a single transaction.

At decision block 2432, the promotional pricing platform 1402 determines whether an active offer already exists for the customer account and/or vehicle. The promotional pricing platform 1402 can query claimed-offer records 1820 indexed by customer account identifier, vehicle identifier, campaign identifier, offer status, and/or roadway program identifier. In some embodiments, the promotional pricing platform 1402 can be configured to allow only one active claimed offer for a vehicle, account, roadway, and/or time window. This configuration can reduce conflicting eligibility responses, prevent stacked discounts, and simplify synchronization between the promotional pricing platform 1402 and the operational back office 1440.

If an active offer already exists, the promotional pricing platform 1402 can display a change-offer confirmation at block 2434. The change-offer confirmation can identify that another offer is active and can request confirmation before the active offer is replaced. At decision block 2436, the promotional pricing platform 1402 receives and evaluates a user confirmation. If the customer does not confirm the change, or if a user has previously selected an offer, the promotional pricing platform 1402 can keep the existing offer at block 2438. Keeping the existing offer can leave the previously stored claimed-offer record 1820 in an active state and can avoid modifying eligibility data exposed through the eligibility API 1444.

If the customer confirms the change, the promotional pricing platform 1402 can deactivate the prior claim and create a new claim at block 2440. The deactivation operation can update a status field of the prior claimed-offer record 1820 to replaced, inactive, cancelled, and/or another nonactive state. The new claim operation can create a new claimed-offer record 1820 coupled to the selected offer record 1816, selected campaign record 1818, customer account record 1802, and vehicle record 1810. In some embodiments, the promotional pricing platform 1402 can perform the deactivation and new claim creation in a single database transaction so that the vehicle does not have two active claimed-offer records after the operation.

If no active offer already exists, or if the prior claim is deactivated, the promotional pricing platform 1402 creates a claimed-offer record at block 2442. The claimed-offer record 1820 can include a claim identifier, customer account identifier, vehicle identifier, offer identifier, campaign identifier, claim timestamp, claim source, offer version, status, threshold progress value, redemption counter, expiration time, and/or validity rule reference. The promotional pricing platform 1402 can expose the claimed-offer record 1820 to the eligibility and application rules module 2056 so that a later eligibility API request from the operational back office 1440 can be evaluated against the claimed offer.

At block 2444, the promotional pricing platform 1402 displays the claimed offer. The claimed offer can be displayed in a claimed offer card 2446 through the consumer interface 1602. The claimed offer card 2446 can include the offer title 2408, offer description 2410, details button 2416, vehicle plate badge 2418, and a progress-to-discount section 2448. The progress-to-discount section 2448 can include a progress bar 2450 and a current progress/threshold label 2452. The current progress/threshold label 2452 can display values such as completed trips relative to a trip threshold, accumulated spend relative to a spend threshold, accumulated billed amount relative to a cap, and/or subscription usage relative to a subscription allowance. The progress bar 2450 can be generated from the progress value stored in the claimed-offer record 1820.

At block 2454, the promotional pricing platform 1402 receives trip and/or spend updates from the operational back office 1440. The trip and/or spend updates can be received through the trips API 1442 and can include trip records 1822 having trip identifiers, entry gantries, exit gantries, entry times, exit times, trip types, original amounts, final amounts, discount identifiers, and/or trip statuses. The promotional pricing platform 1402 can match each trip record 1822 to a vehicle record 1810 and claimed-offer record 1820 using a vehicle identifier, license plate number, license plate state, transponder identifier, claim identifier, campaign identifier, and/or roadway facility identifier.

At block 2456, the promotional pricing platform 1402 updates claim progress. For a trip-threshold offer, the promotional pricing platform 1402 can increment a qualifying-trip counter associated with the claimed-offer record 1820. For a spend-threshold offer, the promotional pricing platform 1402 can increment a spend accumulator using original toll amounts, final toll amounts, or another amount field specified by the offer object 2032. For a monthly-cap offer, the promotional pricing platform 1402 can update a billing-period accumulator and determine whether subsequent trips during the period are eligible for capped billing, reduced pricing, and/or no additional charge. For a subscription offer, the promotional pricing platform 1402 can update subscription usage, covered trips, covered spend, and/or remaining subscription benefits. Of course, for some non-threshold offers, block 2456 may not be required and becomes an optional progress update. For example, if a simple discount were offered, such as during a certain time period, the threshold-related portions of the data flow may not be required.

At decision block 2458, the promotional pricing platform 1402 determines whether a threshold has been satisfied. The threshold determination can compare a current progress value against a threshold minimum stored in the offer object 2032 and/or offer record 1816. The threshold determination can also evaluate validity rules, such as whether the trip occurred during a valid date range, valid day of week, valid time of day, eligible roadway facility, eligible gantry, eligible direction, and/or eligible lane. If the threshold has not been satisfied, the promotional pricing platform 1402 can show updated progress at block 2450 and continue displaying the claimed offer at block 2444.

If the threshold has been satisfied, the promotional pricing platform 1402 unlocks a discount benefit at block 2462. Unlocking the discount benefit can update the claimed-offer record 1820 from an in-progress state to an unlocked, discount-eligible, threshold-reached, and/or active-discount state. The promotional pricing platform 1402 can update an eligibility cache, eligibility index, and/or rule evaluation table used by the eligibility API 1444 so that the operational back office 1440 can receive a discount response for subsequent eligible toll transactions. In some embodiments, the promotional pricing platform 1402 can generate a threshold-reached event and transmit the event to the customer communication service 1426 for delivery through email, SMS, push notification, and/or in-app notification.

At block 2464, the promotional pricing platform 1402 displays a threshold reached state. The threshold reached state can be shown in a threshold reached card 2466. The threshold reached card 2466 can include a threshold-met indication, a discount-available-until-end-date field 2468, and a full progress bar 2470. The discount-available-until-end-date field 2468 can be generated from the validity rule field 2048, campaign record 1818, claimed-offer record 1820, and/or offer object 2032. Displaying the threshold reached state can synchronize the customer-facing state with the eligibility state used by the operational back office 1440.

At block 2472, the promotional pricing platform 1402 and/or operational back office 1440 applies the discount to eligible trips. In some embodiments, the operational back office 1440 transmits an eligibility API request to the promotional pricing platform 1402 for each toll transaction. The promotional pricing platform 1402 can evaluate the claimed-offer record 1820 and return a discount type, discount value, discount identifier, valid period, redemption limit, and/or cap value through the eligibility API 1444. The operational back office 1440 can then apply the discount during rating and/or billing. In other embodiments, the promotional pricing platform 1402 can transmit eligibility rules in advance, and the operational back office 1440 can apply the discount based on locally stored eligibility data. Completed trip data can be returned to the promotional pricing platform 1402 through the trips API 1442.

At decision block 2474, the promotional pricing platform 1402 determines whether the offer has expired and/or whether a redemption limit has been met. The determination can include comparing a current time to an expiration time, comparing an applied discount count to a redemption limit, determining whether a campaign window has ended, determining whether a monthly cap period has ended, and/or determining whether subscription status has ended. If the offer has not expired and the redemption limit has not been met, the promotional pricing platform 1402 can continue applying the discount to eligible trips at block 2472. The offer expiration may be monitored continuously, be based on a timed offer period, updated daily, or some other expiration metric that can be tracked and be used to affect the availability of the offer. If the offer has expired and/or the redemption limit has been met, the promotional pricing platform 1402 moves the offer to a redeemed and/or expired state at block 2476.

Moving the offer to the redeemed and/or expired state at block 2476 can include updating the claimed-offer record 1820, invalidating eligibility cache entries, updating customer-facing displays, preventing further discount responses through the eligibility API 1444, and/or generating a customer communication event. The promotional pricing platform 1402 can store a closure reason, closure timestamp, final progress value, applied discount count, savings amount, and/or final status. The closure data can be used by the customer support service 1448 and/or analytics platform 1420 to explain why a discount was no longer available for later trips.

The consumer offer lifecycle 2400 can generate offer performance data 2478. The offer performance data 2478 can include offer received events, offer displayed events, detail viewed events, claim selection events, change-offer confirmation events, claim created events, offer rejection events, claim replacement events, progress update events, threshold reached events, discount applied events, redemption events, expiration events, and/or savings events. The offer performance data 2478 can be coupled to the customer account record 1802, vehicle record 1810, offer record 1816, campaign record 1818, claimed-offer record 1820, trip record 1822, discount record 1824, and/or savings record 1826.

The offer performance data 2478 can be transmitted to an offer optimization model 2480. The offer optimization model 2480 can be implemented by the promotion analytics module 1424 and/or one or more models in the predictive model layer 2232. The offer optimization model 2480 can use the offer performance data 2478 to update predictions for offer acceptance, incremental managed lane usage, cannibalization risk, revenue impact, level-of-service impact, churn, and/or win-back likelihood. For example, if a customer repeatedly views offer details but does not claim trip-threshold offers, the offer optimization model 2480 can reduce the predicted acceptance score for similar trip-threshold offers for that customer and/or vehicle. If a customer claims a spend-threshold offer and completes additional managed lane trips, the offer optimization model 2480 can increase the predicted incremental usage value for similar offers.

In some embodiments, the consumer offer lifecycle 2400 can be implemented as an offer state machine 2482. The offer state machine 2482 can include states such as available, viewed, claimed, in-progress, threshold-reached, discount-eligible, redeemed, expired, replaced, and/or closed. As used herein, “in-progress” and “in progress,” “threshold-reached” and “threshold reached,” and “discount-eligible” and “discount eligible” are used interchangeably to refer to the corresponding states of the offer state machine 2482. Each state transition can be caused by a validated event, such as a claim selection, detail view, trip update, spend update, threshold determination, discount application, expiration time, and/or redemption limit event. The promotional pricing platform 1402 can store state transition records with timestamps, event identifiers, prior states, new states, customer identifiers, vehicle identifiers, and/or rule version identifiers.

The offer state machine 2482 can improve reliability in distributed processing environments. For example, a trip update can arrive after an offer expiration event, and the promotional pricing platform 1402 can evaluate the stored event timestamps and rule versions to determine whether the trip should count toward progress. A duplicate trip update can be ignored if a state transition record indicates that the trip identifier has already been processed. A duplicate claim selection can return the existing claimed-offer record 1820 rather than creating another active claim. These state-machine operations can reduce duplicate discounts, duplicate progress counts, and inconsistent customer-facing displays.

In some embodiments, the consumer offer lifecycle 2400 can include a single-active-offer control 2484. The single-active-offer control 2484 can use database constraints, transaction locks, and/or conditional updates to prevent simultaneous active claimed-offer records for the same vehicle record 1810 and roadway program. The single-active-offer control 2484 can transactionally deactivate a prior active claimed-offer record 1820 and transactionally generate a new claimed-offer record 1820 in a single database transaction. As used herein, transactionally deactivating an existing active claimed-offer record 1820 and transactionally generating a new claimed-offer record 1820 mean performing the deactivation operation and the generation operation within a single atomic database transaction such that, upon commit, either both operations are persisted together or neither operation is persisted. For example, when creating a new claimed-offer record 1820, the promotional pricing platform 1402 can acquire a lock on the vehicle identifier, check for active claims, transactionally update any prior claim status, transactionally create the new claim, and release the lock. This transactional processing can reduce race conditions when a customer quickly selects multiple offers or when claim requests are retried because of network latency.

The consumer offer lifecycle 2400 can also include synchronization with customer communications. When an offer becomes available, claimed, near expiration, threshold reached, redeemed, and/or expired, the promotional pricing platform 1402 can generate a journey event for the customer communication service 1426. The notification preference manager 1458 can determine which communication channels are enabled for the customer account. The customer communication service 1426 can then transmit an email, SMS, push notification, in-app message, and/or web notification. Engagement events from those communications can be returned as part of the offer performance data 2478.

The consumer offer lifecycle 2400 can provide a technical improvement by maintaining a synchronized offer state across the customer application 2302, promotional pricing platform 1402, and operational back office 1440. The available offer card 2406, offer details modal 2422, claimed offer card 2446, threshold reached card 2466, eligibility API responses, trips API updates, and offer performance data 2478 can all be derived from and/or coupled to the same offer record 1816, campaign record 1818, and claimed-offer record 1820. This state-based architecture can reduce inconsistency between what the customer sees, what the back office applies, and what the analytics platform 1420 uses for future promotional decisions.

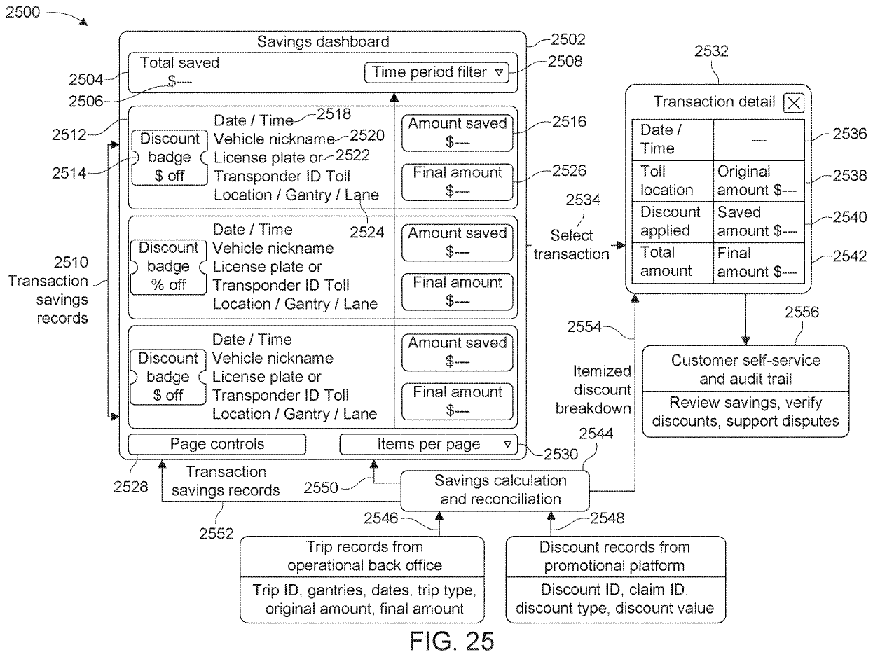

FIG. 25 shows one embodiment of a savings dashboard and transaction detail architecture 2500 configured to display discount savings generated by promotional offers applied to toll transactions. The architecture 2500 can be implemented by the promotional pricing platform 1402, the customer application 2302, the operational back office 1440, the trips API 1442, the eligibility API 1444, the platform database 1606, and/or the customer/vehicle database 1456. The architecture 2500 can convert completed toll transaction data and discount application data into customer-facing savings records that can be reviewed through the customer devices 1404.

The architecture 2500 includes a savings dashboard 2502 rendered through the customer application 2302. The savings dashboard 2502 can be presented through the mobile application 1406, the web application 1408, an in-vehicle interface, and/or another consumer interface 1602. The savings dashboard 2502 includes a savings summary bar 2504 having a total saved field 2506 and a time period filter 2508. The total saved field 2506 can display an aggregate savings amount for a selected customer account, selected vehicle, selected roadway program, selected concession, and/or selected time period. The time period filter 2508 can receive a selected reporting period, such as a current month, previous month, custom date range, campaign period, offer period, subscription period, and/or billing period.

The promotional pricing platform 1402 can calculate the value displayed in the total saved field 2506 by querying savings records 1826 associated with a customer account record 1802 and summing saved amounts satisfying the time period filter 2508. In some embodiments, the promotional pricing platform 1402 can aggregate savings records 1826 by vehicle record 1810, campaign record 1818, offer record 1816, claimed-offer record 1820, roadway facility, discount type, and/or trip type. In other embodiments, the promotional pricing platform 1402 can store precomputed aggregate savings values in a summary table and update the summary table when new trip records 1822 and/or discount records 1824 are received from the operational back office 1440.

The savings dashboard 2502 includes a transaction list 2510 having one or more transaction cards 2512. Each transaction card 2512 can display a toll transaction to which a discount was applied and/or a toll transaction relevant to a claimed offer. Each transaction card 2512 can include a discount badge 2514, an amount saved indicator 2516, a date/time field 2518, a vehicle identifier field 2520, a license plate or transponder field 2522, a toll location field 2524, and a final amount field 2526. The discount badge 2514 can display a discount type and/or discount value, such as a fixed amount discount, percentage discount, free trip discount, capped billing discount, and/or subscription discount. The amount saved indicator 2516 can display a calculated savings amount for the toll transaction.

The date/time field 2518 can be populated from an entry time, exit time, rating time, billing time, and/or other timestamp stored in the trip record 1822. The vehicle identifier field 2520 can display a vehicle nickname, vehicle make/model descriptor, and/or other customer-facing vehicle label stored in the vehicle record 1810. The license plate or transponder field 2522 can display a license plate number, license plate state, transponder identifier, tag identifier, and/or other tolling identifier used to match the trip record 1822 to the vehicle record 1810. The toll location field 2524 can display an entry gantry, exit gantry, toll plaza, roadway segment, direction, lane identifier, milepost, and/or facility identifier. The final amount field 2526 can display the amount billed after a discount was applied by the operational back office 1440.

The transaction list 2510 can include page controls 2528 and an items-per-page selector 2530. The page controls 2528 can request additional pages of transaction cards 2512 from the promotional pricing platform 1402. The items-per-page selector 2530 can change a page size used in a transaction query. In some embodiments, the promotional pricing platform 1402 can implement server-side pagination using a customer account identifier, date range, sort order, and cursor value. Server-side pagination can reduce data transfer and rendering burden on the customer device 1404 when a customer has a large number of trip records 1822 and savings records 1826.

The architecture 2500 includes a transaction detail view 2532. The transaction detail view 2532 can be displayed as a modal, sheet, expanded card, separate screen, and/or other detail interface after a customer selects a transaction card 2512. The transaction card 2512 can transmit a selected trip identifier, savings identifier, and/or transaction identifier to the promotional pricing platform 1402 through a select transaction command 2534. The promotional pricing platform 1402 can use the selected identifier to retrieve the corresponding trip record 1822, discount record 1824, savings record 1826, vehicle record 1810, claimed-offer record 1820, and/or campaign record 1818.

The transaction detail view 2532 can include a transaction date/time detail field 2536, an original toll row 2538, a discount applied row 2540, and a total amount row 2542. The transaction date/time detail field 2536 can display a transaction date and time derived from the trip record 1822. The original toll row 2538 can display a toll location and original amount before application of a promotional discount. The discount applied row 2540 can display a discount name, discount identifier, discount type, discount value, and/or saved amount. The total amount row 2542 can display a final amount billed by the operational back office 1440. The transaction detail view 2532 can provide an itemized representation of how the final amount was determined.

The architecture 2500 includes a savings calculation and reconciliation module 2544. The savings calculation and reconciliation module 2544 can be implemented by the promotional pricing platform 1402, the analytics platform 1420, and/or a back-end service coupled to the platform database 1606. The savings calculation and reconciliation module 2544 receives trip records 1822 from the operational back office 1440 through a trip record data path 2546. The trip records 1822 can include trip identifiers, entry gantries, exit gantries, entry dates, exit dates, trip types, original amounts, final amounts, vehicle identifiers, transponder identifiers, license plate values, trip statuses, and/or billing statuses.

The savings calculation and reconciliation module 2544 also receives discount records 1824 through a discount record data path 2548. The discount records 1824 can include discount identifiers, claim identifiers, trip identifiers, discount types, discount values, valid periods, applied amounts, and/or rule version identifiers. In some embodiments, the discount records 1824 can be created by the promotional pricing platform 1402 when the eligibility API 1444 returns a discount response to the operational back office 1440. In other embodiments, the discount records 1824 can be created or updated after the operational back office 1440 confirms which discount was actually applied during rating and/or billing.

The savings calculation and reconciliation module 2544 can calculate a saved amount by comparing an original amount to a final amount, by using an applied discount amount returned by the operational back office 1440, by applying a discount value from the discount record 1824, and/or by applying a cap or subscription rule from the offer object 2032. The savings calculation and reconciliation module 2544 can store the calculated value in the savings record 1826. The savings record 1826 can include a savings identifier, trip identifier, customer account identifier, vehicle identifier, claim identifier, campaign identifier, offer identifier, saved amount, original amount, final amount, period, and/or reconciliation status.

The savings calculation and reconciliation module 2544 can output aggregated savings data to the savings summary bar 2504 through an aggregated savings data path 2550. The aggregated savings data can include total saved by period, total saved by vehicle, total saved by offer, total saved by campaign, and/or total saved by roadway facility. The savings calculation and reconciliation module 2544 can output transaction savings records to the transaction list 2510 through a transaction savings data path 2552. The transaction savings records can include the data used to populate the transaction cards 2512. The savings calculation and reconciliation module 2544 can output itemized discount breakdown data to the transaction detail view 2532 through an itemized breakdown data path 2554.

In some embodiments, the savings calculation and reconciliation module 2544 can normalize and reconcile asynchronous event data. For example, a claimed-offer record 1820 can be created when a customer claims an offer, an eligibility API response can be generated when the operational back office 1440 rates a transaction, a final trip record can be received after toll billing is completed, and a savings record 1826 can be displayed after the final amount is confirmed. The savings calculation and reconciliation module 2544 can correlate these events using a claim identifier, trip identifier, discount identifier, vehicle identifier, license plate number, license plate state, transponder identifier, campaign identifier, and/or offer identifier. This correlation can reduce mismatches between discounts shown to customers and discounts applied by the operational back office 1440.

In some embodiments, the savings calculation and reconciliation module 2544 can maintain a reconciliation status for each savings record 1826. The reconciliation status can include pending, confirmed, adjusted, reversed, disputed, and/or closed. A pending status can indicate that a toll transaction has been detected but final billing data has not yet been received. A confirmed status can indicate that the original amount, final amount, and discount amount have been received and matched. An adjusted status can indicate that a later update from the operational back office 1440 changed a final amount, trip status, or discount amount. A reversed status can indicate that a trip was voided, refunded, or otherwise removed from savings calculations. These statuses can help the customer application 2302 display accurate savings while handling delayed back-office updates.

The architecture 2500 can include a customer self-service and audit trail module 2556 coupled to the transaction detail view 2532. The customer self-service and audit trail module 2556 can store and/or retrieve data used to support customer review, discount verification, and support inquiries. For example, the customer support service 1448 can access the same trip record 1822, discount record 1824, savings record 1826, and eligibility audit record used by the transaction detail view 2532. Providing a common data source for the customer interface and customer support interface can reduce inconsistencies between what a customer sees and what a support agent sees.

The customer self-service and audit trail module 2556 can store an audit event when a savings record 1826 is created, displayed, adjusted, reversed, disputed, and/or exported. The audit event can include a customer account identifier, vehicle identifier, trip identifier, discount identifier, timestamp, source system, prior value, new value, and/or reason code. In some embodiments, the audit event can also include an offer version identifier and/or campaign version identifier so that the promotional pricing platform 1402 can determine which offer terms were used when the discount was applied.

The savings dashboard 2502 can also provide data to the analytics platform 1420. For example, the promotional pricing platform 1402 can transmit events indicating that a customer viewed the savings dashboard 2502, changed the time period filter 2508, selected a transaction card 2512, opened the transaction detail view 2532, or contacted support from the transaction detail view 2532. These events can be used by the product analytics service 1428 and/or promotion analytics module 1424 to determine whether the savings dashboard 2502 increases customer engagement, improves offer acceptance, reduces support inquiries, and/or changes future managed lane usage.

In some embodiments, the savings dashboard 2502 can support multi-vehicle filtering. The time period filter 2508 and/or another filter control can receive a selected vehicle value, selected license plate value, selected transponder value, and/or selected roadway value. The promotional pricing platform 1402 can then query savings records 1826 coupled to the selected vehicle record 1810. Multi-vehicle filtering can be useful for household accounts, fleet accounts, and/or customer accounts having multiple customer vehicles 1416.

In some embodiments, the savings calculation and reconciliation module 2544 can support capped billing and subscription savings. For a monthly cap offer, the module 2544 can calculate savings as amounts that would have been billed above a cap value during a billing period. For a subscription offer, the module 2544 can calculate savings as a comparison between standard toll charges and charges covered by a subscription during the subscription period. The module 2544 can store the cap period, subscription period, accumulator value, cap value, and/or subscription value in the savings record 1826 and/or a related discount record 1824.

The architecture 2500 can provide technical improvements to the promotional pricing platform 1402 by reconciling distributed toll transaction data and promotional discount data into a unified savings record that can be displayed and audited. The savings calculation and reconciliation module 2544 can use stable identifiers and idempotent update logic to prevent duplicate savings calculations when trip records are retransmitted or updated. The architecture 2500 can also provide a consistent data path from the operational back office 1440 to the customer application 2302, allowing customers to view aggregated savings, transaction-level savings, and itemized discount details derived from the same reconciled records used for support and analytics.

The promotional pricing platform 1402 solves a technical problem in distributed tolling systems in which a customer-facing offer state can become inconsistent with a back-office discount-eligibility state due to asynchronous event timing, retried API messages, and edited offer configurations. By maintaining a processed-trip index, evaluating a versioned eligibility rule at transaction-rating time, and reconciling completed trip records using stable identifiers, the promotional pricing platform 1402 reduces duplicate discount application, reduces inconsistent eligibility responses, and reduces the computational and operational latency associated with manual reconciliation between customer-facing systems and back-office systems.

The figures, flow diagrams, sequence diagrams, state diagrams, and accompanying descriptions herein illustrate examples of operations that can be performed in accordance with embodiments of the disclosed technology. The illustrated order of operations is exemplary only, and the recited operations can be performed in a different order than that shown, in a reverse order, in an interleaved order, substantially concurrently with one another, in partial overlap, in parallel across multiple processors, threads, processes, containers, virtual machines, services, devices, and/or systems, and/or in any other order that achieves the disclosed functionality. No particular order of operations is required unless expressly stated. References herein to a “first,” “second,” “third,” and so on operation are labels for convenience of reference and do not imply a required temporal sequence.

Any one or more of the operations described herein can be omitted, skipped, deferred, repeated, performed multiple times, iterated, looped, conditionally executed, executed in a default state, executed automatically without user input, executed manually in response to user input, batched, queued, scheduled, performed asynchronously, performed synchronously, performed on-demand, and/or performed in response to an event, trigger, timer, threshold, message, sensor reading, prediction, machine-learning output, or other condition. Operations described as occurring in response to a particular condition can also occur independently of that condition in other embodiments. Additional operations not expressly described can be inserted between, before, or after the described operations without departing from the scope of the disclosed technology.

Any operation described as a single step can be performed as two or more sub-operations, and any two or more operations described as separate steps can be combined into a single operation. Any operation described as performed by a particular module, agent, server, service, interface, or other component can instead be performed by a different module, agent, server, service, interface, or component, by a combination thereof, or by a distributed arrangement of two or more thereof, including by cloud-based components, edge components, on-device components, vehicle-based components, and/or roadside components.

The various embodiments, features, components, modules, agents, services, interfaces, data structures, data fields, data records, identifiers, indexes, models, algorithms, rules, parameters, thresholds, methods, processes, and operations described herein are intended to be combinable, interchangeable, and substitutable with one another in any combination or subcombination, unless expressly stated otherwise or unless physically or logically incompatible. A feature described with respect to one embodiment, figure, or example can be used with any other embodiment, figure, or example described herein. The use of headings, subheadings, figure titles, or section labels is for convenience only and does not limit the scope of the disclosure or imply that features under one heading are excluded from embodiments described under another heading.

Optional Components and Sub-Components. Any component, sub-component, module, sub-module, agent, sub-agent, service, interface, data record, data field, identifier, index, model, rule, parameter, threshold, sensor, gantry, reader, network element, or other element described herein can be omitted, duplicated, distributed across multiple devices or services, consolidated into a single device or service, replaced with a functionally equivalent component, supplemented with one or more additional components, and/or implemented across multiple geographic locations, roadway facilities, jurisdictions, concessions, tenants, and/or operators. References herein to a “plurality” of components do not preclude embodiments having a single such component, and references to a single component do not preclude embodiments having a plurality of such components, unless expressly stated otherwise.

Data Structure and Field Flexibility. The data records, data fields, identifiers, indexes, schemas, tables, documents, graphs, key-value structures, event streams, queues, caches, and other data organizations described herein are exemplary. Any data record can include additional fields not expressly described, can omit fields that are expressly described, can store equivalent data in a different format, structure, encoding, character set, language, time zone, unit of measure, or representation, and can be stored across one or more storage systems, databases, services, files, partitions, shards, replicas, regions, and/or providers. Field names, record names, and identifier names used herein are labels for convenience and can be replaced with any functionally equivalent label. Compound identifiers, composite keys, and normalized values can be used in place of, or in addition to, individual identifiers and unnormalized values, and vice versa.

Communication Channel Flexibility. The communication channels, networks, protocols, application programming interfaces (APIs), endpoints, message formats, message queues, event streams, file transfers, database replications, and other communication mechanisms described herein are exemplary. Any communication described as performed through one channel or protocol can be performed through any other suitable channel or protocol, including channels and protocols that are yet to be developed. A communication described as synchronous can be performed asynchronously and vice versa. A communication described as request-response can be performed using publish-subscribe, event streaming, polling, webhooks, batch transfer, and/or other patterns. References to a “network interface,” “API,” “interface,” or similar element are intended to encompass any communicative coupling sufficient to exchange the recited data, whether implemented as a separate hardware interface, a software endpoint, a function call, an inter-process communication, a remote procedure call, a shared memory region, a database read or write, a file system operation, or any other suitable mechanism.

Equivalent Implementations. Any structure, component, operation, or feature described herein can be replaced with a structure, component, operation, or feature that is functionally equivalent, structurally equivalent, or recognized as an equivalent by a person of ordinary skill in the art. Hardware implementations can be replaced with software implementations and vice versa. Software implementations can be replaced with firmware implementations and vice versa. Centralized implementations can be replaced with distributed implementations and vice versa. Synchronous implementations can be replaced with asynchronous implementations and vice versa. Real-time implementations can be replaced with batch implementations and vice versa. Trained machine-learning implementations can be replaced with rules-based, statistical, heuristic, or hybrid implementations and vice versa.

Exemplary Values and Ranges. Any specific value, range, threshold, count, frequency, period, duration, dimension, percentage, ratio, cap, limit, score, weight, parameter, or other quantitative recitation in the description is exemplary only. Other values within a reasonable range above or below the recited value, and other ranges, thresholds, counts, frequencies, periods, durations, dimensions, percentages, ratios, caps, limits, scores, weights, and parameters are contemplated and can be substituted for the recited value or range to achieve the disclosed functionality. The recitation of a specific value does not preclude the use of substantially similar values to achieve the same or substantially the same result.

Conditional Language. Use of the words “can,” “may,” “might,” “could,” “would,” “should,” “in some embodiments,” “in some cases,” “in some examples,” “optionally,” “preferably,” “for example,” “such as,” “including,” “comprising,” “containing,” and similar expressions throughout the specification is intended to convey that the associated feature, component, operation, or characteristic is optional, exemplary, or non-limiting, and that the disclosed technology can be practiced with or without the associated feature, component, operation, or characteristic.

Cross-Embodiment Combinations. Any feature, component, operation, or aspect described with respect to FIGS. 1-13 can be combined with any feature, component, operation, or aspect described with respect to FIGS. 14-25, and vice versa. Any embodiment that includes the multi-agent reinforced learning system, the future traffic conditions prediction server, the toll setting server, the segment agents, the coordination agent, the connected-automated vehicle communications, the dynamic toll rate signs and/or gantries, the advanced traffic management system, the back office systems, and/or any other component described with respect to FIGS. 1-13 can additionally include the promotional pricing platform, the offer engine, the campaign manager, the segment manager, the customer/vehicle database, the notification preference manager, the API gateway, the eligibility API, the trips API, the rating and billing module, the analytics platform, the customer communication service, the product analytics service, the customer support service, the savings dashboard, the offer state machine, and/or any other component described with respect to FIGS. 14-25, and vice versa. The disclosed technology contemplates any and all such combinations, sub-combinations, and permutations.

No Required Sequence or Combination. The specification, including the figures and accompanying descriptions, is not intended to require any particular sequence, combination, or selection of features, components, operations, or aspects for the practice of the disclosed technology. The recitation of a particular sequence, combination, or selection in any single embodiment is not intended to limit the scope of the claims or to imply that the recited sequence, combination, or selection is required. Where the specification describes a particular sequence, combination, or selection, that description is intended to be one example among many, and other sequences, combinations, and selections that achieve the disclosed functionality are contemplated and within the scope of the disclosed technology.

Non-Limiting Examples. Each example, embodiment, figure, illustration, drawing, schematic, flow diagram, table, listing, and description provided herein is non-limiting and is provided to illustrate one or more aspects of the disclosed technology. The disclosed technology is not limited to the specific examples, embodiments, figures, illustrations, drawings, schematics, flow diagrams, tables, listings, or descriptions provided herein, and a person of ordinary skill in the art will recognize that other examples, embodiments, figures, illustrations, drawings, schematics, flow diagrams, tables, listings, and descriptions can be used to practice the disclosed technology. The claims are not limited to the specific examples, embodiments, figures, illustrations, drawings, schematics, flow diagrams, tables, listings, or descriptions provided herein.

While some of the preferred embodiments have been described, it will be understood that those skilled in the art, both now and in the future, may make various improvements and enhancements which fall within the scope of the claims which follow. Moreover, while the various embodiments are described in relation to the various figures, the figures, in some instances, all relate to the same embodiment. In other words, the various figures and accompanying disclosure can be used in various combinations to result in one or more embodiments. These claims should be construed to maintain the proper protection for the invention first described.

What is claimed is:

1. A managed-lane promotional pricing computing platform comprising:
network interfaces comprising a customer interface, an administrative interface, an eligibility application programming interface (API), and a trips API, the network interfaces communicatively linked to customer devices and to an operational back-office server, the operational back-office server rating toll transactions generated as vehicles are detected by roadway tolling equipment positioned along a managed lane, the roadway tolling equipment comprising toll gantries, transponder readers, automatic license plate recognition cameras, and/or roadway sensors;
a database storing customer account records, vehicle records, offer records, campaign records, claimed-offer records, trip records, discount records, savings records, and a processed-trip index;
a processor; and
memory communicatively linked to the processor, the memory including instructions that cause the processor to:
receive, through the customer interface, enrollment data including customer identity data and vehicle identity data, the vehicle identity data including a license plate number, a license plate state, and/or a transponder identifier;
generate a customer-vehicle record coupling a customer account to a vehicle record, the customer-vehicle record indexed by a plate-and-state value and/or the transponder identifier;
receive, through the administrative interface, an offer record comprising a threshold type, a threshold minimum, a discount type, a discount value, a validity rule, and a redemption limit;
store a versioned eligibility rule derived from the offer record, the versioned eligibility rule associated with a version identifier and an effective time;
receive, through the customer interface, a claim selection associated with the offer record and the vehicle record;
generate a claimed-offer record coupling the customer account, the vehicle record, and the offer record, the claimed-offer record identifying a progress value and the version identifier that is active when the claim selection is received;
receive, through the eligibility API and during rating of a toll transaction by the operational back-office server, an eligibility query including vehicle identification data detected by the roadway tolling equipment and toll transaction data, the toll transaction data including a toll transaction identifier and a transaction timestamp;
match the eligibility query to the vehicle record using an indexed comparison of the vehicle identification data to the customer-vehicle record such that a matched customer-vehicle record is returned within a latency window of the rating of the toll transaction;
evaluate the versioned eligibility rule that was effective at the transaction timestamp based at least in part on the claimed-offer record, the progress value, the validity rule, and the redemption limit, the versioned eligibility rule being evaluated according to the version identifier identified by the claimed-offer record notwithstanding an edit to the offer record occurring after the claim selection;
transmit, through the eligibility API to the operational back-office server, a machine-readable eligibility response that indicates a discount identifier, the discount type, the discount value, and a valid period when the toll transaction is eligible, and indicates an ineligible status when the toll transaction is ineligible;
receive, through the trips API from the operational back-office server, completed trip data including the toll transaction identifier, a trip identifier, an original toll amount, a final toll amount, and an applied discount identifier;
in the event the trip identifier is present in the processed-trip index, prevent a second update to the progress value;
in the event the trip identifier is absent from the processed-trip index, store the trip identifier in the processed-trip index and update the progress value of the claimed-offer record, a trip record, a discount record, and a savings record using the completed trip data; and
transmit, through the customer interface, the progress value and a savings amount derived from the savings record.

2. The managed-lane promotional pricing computing platform of claim 1 wherein the processed-trip index comprises a unique index on the trip identifier and/or a composite index on the toll transaction identifier, a vehicle identifier of the vehicle record, and a trip time, and wherein the instructions cause the processor to update an existing trip record rather than generate a duplicate trip record when the completed trip data is received more than once.

3. The managed-lane promotional pricing computing platform of claim 1 wherein the instructions further cause the processor to:
detect an existing active claimed-offer record coupled to the vehicle record;
present a change-offer confirmation through the customer interface; and
in response to a confirmation received through the customer interface, transactionally deactivate the existing active claimed-offer record and generate the claimed-offer record within a single atomic database transaction such that, upon commit, both the deactivation and the generation are persisted together or neither is persisted.

4. The managed-lane promotional pricing computing platform of claim 1 wherein the instructions cause the processor to maintain a state machine coupled to the claimed-offer record, the state machine including available, claimed, in-progress, threshold-reached, discount-eligible, redeemed, expired, and/or replaced states, and to store state transition records each including a timestamp, an event identifier, a prior state, and a new state.

5. The managed-lane promotional pricing computing platform of claim 1 wherein the threshold type comprises a trip threshold, a spend threshold, a monthly cap, and/or a subscription condition.

6. The managed-lane promotional pricing computing platform of claim 5 wherein the instructions cause the processor to maintain a period accumulator coupled to the vehicle record and, after the period accumulator satisfies a cap value, transmit a capped billing response through the eligibility API.

7. The managed-lane promotional pricing computing platform of claim 1 wherein the instructions cause the processor to cache active claimed-offer records indexed by a vehicle identifier and a valid time window, generate the machine-readable eligibility response from the cached active claimed-offer records without scanning the offer records and the campaign records, and refresh the cached active claimed-offer records when an offer is claimed, when a campaign is published, when a vehicle record is added, and/or when the progress value changes.

8. The managed-lane promotional pricing computing platform of claim 1 wherein, when the license plate number in the vehicle identification data matches a first vehicle record and the transponder identifier in the vehicle identification data matches a second vehicle record, the instructions cause the processor to apply a conflict rule and indicate the ineligible status with a conflict reason code in the machine-readable eligibility response unless the conflict rule is satisfied.

9. The managed-lane promotional pricing computing platform of claim 1 wherein the instructions cause the processor to couple a segment record to the offer record within a campaign record, receive message variants, a publication window, and an offer window coupled to the campaign record, and generate customer communication events using the message variants, the publication window, and the offer window.

10. A managed-lane promotional pricing computing platform comprising:
network interfaces comprising a customer interface, an administrative interface, an eligibility application programming interface (API), and a trips API;
a database storing customer records, vehicle records, offer records, campaign records, claimed-offer records, trip records, discount records, and savings records;
a processor; and
memory communicatively linked to the processor, the memory including instructions that cause the processor to:
receive, through the customer interface, enrollment data including customer identity data and vehicle identity data, the vehicle identity data including a license plate number, a license plate state, and/or a transponder identifier;
generate a customer-vehicle record coupling a customer account to a vehicle record;
receive, through the administrative interface, an offer record comprising a threshold type, a threshold minimum, a discount type, a discount value, a validity rule, and/or a redemption limit;
receive, through the customer interface, a claim selection associated with the offer record and the vehicle record;
generate a claimed-offer record coupling the customer account, the vehicle record, and the offer record;
receive, through the eligibility API, an eligibility query from an operational back-office server during rating of a toll transaction generated by roadway tolling equipment, the eligibility query including vehicle identification data and toll transaction data;
match the eligibility query to the vehicle record using an indexed comparison of the vehicle identification data to the customer-vehicle record;
evaluate a versioned rule associated with the offer record using the claimed-offer record, the toll transaction data, a progress value, the validity rule, and/or the redemption limit;
transmit, through the eligibility API to the operational back-office server, a machine-readable eligibility response comprising a discount identifier, the discount type, the discount value, a valid period, and/or an ineligible status;
receive, through the trips API from the operational back-office server, completed trip data including a trip identifier, an original toll amount, a final toll amount, and/or an applied discount identifier; and
update the claimed-offer record, a trip record, a discount record, and/or a savings record using the completed trip data.

11. The managed-lane promotional pricing computing platform of claim 10 wherein the eligibility query comprises a toll transaction identifier, a gantry identifier, a lane identifier, a transaction timestamp, a plate-and-state value, and/or the transponder identifier.

12. The managed-lane promotional pricing computing platform of claim 10 wherein the instructions cause the processor to normalize the license plate number by removing punctuation and converting alphabetic characters to a common case before storing the customer-vehicle record.

13. The managed-lane promotional pricing computing platform of claim 10 wherein the instructions cause the processor to store the trip identifier in a processed-trip index and prevent a second update to the progress value when duplicate completed trip data includes the trip identifier.

14. The managed-lane promotional pricing computing platform of claim 10 wherein the instructions cause the processor to maintain a state machine associated with the claimed-offer record, the state machine including available, claimed, in-progress, threshold-reached, discount-eligible, redeemed, expired, and/or replaced states.

15. The managed-lane promotional pricing computing platform of claim 10 wherein the instructions cause the processor to:
detect an existing active claimed-offer record associated with the vehicle record;
present a change-offer confirmation through the customer interface; and
in response to a confirmation received through the customer interface, transactionally deactivate the existing active claimed-offer record and generate the claimed-offer record.

16. The managed-lane promotional pricing computing platform of claim 10 wherein the threshold type comprises a trip threshold, a spend threshold, a monthly cap, and/or a subscription condition.

17. The managed-lane promotional pricing computing platform of claim 10 wherein the database stores notification preference records including channel preferences associated with new offers, expiring offers, and/or redeemed offers, the channel preferences including push notification preferences, email preferences, and/or SMS preferences.

18. The managed-lane promotional pricing computing platform of claim 10 wherein the instructions cause the processor to:
receive, through the administrative interface, a campaign record coupling a segment record to the offer record;
receive message variants associated with the campaign record;
receive a publication window and an offer window associated with the campaign record; and
generate customer communication events using the message variants, the publication window, and the offer window.

19. A computer-implemented method comprising:
receiving, by a promotional pricing computing platform and through a customer interface, enrollment data including customer identity data and vehicle identity data;
generating, by the promotional pricing computing platform, a customer-vehicle record coupling a customer account to a vehicle record;
receiving, through an administrative interface, an offer configuration including a threshold type, a discount type, a discount value, a validity rule, and/or a redemption limit;
generating an offer record from the offer configuration;
receiving a claim selection associated with the offer record and the vehicle record;
generating a claimed-offer record coupling the customer account, the vehicle record, and the offer record;
receiving, through an eligibility API from an operational back-office server during rating of a toll transaction, an eligibility query including vehicle identification data, toll transaction data, and a toll transaction identifier;
matching the eligibility query to the vehicle record using the customer-vehicle record;
evaluating a versioned eligibility rule associated with the offer record using the claimed-offer record, the toll transaction data, a progress value, the validity rule, and/or the redemption limit;
transmitting, through the eligibility API, an eligibility response to the operational back-office server, the eligibility response including a discount identifier, the discount type, the discount value, and/or an ineligible status;
receiving, through a trips API, completed trip data including a trip identifier, an original toll amount, a final toll amount, and/or an applied discount identifier; and
updating the claimed-offer record and a savings record using the completed trip data.

20. The computer-implemented method of claim 19 comprising:
storing the trip identifier in a processed-trip index; and
preventing duplicate updating of the progress value when subsequently received completed trip data includes the trip identifier.
